(19) United States
(12) Patent Application Publication
(10) Pub. No.: US 2007/0235335 A1
(43) Pub. Date: Oct. 11, 2007

(54) Electrophoretic Devices, Instruments and Systems Including Same

(75) Inventors: David Strand, Sherborn, MA (US); Dan M. Leatzow, Kalispell, MT (US)

Correspondence Address: BANNER & WITCOFF, LTD., 28 STATE STREET, 28th FLOOR, BOSTON, MA, 02109-9601, US

(73) Assignee: Protasis Corporation, Marlborough, MA (US)

(21) Appl. No.: 10/537,197

(22) PCT Filed: Dec. 1, 2003
(86) PCT No.: PCT/US03/38170

§ 371 Date: Jun. 14, 2007

Related U.S. Application Data
(60) Provisional application No. 60/430,493, filed on Dec. 2, 2002.
(60) Provisional application No. 60/447,997, filed on Feb. 18, 2003.
(60) Provisional application No. 60/471,616, filed on May 19, 2003.
(60) Provisional application No. 60/471,595, filed on May 19, 2003.

(51) Int. Cl. B01D 57/02

(52) U.S. Cl. 204/518

(57) ABSTRACT

Devices, systems and methods are provided for processing fluid samples containing one or more analytes. In certain examples, an electrophoretic device comprises a separation chamber and an electrode chamber, each of which may be uniform or non-uniform. The electrode chamber includes two or more electrodes or may include an electrode array. Molecular sieve may be included in the separation chamber, and the molecular sieve is operative to shift the location at which a stationary focused band of a charged analyte forms under a given set of focusing process parameters. Such systems are especially suitable for linking up analytical instruments in a hyphenated fashion, particularly where the instruments have differing system parameters.

### PRIORITY CLAIM

This application claims the benefit of U.S. Provisional Application No. 60/430,493 entitled “Electrophoresis Device, System and Method for Sample Management and Hyphenation of Analytical Instruments” and filed on Dec. 2, 2002, U.S. Provisional Application No. 60/447,997 entitled “Electrophoresis Device, System and Method for Sample Management and Hyphenation of Analytical Instruments” and filed on Feb. 18, 2003, U.S. Provisional Application No. 60/471,616 entitled “Electrophoresis Device, System and Method for Sample Management and Hyphenation of Analytical Instruments III” and filed on May 19, 2003, and U.S. Provisional Application No. 60/471,595 entitled “Electrophoresis Devices and Methods for Focusing Charged Analytes” and filed on May 19, 2003, the entire disclosures of each of which is hereby incorporated herein by reference for all purposes.

### FIELD OF THE INVENTION

The present invention is directed to an electrophoretic device, systems incorporating such devices and methods of their use for focusing and separating of samples and for sample management and hyphenation of analytical instruments.

### BACKGROUND

Electrically driven separations processes for analysis of complex mixtures have become widely accepted throughout the field of biotechnology, and electrophoresis-based devices continue to find widespread use in on-going proteomic investigations. The most prominent technique for proteomic analysis of complex mixtures employs two-dimensional polyacrylamide gel electrophoresis (2D-PAGE), where a complex mixture is loaded onto a gel and resolved along a first axis using isoelectric focusing (i.e., resolving components according to pI) and then along a second axis using SDS-PAGE (i.e., resolving molecules based upon molecular weight). The popularity of electrophoresis stems from the technique's ability to resolve target molecules on the basis of small differences in molecular weight, electrophoretic mobilities, isoelectric points, or combinations of these properties. Although successful, PAGE-based techniques can be time consuming, labor intensive, and do not allow for easy recovery of sample or adjustment of sample loadings to compensate for maldistribution of components commonly observed in biological systems. In addition, integration of 2D-PAGE systems into seamless analytical systems is oftentimes cumbersome.

Chromatographic techniques for analysis of complex mixtures are second only to electrophoresis techniques in terms of resolving power and are more amenable to automation and hyphenation. However, sample concentration issues, flow rate dissimilarities, time-scale differences, or an ability to perform in situ buffer exchange are problematic when integrating LC techniques into hyphenated instrument platforms. The analytical instrument industry has gone great lengths to develop liquid chromatography (LC) systems (e.g., capillary and nanoscale systems) to improve compatibility with high sensitivity detectors (e.g., mass spectrometers). Current methodologies for addressing these drawbacks to hyphenation include the use of split valves, sample loop arrays, or solid phase extraction cartridges. Although these examples are capable of joining two devices together, each has pitfalls in yielding a universal hyphenation technology and is of low value as a stand-alone instrument.

Analysis using hyphenated devices or systems has become very popular in scientific research, as evidenced by the emergence of HPLC-NMR, HPLC-CD, and LC-MS/MS systems. A typical approach for hyphenated technologies involves two or more conventional instruments ganged together, where in many cases the samples are physically transferred from the output of one instrument to the input of the subsequent instruments. To increase the analytical throughput, automated sample handlers or robots are generally involved. Many hyphenation strategies are manufacturer specific, thus limiting options of useable instrument platforms and compatibility is often a problem between the instruments from different manufacturers.

Thus, there is a need for electrically-driven separation devices, systems and methods, suitable for separating and/or concentrating charged analytes, especially for separation and concentration of biomacromolecules, for example, proteins. There is also a need for sample management devices, systems and methods, especially for hyphenation of analytical instruments and for separation and/or focusing of charged analytes. Accordingly, it is an object of this invention to provide devices, systems and methods for separation and/or concentration of charged analytes and to provide devices, systems and methods for sample management and hyphenation of analytical instruments.

### SUMMARY

In accordance with a first aspect, electrophoretic devices are provided that are capable of separating and/or focusing one or more analytes in a sample fluid. In at least certain examples, the devices comprise a separation chamber having a fluid inlet port and a fluid outlet port, with a flow path from the fluid inlet port to the fluid outlet port defining a fluid flow direction through the separation chamber. The device also comprises an electrode chamber separated from the separation chamber by a permeable membrane, and electrodes positioned in the electrode chamber and operative when energized to generate an electric field gradient in the separation chamber, e.g. linear and non-linear electric field gradients optionally having multiple segments with different slopes. In some examples, the separation chamber has a non-uniform configuration along at least a portion of the flow path. In certain examples, the electrode chamber has a non-uniform configuration along at least a portion of the flow path of the separation chamber. Some or all of the electrodes can be positioned in the electrode chamber. In some examples, the device is elongate, that is, the separation chamber and the electrode chamber are correspondingly elongate, typically in a direction parallel to the plane of the membrane, such that flow of fluid through the separation chamber is in the longitudinal axial direction of the device.

In accordance with another aspect, electrodes of the electrophoretic device can be energized to create an electric field gradient required to focus a charged analyte in the separation chamber of the electrophoretic device. In certain examples, the electrophoretic device further comprises an electrode chamber in which the electrodes are suitably positioned. Buffer can be flowed through the electrode chamber, serving also to cool the electrodes. The electrodes typically are separated from the separation chamber, e.g., by a membrane, typically a permeable or porous conductive membrane that me be substantially planar or substantially non-planar. To obtain good power efficiency and strong electric field strength, the electrodes generally are located proximate the membrane separating the separation chamber from the electrode chamber.

In accordance with an additional aspect, an electrophoretic device comprises a separation chamber configured to receive sample fluid from a first sample treatment device. As described in more detail below, a charged analyte in the sample fluid flowing through the separation chamber, e.g., a suspended or dissolved analyte, can be collected or concentrated or “focused” at a particular location in the separation chamber by balancing the flow of the sample fluid, e.g., the hydrodynamic force, which tends to move the analyte downstream with the sample fluid toward the outlet of the separation chamber, against the electric field gradient, which tends to move the analyte back upstream toward the inlet of the separation chamber. It will be within the ability of the person of ordinary skill in the art, given the benefit of this disclosure, to select appropriate electric field strengths to balance against the hydrodynamic force of a particular sample fluid flow through the separation chamber of an electrophoretic device used to separate charged analytes or used to connect or “hyphenate” two sample treatment devices, to focus an analyte within the separation chamber.

In accordance with another aspect, a processing system comprises a first sample treatment device having a fluid outlet port, a second sample treatment device having a fluid inlet port and optionally having at least one operative fluidic requirement different from the corresponding operative fluidic requirement of the first sample treatment device, and an electrophoretic device comprising a separation chamber having a fluid inlet port in fluid communication with the fluid outlet port of the first sample treatment device and a fluid outlet port in fluid communication with the fluid inlet port of the second sample treatment device, and electrodes separated from the separation chamber by a membrane and operative to generate an electric field gradient in the separation chamber. Such treatment includes, but is not limited to, detection, separation, fractionation, testing or analysis, reaction, and the like, and is not limited in scale, that is, is inclusive of preparative scale devices, analytical scale devices, etc. and combinations of such devices. Exemplary sample treatment devices include detectors, pumps, valves, columns, membranes, reactors, mixers, etc and the like. The first and second sample treatment devices will typically have differing operative fluidic requirements. The electrophoretic device is positioned between the first and second sample treatment devices, and is in fluid communication with each of the first and second sample treatment devices, and serves as a bridge between them able to accommodate or compensate for their different operative fluidic requirements. In certain embodiments or examples of the methods and systems disclosed here, the electrophoretic device receives from the first sample treatment device a flow of sample fluid containing a charged analyte. The electrophoretic device serves to collect and hold the charged analyte in between the first and second sample treatment devices while the fluidic parameters of the fluid flow are changed, e.g., its flow rate, composition and/or analyte concentration, etc. Thus, the electrophoretic device receives and accommodates the flow from the first sample treatment device and facilitates preparation of the sample flow into the second sample treatment device. The sample flow into the second sample treatment device contains at least a portion of the charged analyte and matches the operative fluidic requirements of the second sample treatment device.

In accordance with another aspect, a processing system is provided for electrofocusing of target molecules, e.g., proteins, nucleic acids, etc., comprising one or more electrophoretic devices as disclosed above. In accordance with certain preferred embodiments, such processing systems comprise automated sample injection, a pump or pump module for generation of the focusing chromatographic flow, a cooling and degassing module, and a separation chamber with associated electrode chamber and conductive membrane.

In accordance with a method aspect, electrophoretic methods for focusing a charged analyte are provided. Devices in accordance with the aspects and embodiments above are provided, and a first or sample fluid comprising at least one charged analyte is introduced into the separation chamber. The electrodes are energized to create an electric field gradient in the separation chamber to focus the charged analyte in the electric field gradient. The electric field gradient is generated by the creation of an electric field by the electrodes in the electrode chamber, the gradient arising from the cross-sectional non-uniformity of the electrode chamber and resultant non-uniformity of current density throughout the separation chamber. Without wishing to be bound by any particular scientific theory, the gradient in the electric field can in certain preferred embodiments be influenced by non-uniformity in the separation chamber. Certain preferred embodiments of such methods simultaneously focus multiple charged analytes from a fluid sample. For example, a first analyte can be focused in the chamber at a stable position spatially separated from the focusing location of a second analyte.

In accordance with another method aspect, electrophoretic devices as disclosed herein are employed with molecular sieve in the separation chamber for focusing a charged analyte in the separation chamber at a stable position that, for a given set of focusing process parameters (e.g., sample fluid flow rate, composition and/or pH, electric field gradient strength and/or configuration, chamber configuration, etc.) is shifted from the location at which it would focus under the same set of process parameters absent the molecular sieve. In certain preferred embodiments, a fluid sample containing multiple charged analytes of different molecular weights but having the same or similar charge to mass ratio or electrophoretic mobility is introduced into the separation chamber having a fixed or soluble molecular sieve, such that hydrodynamic force of the fluid flow is opposed by a gradient in the electric field and by the molecular sieve. It should be understood that reference above and elsewhere herein to a fluid sample can mean a single fluid sample comprising multiple analytes passed one or more times through the separation chamber or a series of two or more fluid samples, each comprising one or more analytes, passed in turn through the channel. By using molecular sieve in the separation chamber, the focusing location can be shifted relative to the focusing location in the absence of molecular sieve.

In accordance with another aspect, methods are provided employing the electrophoretic devices and/or the processing systems disclosed herein, for sample collection, sample conditioning, sample fractionation, and/or sequential sample withdrawal or release. Certain especially preferred embodiments are operative to capture a dilute analyte peak or fraction and to focus such peak or fraction to a concentrated band, e.g., to capture proteins with mobilities spanning the range 2.0×10⁻⁶-2×10⁻³ cm²/V sec, which encompasses a great percentage of molecules with biological interest. Certain especially preferred embodiments are operative to capture sequential injections of dilute sample peaks or fractions with subsequent focusing into a single band, e.g., with a total sample loading up to 50 micrograms of protein in a total volume of 2 μL. Certain especially preferred embodiments are operative to capture multiple peaks, fractions or bands and selectively release a single focused band.

In accordance with another aspect, methods are provided employing the processing systems disclosed above. In certain examples, a fluid comprising at least one charged analyte can be fed, directly or indirectly (i.e., with or without intervening devices or treatment) from the first sample treatment device into the separation chamber of the electrophoretic device. At least one charged analyte in the fluid can be focused using an electrophoretic device as described here. The focused analyte may then be fed to the inlet port of the second sample treatment device, typically with operative fluidic parameters meeting the requirements of the second sample treatment device. As noted above, the operative fluidic parameters of the second sample treatment device often differ significantly from those of the first sample treatment device. For example, the concentration of the charged analyte may be increased, or the flow rate or fluid composition may be altered while the charged analyte is held in the separation chamber or when it is passed from the separation chamber. The charged analyte can be released from the separation chamber of the electrophoretic device, e.g., to pass it directly or indirectly to the second treatment device, by reducing, altering or eliminating the electric field, for example. Certain preferred embodiments of such methods simultaneously focus multiple charged analytes from a fluid sample. Each of the different analytes can be focused in the same electrophoretic device or in different electrophoretic devices. If focused in the same separation chamber, typically the different analytes are focused at different, stable positions, i.e., at positions that are spatially separated from each other in the direction of sample fluid flow through the separation chamber and preferably the bands are spatially separated from each other such that individual bands can be removed with minimal contamination resulting from other bands.

It will be recognized by those skilled in the art, that suitable examples of the technology disclosed here can separate or focus charged analytes and/or enhance hyphenation of analytical instruments by eliminating or accommodating dissimilarities in system parameters, without substantial loss of target sample, and optionally with change in buffer, change in analyte concentration, analyte separation, collection and/or selective routing for further sample processing. In addition, suitable embodiments have application in sample management by providing a dynamic platform for routing and preparation of target solutes for subsequent analysis.

### BRIEF DESCRIPTION OF THE FIGURES

Certain examples or embodiments of the invention are described below with reference to the accompanying figures in which:

FIGS. 1A and 1B are graphs showing multiple linear segments of an electric field gradient, in accordance with certain preferred embodiments;

FIG. 2A is a graph illustrating the principles of electrophoretic field gradient focusing (“EFGF”) and FIG. 2B is a graph illustrating the principles of a fluid gradient, in accordance with certain preferred embodiments;

FIGS. 3A-3F present schematic representations and graphical representations of two approaches for conducting electric field gradient focusing in accordance with certain embodiments of the systems and methods disclosed here;

FIG. 4 is an exploded view of an exemplary electrophoretic device, in accordance with certain embodiments;

FIG. 5 is a schematic of another example of an electrophoretic device, in accordance with certain preferred embodiments;

FIG. 6 is a schematic perspective view of an exemplary embodiment of an electrophoretic device suitable for use in the systems and methods disclosed here;

FIG. 7 is a schematic perspective view of another embodiment of an electrophoretic device suitable for use in the systems and methods disclosed here;

FIG. 8A is an exploded view of another embodiment of an electrophoretic device suitable for use in the systems and methods disclosed here;

FIGS. 8B-8E are schematic perspective views of selected components of the device illustrated in FIG. 8A, in accordance with certain embodiments;

FIG. 9 is an elevation view, partly in section, of the device of FIGS. 22A-22E in assembly, in accordance with certain embodiments;

FIGS. 10A and 10B are front and back plan views, respectively, of the device of FIGS. 8A-8E and 9 in assembly, in accordance with certain embodiments;

FIGS. 11A and 11B are views, partially in section, of the device of FIGS. 8A-8E, 9 and 10A-10B, in assembly, taken through line 6A-6A in FIG. 9 and line 6B-6B in FIGS. 10A and 10B, respectively, in accordance with certain embodiments;

FIG. 12 is a schematic representation of the resistance between two adjacent electrodes in another embodiment of the methods and systems disclosed here;

FIG. 13 is a schematic diagram of exemplary control circuits for actuating or energizing electrodes in an electrophoretic device of certain embodiments of the systems and methods disclosed here;

FIG. 14 is a schematic drawing of another embodiment of an electrophoretic device suitable for use in systems and method in accordance with the certain embodiments;

FIGS. 15A and 15B each is a graphical representation of the field strength profile and potential profile, respectively, of a linear field gradient (15.5 v/cm2) in accordance with another embodiment of the methods and systems disclosed here;

FIG. 16 is a schematic diagram of an exemplary PC-based system for electric field gradient control in an electrophoretic device of certain systems and methods disclosed here;

FIG. 17 is a circuit diagram of a representative controller unit, in accordance with certain embodiments;

FIG. 18 is a circuit diagram of a representative controller unit, in accordance with certain embodiments;

FIG. 19 is a schematic illustration of a representative DAC board circuit diagram illustrating connections, in accordance with certain embodiments;

FIGS. 20A and 20B are schematic illustrations of a representative DAC board circuit diagram illustrating components, in accordance with certain embodiments;

FIG. 21 is a schematic of a system in accordance with one embodiment, capable of functioning as a “notch filter;”

FIG. 22 illustrates multiple electrophoretic devices combined in series and parallel configuration suitable for certain embodiments of the systems and methods disclosed here, which arrangement may be referred to as a multiplexer or as an electrophoretic multiplexer;

FIG. 23 is a graph further illustrating the principles of EFGF, in accordance with certain embodiments;

FIG. 24 is a series of images showing three injected proteins coming into focus, in accordance with certain embodiments;

FIG. 25 shows top views, a cross sectional side view, and a cross-sectional end view, respectively, of an exemplary device, in accordance with certain embodiments;

FIG. 26 is a schematic illustration of an exemplary system in accordance with certain embodiments;

FIG. 27 is a schematic illustration of an exemplary dual-device system in accordance with certain embodiments;

FIG. 28 is a series of images showing focused bands being eluted from an exemplary separation chamber in accordance with certain embodiments;

FIGS. 29A and 29B are top and isometric views, respectively, of a diverter suitable for use in certain systems and methods disclosed here, in accordance with certain embodiments;

FIGS. 30A and 30B are top and isometric views, respectively, of a general fluidic interface manifold suitable for use in certain systems and methods disclosed here;

FIGS. 31A and 31B are top and isometric views, respectively, of a top block suitable for use in certain systems and methods disclosed here;

FIG. 32 is a separation channel layer suitable for use in certain systems and methods disclosed here;

FIGS. 33A and 33B are top and isometric views, respectively, of a bottom block suitable for use in certain systems and methods disclosed here;

FIG. 34 is an exploded isometric view of an exemplary system incorporating the elements illustrated in FIGS. 29-33;

FIG. 35 is a schematic of an exemplary system in accordance with the present certain embodiments;

FIG. 36 is a schematic of an exemplary dual-device system in accordance with certain embodiments;

FIG. 37 is a schematic of an alternative dual-device system in accordance with certain embodiments;

FIG. 38 shows a graph showing effect of applied voltage on the magnitude of the electric field gradient in an exemplary electrode chamber, in accordance with certain preferred embodiments;

FIG. 39 is a schematic of showing the general shape of an electrode chamber and the relative location of 4 electrodes (electrodes 1-3 are anodes and electrode 4 is a cathode), in accordance with certain preferred embodiments;

FIG. 40 is a graph showing multiple linear segments of an electric field gradient in which the segments have differing slopes, in accordance with certain preferred embodiments;

FIG. 41 is a graph showing an elution profile of a separation experiment using an exemplary electrophoretic device, in accordance with certain preferred embodiments;

FIG. 42 is another graph showing an elution profile results of a separation experiment using an exemplary electrophoretic device, in accordance with certain preferred embodiments;

FIG. 43 is another graph showing an elution profile of a separation experiment using an exemplary electrophoretic device, in accordance with certain preferred embodiments;

FIGS. 44 and 45 are photographs showing the separation of dyes at various time points, in accordance with certain preferred embodiments; and

FIGS. 46 and 47 are photographs showing the separation of dyes at various time points, in accordance with certain preferred embodiments;

FIG. 48 is an example of an electrophoretic device comprising 4 electrodes, in accordance with certain preferred embodiments;

It will be recognized that certain components or features shown in the figures may not be necessarily to scale and that certain features may be enlarged or distorted relative to other features to facilitate understanding of the exemplary devices and methods disclosed herein.

### DETAILED DESCRIPTION OF CERTAIN EXAMPLES

Unless otherwise indicated or unless otherwise clear from the context in which it is described, aspects or features of particular devices and methods disclosed here, e.g., disclosed by way of example in one or more preferred embodiments, should be understood to be disclosed generally for use in all other embodiments of the devices and methods disclosed here. Also, in accordance with traditional patent usage, the use of the indefinite article “a” here and in the appended claims is intended to mean one or more than one, that is, at least one, unless otherwise clear from the context in which it is used. It should be understood that the mere usage of the phrase “at least one” or like phrases in certain instances, is alone not an indication that usages of the individual article “a” in other instances means only one.

As used here, the term “electrophoretic device” refers to devices that employ opposing hydrodynamic and electrophoretic forces to affect or control the location of an analyte, such as a charged analyte, for example, within a flow of fluid through the device.

As used here, the term “sample treatment device” includes any device designed to accept, treat and release a sample contained in a fluid.

As used here, the term “operative fluidic requirements” refers to the sample treatment device requirements for the fluid containing at least one charged analyte, including, but not limited to: flow rate, time-scale, solute concentration, solute content or solvent composition.

As used here, the term “fluidic parameters” refers to the actual parameters exhibited by the fluid at a given point in time, and are inclusive of all parameters included under the term “operative fluidic parameters.”

As used here, the term “focus” and other forms of that word are used generally to mean concentrating and holding a desired analyte (i.e., a target species dissolved or suspended in a sample fluid) in the separation chamber of an electrophoretic device in accordance with the above disclosure. It will be readily understood that this inherently includes separating that analyte from the carrier fluid and optionally from one or more other analytes that do not concentrate at the same location in the channel under the focusing process parameters employed. The term “separating” and other forms of that word, unless otherwise indicated by context or the like, generally are used to describe the result of the present invention, optionally employing molecular sieve in the separation chamber, i.e., separating the desired analyte from the sample fluid and, in certain preferred embodiments, from other analytes. As noted above, the electrode chamber includes electrodes for generating a focusing electric field gradient. The separation chamber is in electrical communication and mass or ionic communication with the electrode chamber through the porous, conductive membrane. “Communication” or “electrical communication” as used herein refers to the ability of the electric field that is generated by the electrode array to be transferred, or to have an effect, within the separation chamber, and may be by any means which accomplishes this.

The porous membrane retains analytes in the separation chamber and is permeable to certain molecules such that the electrode chamber and separation chamber are in communication as noted above. Generally, an eluant is introduced into and flows through the separation chamber containing the charged analyte. The eluant flow is opposed to the direction of electrophoretic migration of the analyte. As noted above, a “configured” chamber refers to a chamber, i.e. a separation chamber or an electrode chamber, that has a non-uniform cross-section flow channel, that is to say, the cross-sectional area of the separation chamber varies axially along the chamber. It will of course be apparent to the person of ordinary skill in the art, given the benefit of this disclosure, that such configuration or non-uniformity affects the nature and characteristics of the electric field.

In accordance with certain examples, the electrophoretic devices may be configured for use horizontally or vertically. In horizontal electrophoretic devices, the sample fluid typically enters at one end of the separation chamber, e.g., the left side, and exits at the other end of the separation chamber, e.g. the right side, or at sampling ports at various positions along the separation chamber. In vertical electrophoretic devices, the sample fluid can enter the top of the device and exit at the bottom of the device, or at the sides of the device, or the sample fluid can enter at the bottom of the device and exit at the top of the device or the sides of the device. It will be within the ability of the person of ordinary skill in the art, given the benefit of this disclosure, to select and design suitable horizontal and vertical electrophoretic devices.

In accordance with certain examples, an electrophoretic device, such as an electrophoretic device employed in processing systems or methods disclosed here, has a configured separation chamber, i.e., a non-uniform separation chamber with a cross-sectional area, and optionally shape, of the separation chamber varying along the direction of flow through the separation chamber. Typically, the separation chamber is elongate, with flow through the chamber being along the longitudinal axis. In embodiments having a non-uniform separation chamber, the cross-sectional area of the chamber typically varies significantly along the longitudinal axis of the chamber. In this regard, varying cross-sectional area should be understood to mean more significant cross-sectional change than, e.g., the end fairing of typical cylindrical glass lab ware. In operation of such electrophoretic devices in a system or method disclosed here, the electrodes generate an electric field into the separation chamber, where the non-uniformity of the separation chamber induces or effectively causes a gradient effect in the electric field. The non-uniformity of the separation chamber further leads to a gradient effect in the hydrodynamic force of a sample fluid flowing through the chamber. In certain embodiments having a non-uniform separation chamber, the separation chamber comprises a non-uniform tube, e.g., a frustro-conical configuration in which cross-sectional area increases or decreases along the direction of sample fluid flow through the chamber. In certain embodiments having a non-uniform separation chamber, the electrophoretic device has a planar configuration, wherein the membrane between the separation chamber and the electrodes is flat or planar and forms one wall of the separation chamber. The separation chamber in such cases may have a substantially uniform height (height here meaning the direction normal to the plane of the membrane) and a non-uniform or non-constant width (width here meaning the direction perpendicular to the overall direction of sample fluid flow and parallel to the plane of the membrane). In other embodiments, the separation chamber has a substantially uniform width and a varying or non-uniform height. In yet other embodiments, a separation chamber of non-uniform width and non-uniform height is used. Yet other embodiments employ a separation chamber defined by one or more non-linear or non-flat walls, for example, a wall comprised of a series of faces or facets, some or all having varying dimensions; or wherein the separation chamber has a curved cross-section, such as, for example, a half-circular cross-section, that varies axially, as, for example, a half-cone-shaped chamber. Other suitable configurations will be readily apparent to the person of ordinary skill in the art given the benefit of this disclosure.

In accordance with certain examples, an electrophoretic device, such as an electrophoretic device employed in processing systems or methods disclosed here, has a configured electrode chamber, i.e., a non-uniform electrode chamber with a cross-sectional area, and optionally shape, varying significantly along the direction of flow, i.e., varies in a manner which influences the electric field gradient profile sufficiently to usefully impact the location, speed or efficiency of focusing of the target analyte. In embodiments having a non-uniform electrode chamber, the cross-sectional area of the electrode chamber likewise varies significantly along the direction of the flow. In this regard, varying cross-sectional area should be understood to mean more significant cross-sectional change than, e.g., the end fairing of typical cylindrical glass lab ware. In operation of such electrophoretic devices in the systems and methods disclosed here, the electrodes generate an electric field into the separation chamber, and the non-uniformity of the electrode chamber induces or effectively causes or alters the gradient effect in the electric field. The electrode chamber may, for example, be in the form of a non-uniform tube, e.g., a frustro-conical configuration in which cross-sectional area increases or decreases along the direction of sample fluid flow. In certain embodiments the electrophoretic device has a planar configuration, wherein the membrane between the separation chamber and the electrodes is flat or planar and forms a shared wall between the separation chamber and the electrode chamber. The electrode chamber in such cases may have a substantially uniform height (height here meaning the direction normal to the plane of the membrane) and a non-uniform or non-constant width (width here meaning the direction perpendicular to the overall direction of sample fluid flow and parallel to the plane of the membrane). In other such embodiments, the electrode chamber has a substantially uniform width and a varying or non-uniform height. Other such embodiments employ an electrode chamber of non-uniform width and non-uniform height. Other such embodiments employ a electrode chamber defined by one or more non-linear or non-flat walls, for example, a wall comprised of a series of faces or facets, some or all having varying dimensions; or wherein the electrode chamber has a curved cross-section, such as, for example, a half-circular cross-section, that varies axially, as, for example, a half-cone-shaped chamber. Other suitable configurations will be apparent to those skilled in the art given the benefit of this disclosure. In general, the separation chamber optionally is non-uniform, i.e., has a configuration the same as or similar to any of the configurations disclosed above for the electrode chamber.

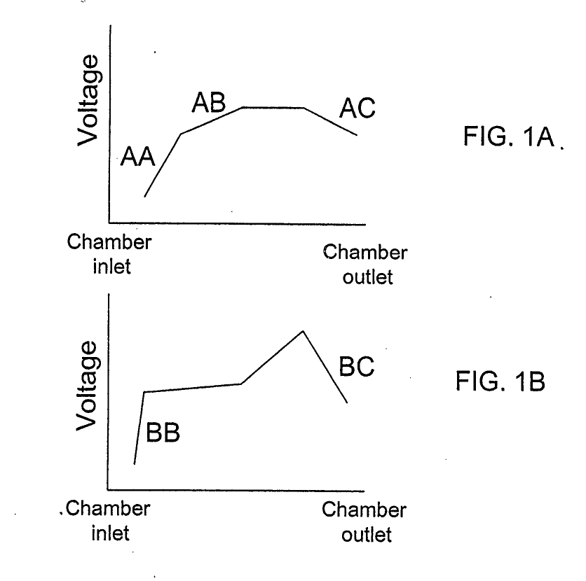

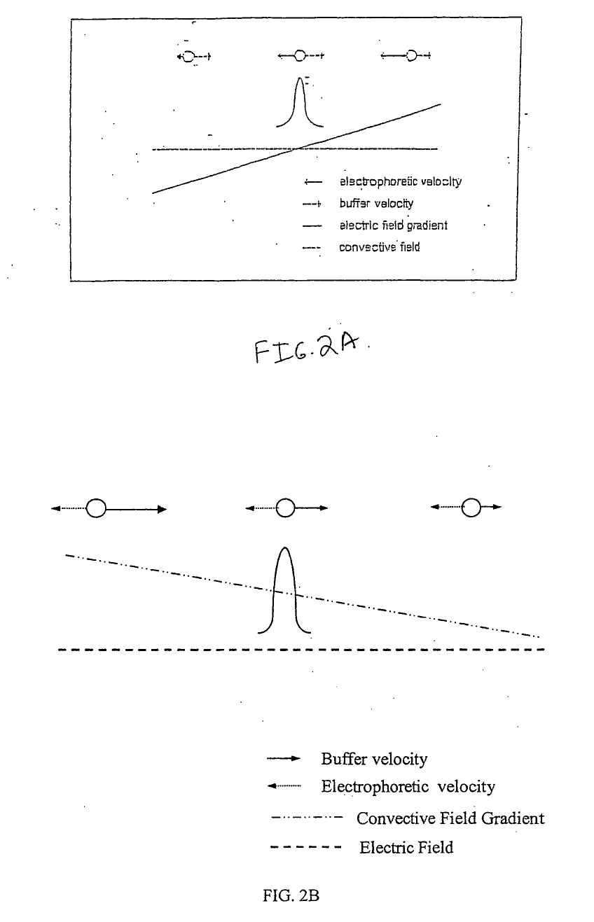

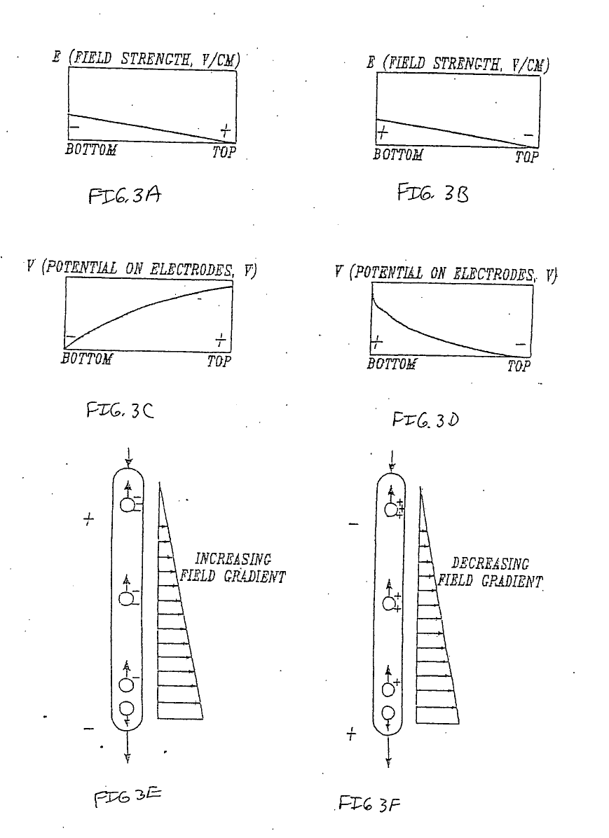

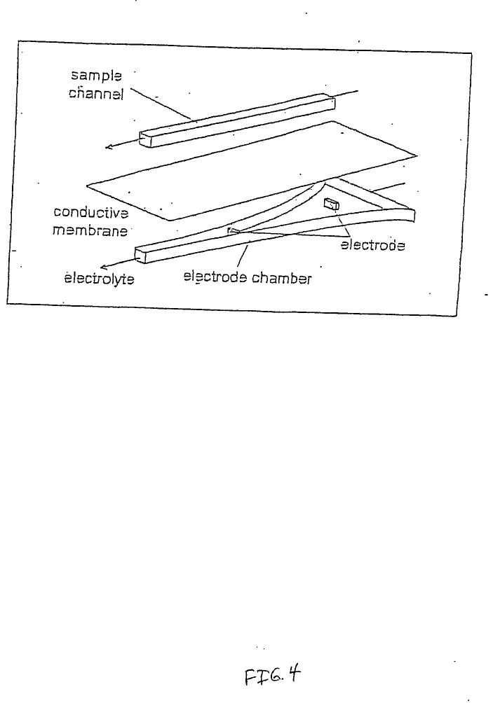

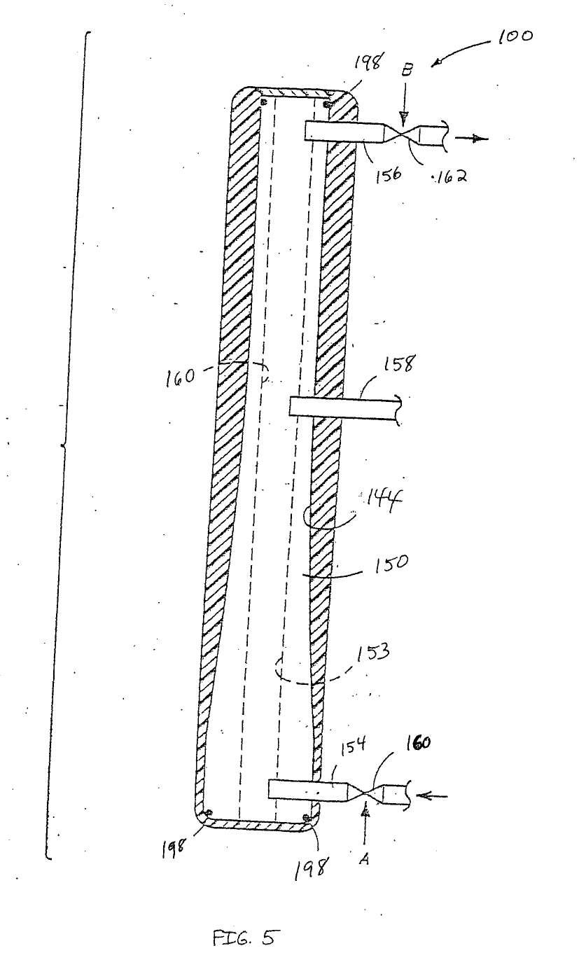

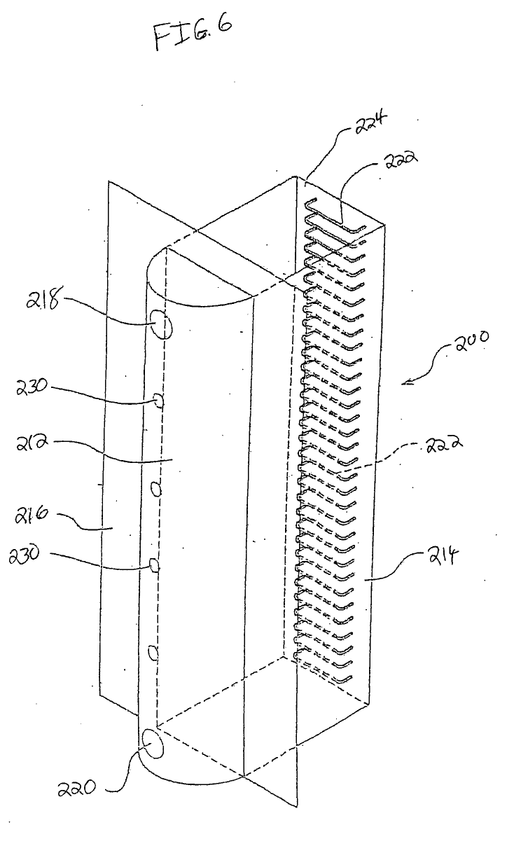

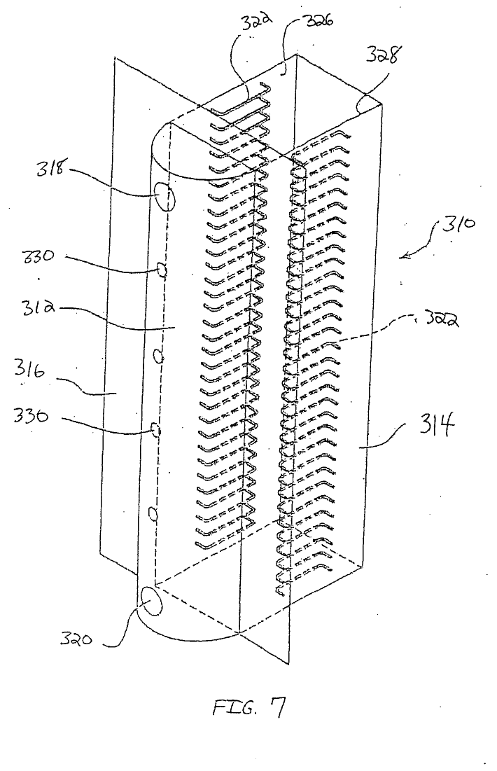

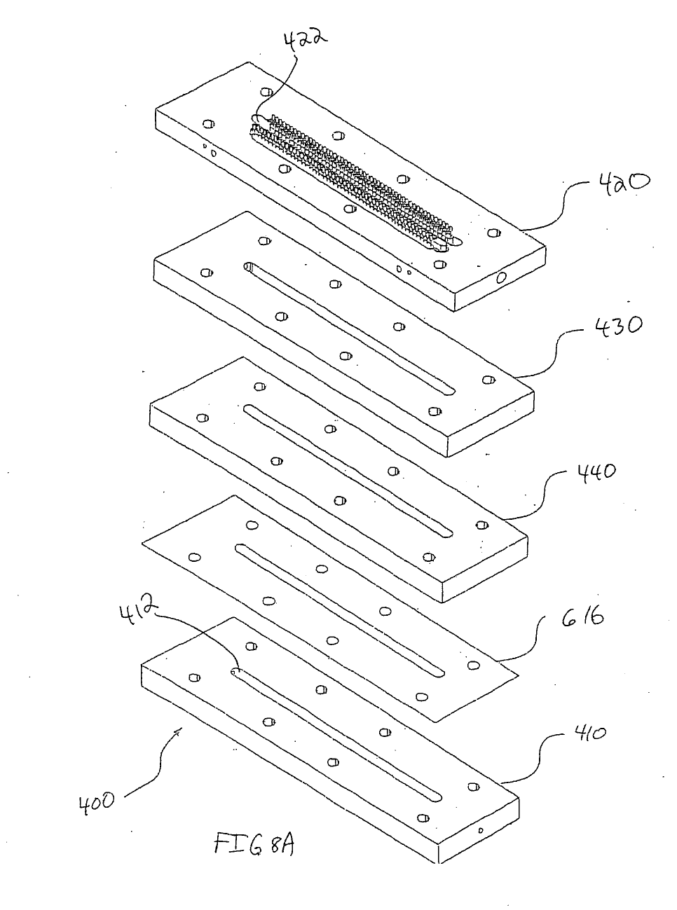

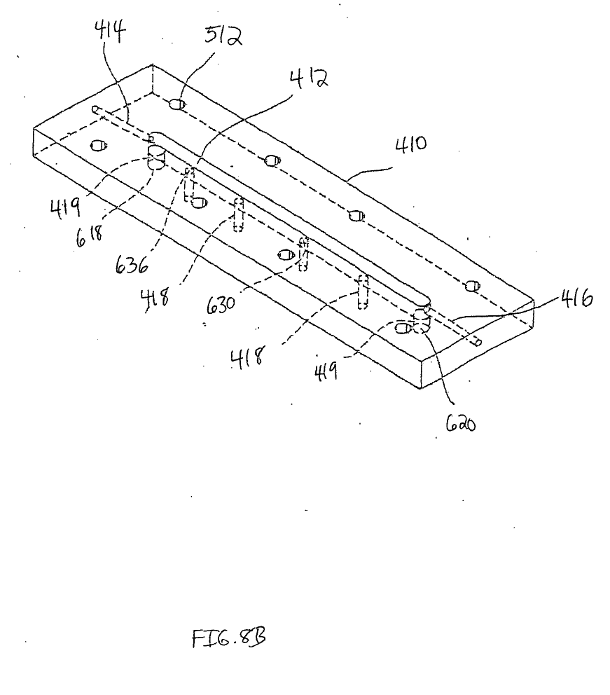

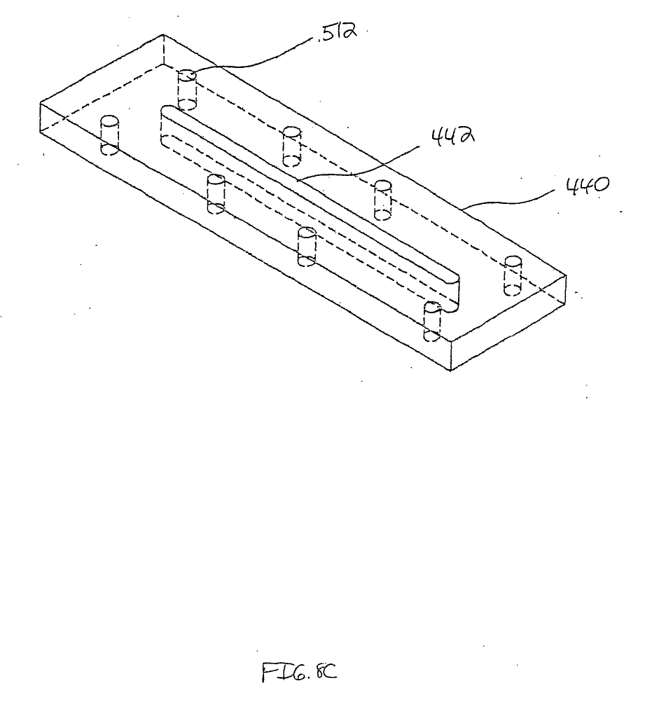

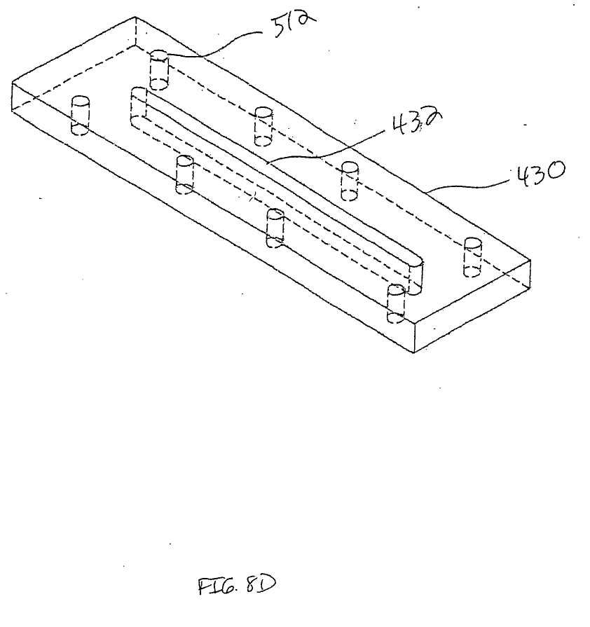

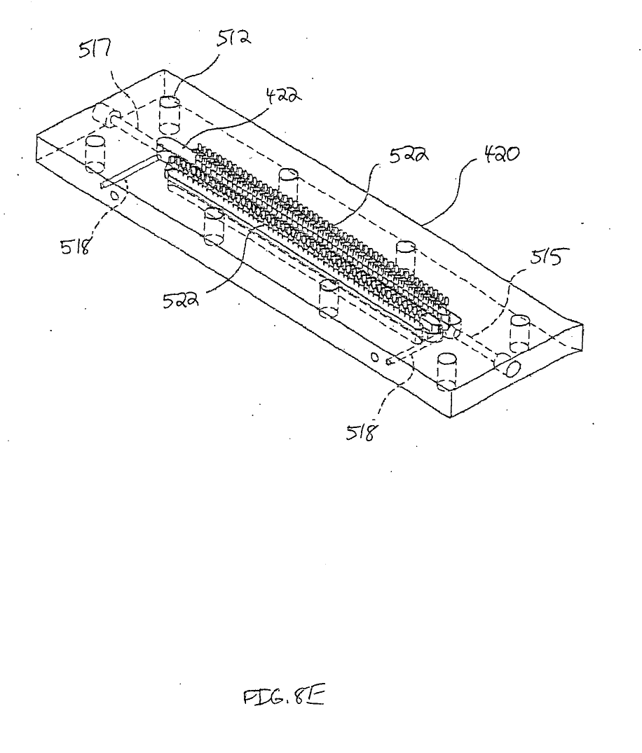

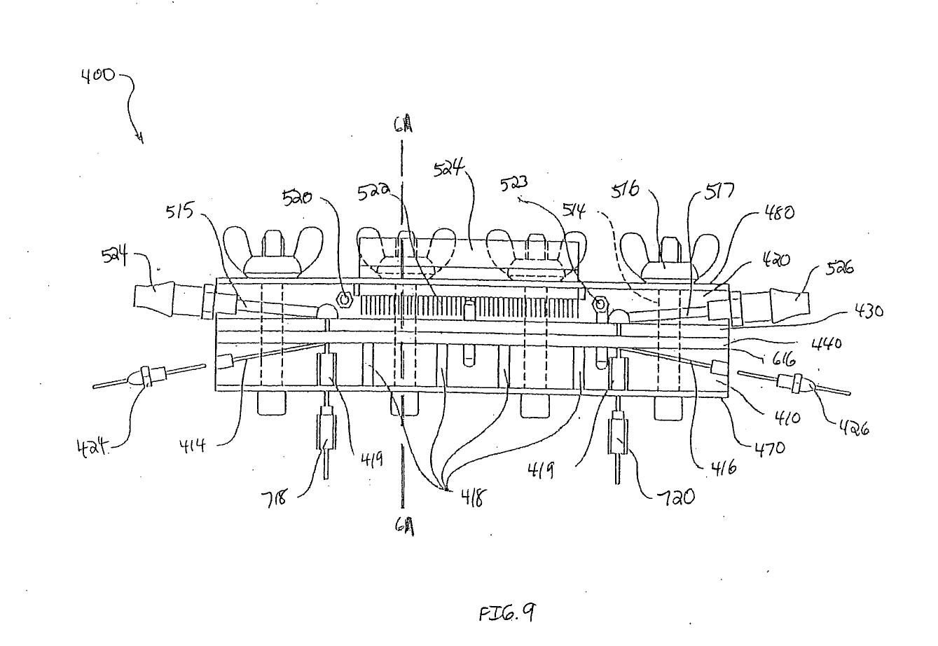

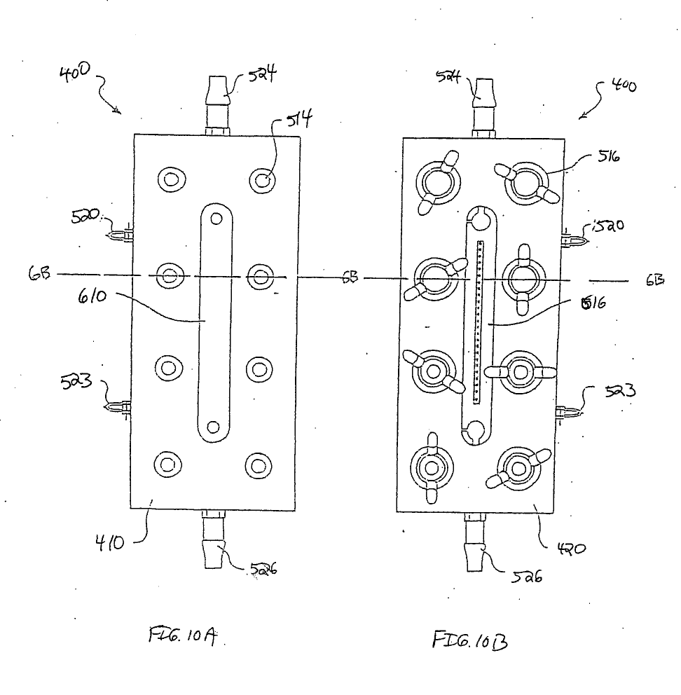

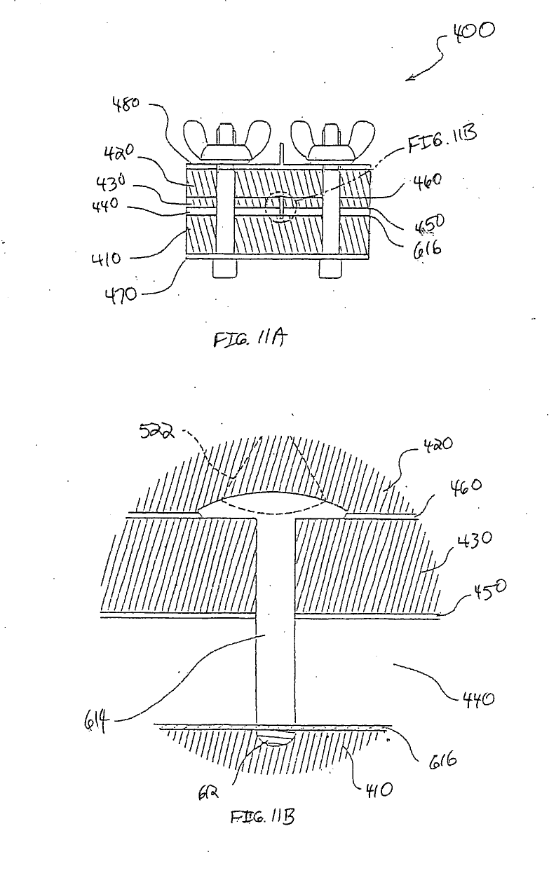

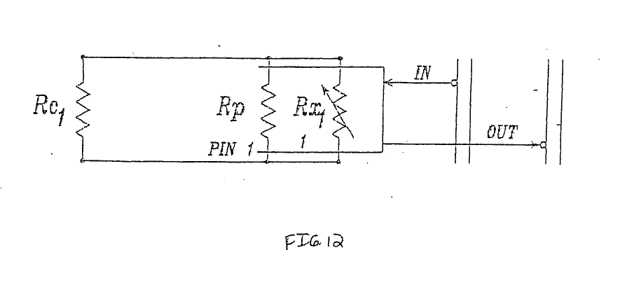

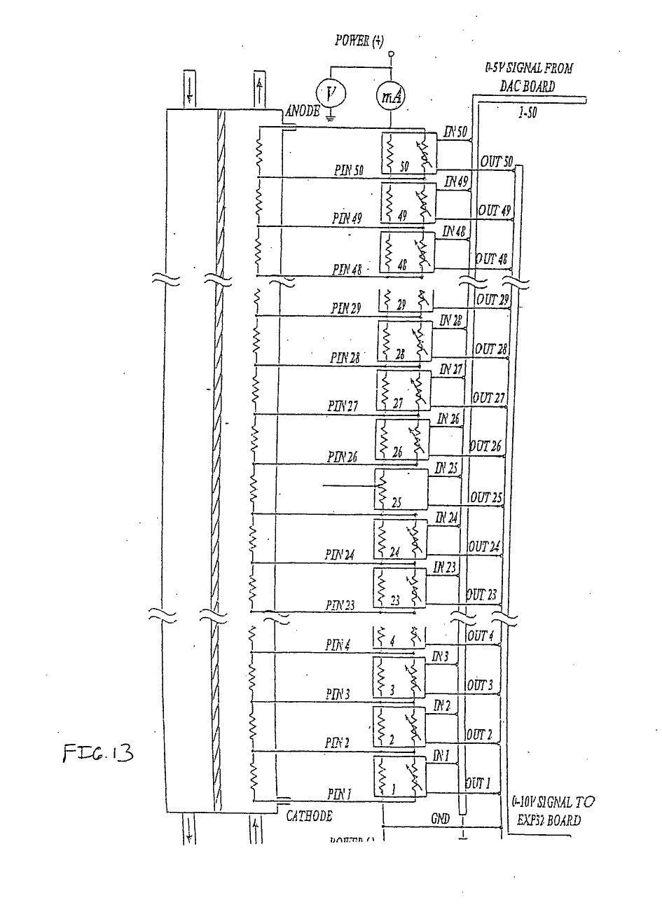

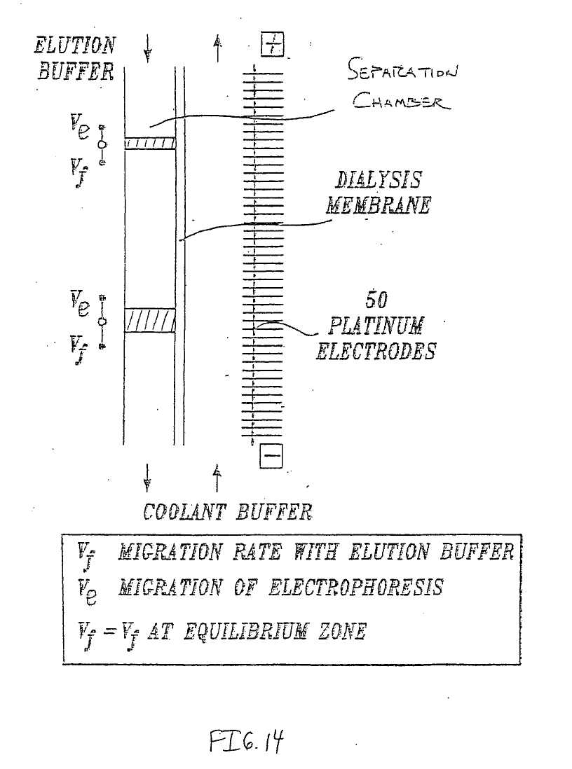

In accordance with certain preferred embodiments, the electric field gradient used in the electrophoretic devices disclosed here may be composed of multiple linear segments having differing slopes. For example, a first linear segment with a first slope may exist between a first electrode and a second electrode, and a second linear segment may exist between the second electrode and a third electrode. The slope of the second linear segment may be greater than or less than the slope of the first linear segment. Referring to FIG. 1A, the slope of the electric field at the portion of the separation chamber near the inlet port, shown as AA in FIG. 1A, is much steeper than the slope of the electric field toward the outlet port, shown as AB in FIG. 1A. Referring to FIG. 1B, the slope of the electric field at the inlet of the separation chamber, shown as B-B in FIG. 1B, is greater than the slope of the electric field in the corresponding section of chamber shown in FIG. 1A. The gradient defined by segment BB is said to be steeper than the gradient defined by segment AA. Without wishing to be bound by any particular scientific theory, the electric field is defined by the change in voltage divided by the change in length (Δ V/Δ 1). The shape of the electrode chamber defines the shape of the gradient and the electrodes, e.g. the number and placement of the electrodes, defines the different segments of the gradients. By using more electrodes, it is possible to increase the number of segments. Again without wishing to be bound by any particular scientific theory, a shallow gradient, i.e., one with a lower slope, provides better separation between analytes having similar properties. By using a device having multiple segments with differing slopes, different analytes can be separated in a different manner depending on the location of the separation chamber. As a rough approximation, the distance between bands is proportional to the inverse of the electric field gradient. For example, by using an electrophoretic device with a first steep gradient, such as AA shown in FIG. 1A, the analyte bands can be stacked. By using a second gradient in the same electrophoretic device, such as shallow gradient AB in FIG. 1A, closely spaced analytes can be resolved to a higher degree, e.g., interband distance can be increased. In this example, the first steep gradient stacks the bands as they enter the electrophoretic device and the second, shallow gradient separates the bands as they move along the length of the separation chamber. The person of ordinary skill in the art, given the benefit of this disclosure, will be able to design suitable electrophoretic devices having steep, shallow and other gradients suitable for an intended separation.

In accordance with other preferred embodiments, the electric field gradient may be non-linear, for example, parabolic, hyperbolic, etc. depending on the shape of the electrode chamber and/or separation chamber and depending on the selected voltage values applied to the electrodes that generate the electric field. For example, in certain embodiments, four electrodes (3 anodes and a cathode) can be used to generate either linear electric fields or parabolic electric fields or linear or parabolic segments of electric fields. Without wishing to be bound by any particular scientific theory, the shape of the electrode chamber defines the shape of the gradient, e.g., linear or parabolic, and the electrodes, e.g. the number and placement of the electrodes, defines the different segments of the gradients. It will be within the ability of the person of ordinary skill in the art to design suitable electrode chambers for generating a desired electric field gradient.

In accordance with certain examples, outlet ports and/or sampling ports of the electrophoretic devices disclosed here preferably are positioned in a portion of the separation chamber that experiences an electric field with increasing slope. Without wishing to be bound by any particular scientific theory, in areas of decreasing electric field, such as AC in FIG. 1A and BC in FIG. 1B, separated analyte bands can become defocused. To avoid off-loading or sampling defocused bands, the outlet port or sampling port can be positioned within an electric field segment with increasing slope. It will be within the ability of the person of ordinary skill in the art, given the benefit of this disclosure, to position outlet and sampling ports in suitable positions along the length of the separation chamber of electrophoretic devices disclosed here.

In accordance with certain examples, an electric field can be established and maintained in the separation chamber using an electrode array, typically located within or proximate the electrode chamber, in which the voltages of the electrodes typically are individually monitored and controlled to influence the shape and/or strength of the gradient in the electric field, with or without adjustment or change during the focusing process. Optionally, for example, the voltage applied to each electrode is controlled by a computer-controlled circuit board or suitable processor or the like in operative connection to a suitable voltage source. In certain preferred embodiments, the electrode array is used to dynamically control the electric field gradient during the focusing process, for example, to shift the location of a stationary focused band within the separation chamber to bring the band over an optional off-take port located on the separation chamber from which the band can be selectively removed.

In accordance with certain preferred embodiments, devices and methods are provided, whereby two or more proteins or other biomacromolecules which have the same or similar charge to mass ratios or electrophoretic mobilities but different size, can be focused from the same fluid sample in the separation chamber of a device as disclosed above. Each such biomacromolecule can be concentrated at a location in the channel spatially separated from the locations at which others of the biomacromolecules are focused. In accordance with the principles disclosed above, the focusing locations of the different biomacromolecules are stable during the focusing process, that is, each of such analytes can be held at its respective focusing location in the channel during and after the focusing process.

In certain preferred embodiments or examples of the electrophoretic devices and hyphenated systems and methods disclosed here, the electrodes of the electrophoretic device comprise a pair of electrodes, typically being positioned in an electrode chamber, with each electrode of the pair being located at or near a corresponding end of the separation chamber. In other embodiments, the electrophoretic device comprises multiple electrodes, that is, more than two electrodes arranged along the chamber length, for example, about four electrodes spaced equally or non-equally along the electrode chamber. Other suitable electrode configurations will be apparent to those skilled in the art given the benefit of this disclosure. Optionally, each electrode is capable of being individually controlled, i.e., energized at a voltage selected independently of the voltage level of other electrodes in the array in order to achieve good control of the strength and gradient profile of the electric field at each point along its length. In certain embodiments the electrode array is operative to generate an electric field gradient profile, e.g. an electric field gradient having multiple linear segments of differing slope. That is, the electrode array can be energized in a controlled manner to create a gradient in the electric field in the separation chamber, and the shape and/or strength of the field is also influenced by non-uniformity of the separation chamber, electrode chamber, or both. In certain preferred embodiments, the electrode array is operative to generate an electric field gradient profile in the separation chamber which can be dynamically controlled. As used here, dynamic control of the electric field may include varying the strength of the electric field over time and/or location in the separation chamber. An individual manual control may be provided for each of the electrodes (or at least for some of the electrodes) of the array, or the controller may include a computer interface between an operator and circuitry configured to control the energization level of the individual electrodes to produce a gradient profile specified by the operator. The voltages of the electrodes typically are individually monitored and controlled to influence the shape and/or strength of the gradient in the electric field, with or without adjustment or change during the focusing process. Optionally, for example, the voltage applied to each electrode is controlled by a computer-controlled circuit board or suitable processor or the like in operative connection to a suitable voltage source. In certain preferred embodiments, the electrode array is used to dynamically control the electric field gradient during the focusing process, for example, to shift the location of a stationary focused band of analyte within the separation chamber. The position of the focused band may be controlled, for example, to bring the band to an off-take port, e.g., a port at an intermediate located along the separation chamber, between the main inlet port and main outlet port of the chamber. Other suitable control apparatus and techniques will be apparent to those skilled in the art given the benefit of this disclosure.

In accordance with other preferred embodiments of the devices and systems disclosed herein further comprise molecular sieve in the separation chamber. The molecular sieve is operative to shift the location at which a stationary focused band of charged analyte forms in the separation chamber under a given set of focusing parameters. The molecular sieve advantageously enables separation of two or more molecules, for example, two or more proteins or other biomacromolecules, which have the same or similar charge to mass ratios or electrophoretic mobilities but different size. The molecular sieve in certain preferred embodiments comprises a gel, for example an organic or an inorganic gel or a mixture thereof. The molecular sieve may be fixed in the sample chamber or may be soluble. Fixed molecular sieve may occupy any suitable portion of the volume of the separation chamber, preferably substantially the entire volume of the separation chamber. Soluble molecular sieve preferably is incorporated into a fluid sample containing the target analyte to be focused. Materials suitable for use as the molecular sieve in a device as disclosed here are further discussed below and, in general, are operative in conjunction with the other components of the device, for the intended analyte(s), under a suitable set of focusing process parameters, to shift the location at which a charged analyte is focused and held in the focusing chamber as a function of the size or molecular weight of the molecule.

Certain embodiments of the systems and methods disclosed here for sample management comprise multiple electrophoretic devices. In certain embodiments electrophoretic devises are combined (optionally with other devices in between and/or upstream or downstream) in series or in parallel or in a combination of series and parallel. Good sample management can be achieved with such systems, including capability to focus and further processing of different analytes simultaneously or at different times, etc.

In accordance with certain preferred embodiments, in operation under suitable focusing process parameters, the channels or chambers of the devices disclosed above typically are filled with fluid sufficiently electrically conductive to establish an electric field gradient in the separation chamber or chamber when the electrodes of the electrode chamber are energized. The porous, conductive membrane between the chambers preferably is operative to establish selective communication between the separation chamber and the electrode chamber, at least sufficiently to provide selective mass transport between the chambers, but prevents the target analyte from passing to the electrode chamber. In those embodiments described here that comprise a porous membrane, the membrane is at least conductive in that it does not prevent or substantially alter the electric field in the chamber and it is porous in the sense that it is permeable to buffer species or the like without allowing contact of the target analyte with the electrodes. In certain embodiments, the membrane does not substantially affect the electric field generated by the electrodes and does not affect the electric field experienced by the separation chamber. The separation and electrode chambers typically are elongate and partly or wholly overlying one another in their longitudinal dimension. As discussed herein, the electrodes of the electrode chamber are operative to establish an electric field in the electrode chamber, which is communicated through the porous conductive membrane to the separation chamber. A gradient is induced in the electric field by the non-uniformity of the electrode chamber, either alone or, where existent, in combination with the non-uniformity of the separation chamber and/or the number of electrodes. In at least certain examples, the number of electrodes provides the desired operational segments of the electric field gradient.

In accordance with certain preferred embodiments, processing systems employing electrophoretic devices disclosed here allow for electrofocusing of analytes or target molecules, including but not limited to biomacromolecules, e.g., proteins, etc. They may have one or more than one of the electrophoretic devices discussed herein. In accordance with certain preferred embodiments, such processing systems comprise automated sample injection, a pump or pump module for generation of the focusing chromatographic flow, a cooling and degassing module, and a focusing or separation chamber with associated electrode chamber and conductive membrane. Certain preferred embodiments of such electrophoresis systems have utility especially in the hyphenation of analytical instruments. For example, one or more of the electrophoretic devices are employed as a bridge in a hyphenated system to resolve dissimilar flow rates, processing times, dissimilar pressures, etc. More specifically, for example, the electrophoretic device(s) may be positioned downstream of a high pressure liquid chromatography (HPLC) system. The electrophoretic device(s) are in fluid communication with the outlet port of the HPLC column and/or an outlet port of an HPLC flow cell detector to receive and hold analyte stepped off the column in one or a series of multiple runs. When sufficient analyte is concentrated in the electrophoretic device(s), it can be released to an analysis device, such as, for example, an NMR device, e.g., a capillary scale NMR (capNMR), or to a mass spectrometer (MS). An HPLC device typically processes milliliters per minute, whereas capNMR or MS typically process microliters per minute. The electrophoretic device(s) perform as a bridge in the hyphenated system (i.e., in a HPLC-MS or HPLC-capNMR system) to resolve the dissimilar flow rates, processing times, etc.

In certain embodiments or examples of the hyphenated systems and methods disclosed here, the electrodes of the electrophoretic device are not positioned within an electrode chamber. In certain such embodiments the separation chamber comprises a uniform or non-uniform tube, with electrodes plated or otherwise formed on the interior surface of the tube and coated with a porous, conductive coating. The porous coating preferably is chosen such that it allows small molecules such as buffer ions to pass but prohibits molecules of the size of the analytes from passing through and contacting the electrodes. In other embodiments, the electrodes are plated or otherwise formed on the exterior of the separation chamber. Other suitable configurations of electrophoretic devices that lack an electrode chamber will be readily apparent to the person or ordinary skill in the art, given the benefit of this disclosure.

In accordance with certain embodiments or examples of the hyphenated systems and methods disclosed here, the electrophoretic devices used in such systems and methods have a configured or non-uniform electrode chamber separated from the separation chamber by a porous, conductive membrane. Electrodes are positioned in the electrode chamber and are operative when energized or actuated to generate an electric field, e.g. an electric field with multiple linear segments of differing slopes, in the separation chamber. As discussed above, the electrode chamber is configured or non-uniform, meaning that it has a non-uniform cross-section. That is, the cross-sectional area, and optionally the shape, of the electrode chamber varies in the direction of flow. Typically, the electrode chamber is elongate and corresponds generally to an elongate separation chamber, with flow of buffer or cooling fluid through the electrode chamber being along its longitudinal axis. In embodiments having an elongate, non-uniform electrode chamber, the cross-sectional area of the chamber typically varies significantly along its longitudinal axis. In this regard, varying cross-sectional area should be understood to mean more significant cross-sectional change than, e.g., end fairing such as might be found in typical cylindrical glass lab ware. In operation of such electrophoretic device in a system or method disclosed here, the electrodes generate an electric field which extends through the membrane into the separation chamber, and the non-uniformity of the electrode chamber induces or effectively causes (or contributes to) a gradient effect in the electric field in the separation chamber along the direction of sample fluid flow through the separation chamber. In certain embodiments having a non-uniform electrode chamber, the electrode chamber comprises a non-uniform tube, e.g., a frustro-conical configuration in which cross-sectional area increases or decreases along the direction of fluid flow through the chamber. In certain embodiments having a non-uniform electrode chamber, the electrophoretic device has a planar configuration, wherein the membrane between the separation chamber and the electrode chamber is flat or planar and forms one wall of the electrode chamber. The electrode chamber in such cases may have a substantially uniform height (height here meaning the direction normal to the plane of the membrane) and a non-uniform or non-constant width (width here meaning the direction perpendicular to the overall direction of fluid flow and parallel to the plane of the membrane). In other such embodiments, the electrode chamber has a substantially uniform width and a varying or non-uniform height. Other such embodiments employ an electrode chamber of non-uniform width and non-uniform height. Other such embodiments employ an electrode chamber defined by one or more non-linear or non-flat walls, for example, a wall comprised of a series of faces or facets, some or all having varying dimensions; or wherein the electrode chamber has a curved cross-section, such as, for example, a half-circular cross-section, that varies axially, as, for example, a half-cone-shaped chamber. Other suitable control configurations will be apparent to those skilled in the art given the benefit of this disclosure. In certain embodiments or examples of the hyphenated systems and methods disclosed here, the electrophoretic device comprises both a configured electrode chamber and a configured separation chamber, each in accordance with the principles disclosed here.

As noted above, the electrophoretic devices of the systems and methods disclosed here comprise a separation chamber through which a sample fluid flows. In operation under suitable focusing process parameters, the channels or chambers of the electrophoretic devices typically are filled with fluid, e.g., buffer solution, which permit an electric field gradient in the separation chamber when the electrodes of the electrophoretic device are energized. In typical embodiments having an electrode chamber and a porous membrane between the electrode chamber and the separation chamber, the membrane preferably is operative to establish selective mass transport, e.g., transport of buffer species, between the separation chamber and the electrode chamber, but prevents the target analyte from passing to the electrode chamber. The separation and electrode chambers typically are elongate, adjacent to each other, and substantially coextensive, with flow passing in the longitudinal direction. In certain embodiments, a gradient is established in the electric field in the separation chamber in the direction of flow. As disclosed above, such gradient can be induced by non-uniformity of the separation chamber, non-uniformity of the electrode chamber and/or the controlled energizing of an electrode array. Additionally, where the embodiments include a non-uniform separation chamber, a gradient in the direction of flow is induced in the flow rate of a fluid flowing through the separation chamber.

In accordance with certain preferred embodiments, the electric field gradient is established in the separation chamber such that a charged analyte flowed into the chamber will be subject to an electrophoretic force in a direction opposite to the direction of flow. That is, the electrophoretic force opposes the hydrodynamic force of the flowing fluid. Without wishing to be bound by any particular scientific theory, the magnitude of the electrophoretic force is determined by the net or apparent charge of the analyte and by its location within the electric field gradient, while the hydrodynamic force is determined by the hydrodynamic radius of the analyte and by the viscosity and speed of the flowing fluid. At some point in the separation chamber, the hydrodynamic force and the opposing electrophoretic force on a charged analyte will balance out, i.e., will equal each other in magnitude, and the analyte will be substantially held at that point. As sample fluid continues to flow through the separation chamber, analyte continues to focus into a band at the equilibrium point. By using the electrophoretic devices and systems disclosed here, dilute samples can be concentrated and off-loaded for analysis and further processing.

It will be apparent to the person of ordinary skilled in the art, given the benefit of this disclosure, that the electrophoretic devices, processing systems and methods disclosed here have application in a wide variety of research, development and industrial applications. The following preferred embodiments are discussed below for illustration and as examples, and not necessarily to limit the scope of the invention. These and other suitable embodiments are able to provide hyphenation of analytical instruments by eliminating or sufficiently reducing dissimilarities in system parameters, without unacceptable loss of target sample. In certain examples, the electrophoretic devices consolidates the features of buffer exchange, solute concentration, solute separation, solute collection, and selective solute routing into a single device for sample management.

In accordance with certain preferred embodiments, an electrophoretic device comprising a single electrophoresis unit with a single separation chamber or multiple such units in a series and/or parallel array provides a universal solution for hyphenation of analytical instruments where there exists a dissimilarity in system parameters including, but not limited to: flow rate, time-scale, solute concentration, solute content or solvent composition. Such electrophoretic devices may in some instances be referred to below as a sample peak universal router or “SPUR” device. SPUR devices, as disclosed above, have application in sample management by providing a dynamic platform for routing and preparation of target solutes for subsequent analysis. Without wishing to be bound by any particular scientific theory, it is presently understood, as discussed above, that the electrophoretic devices described here are based on the principle of opposing counteracting forces that in combination create a dynamic equilibrium point. The force in one direction results from bulk fluid flow, which imposes a hydrodynamic force or velocity on solutes in the stream. Again without wishing to be bound by any particular scientific theory, the magnitude of the hydrodynamic velocity is proportional to the hydrodynamic radius or apparent size of the solute, and is adjustable with changes in the rate of chromatographic flow. The hydrodynamic velocity, as noted above, may vary throughout the separation chamber as a result of a non-uniformity of the separation chamber. As such, the hydrodynamic velocity is also dependent upon the shape and size of the separation chamber. In the opposite direction, an electrophoretic velocity is induced with the application of a voltage to the separation chamber, e.g., application of a voltage to a fluid stream containing solutes. The electrophoretic velocity is proportional to the molecular charge of the solute, which may change with changes in solvent pH or solvent composition. The hydrodynamic radius of an analyte is independent of the charge, and thus is independent of the electrophoretic velocity of the analyte. The provision of a gradient in the electric field and in the flow rate advantageously provides two independent means of achieving separation or focusing of analytes, such as charged analytes, for example, thus increasing the likelihood of being able to separate spatially multiple analytes in a sample fluid at different locations in the separation chamber. Yet again without wishing to be bound by any particular scientific theory, the focal point for a particular solute is the point in the separation path where the opposing velocities are equal in magnitude, which yields a net zero velocity. The focal point is one of a dynamic equilibrium for the solute, whereby any movement from that point results in a non-zero velocity and a restoring force. In establishing a desired electric field gradient, the person of ordinary skill in the art, given the benefit of this disclosure, will recognize that there are a number of factors potentially influencing the strength and shape or profile of the gradient. The gradient-establishing parameters include the shape of the electrode chamber, the voltage settings for the electrode array if an array is employed in the electrophoretic device in question, the configuration of the electrode chamber, if an electrode chamber is employed, etc. Thus, for example, if a configured separation chamber is used, such that a hydrodynamic force gradient is established in the sample fluid flow through the separation chamber, that gradient will influence the focusing point for an analyte and should be taken into account when establishing an electric field gradient, e.g., by selecting a suitable configuration for the electrode chamber (if any), electric field gradient profile, etc. For example, while a hyperbolic electrode chamber would in certain embodiments, in conjunction with a uniform or non-configured separation chamber, lead to a linear field gradient, the electrode chamber could be differently configured to achieve a linear field gradient, or in certain instances multiple linear field segments, in the presence of a non-uniform separation chamber. Determination of suitable chamber configurations and electrode array actuation will be readily apparent and/or readily determined empirically by the person of ordinary of skill in the art, given the benefit of the present disclosure.

As disclosed above, in certain examples, the electrophoretic device can function as a bridge or hyphenation between sample treatment devices, e.g., between first and second testing devices, between sample synthesis and sample testing devices, etc. The electrophoretic device can receive a target analyte in a sample fluid flow from the first treatment device and focus and retain or hold a target analyte until ready for release to the second sample treatment device. When the collected and held-in-place solute or analyte is to be released, the electrical field can be decreased or eliminated or the flow rate increased. An exemplary illustration of electric field gradient focusing is illustrated in FIG. 2A, where a constant bulk fluid flow is counteracted by a linear gradient in the electric field strength. A bulk buffer flow pushes solute to the right, while being counteracted by an electrophoretic force in the opposite direction. The magnitude of the electrophoretic force varies along the axis of the separation chamber. FIGS. 3A-3E further illustrate this concept in the context of processing proteins as target analytes. Fluid flow is in the direction of the arrows in FIGS. 3E and 3F. Negatively charged proteins are seen to focus in an increasing field gradient with the electric field in the same direction as the convective flow of buffer (FIGS. 3A, 3C, and 3E). Positively charged proteins are seen to focus in a decreasing field gradient with the electric field in a direction opposite to the convective flow (FIGS. 3B, 3D, and 3F). Without wishing to be bound by any particular scientific theory, the amount of charge carried on protein molecules is dependent on the pH of the buffer and generally is different from protein to protein and depends, at least in part, on the amino acid composition of the protein. The migration rate is directly proportional to the amount of charge carried. Therefore, distinct stationary accumulation zones for differently charged species can be established in the separation chamber. In order to focus the charged protein in the separation chamber, the direction of electric field, the slope of field gradient and the pH of the elution buffer must be matched, i.e., must have a net zero equilibrium point at some location along the flow path through the separation chamber. Otherwise, the target protein could be flushed out of the chamber, concentrated at one end, or not enter into the chamber at all, each of which provides poor or inconvenient focusing of the protein.

In accordance with certain preferred embodiments, an exemplary illustration of a solvent gradient or bulk fluid gradient is illustrated in FIG. 2B, where a constant electric field is counteracted by a linear bulk fluid flow gradient. As can be seen in FIG. 2B, in areas closest to where the bulk fluid flow gradient is highest, the bulk fluid tends to carry the solutes downstream due to the larger hydrodynamic force as compared to the electromotive force from the electric field. In areas where the bulk fluid flow gradient is smallest, the electromotive force tends to predominate and force the solute in the opposite direction. It will be within the ability of the person of ordinary skill in the art, given the benefit of this disclosure, to select suitable bulk fluid flow gradients for use in combination with a constant electric field strength or for use with electric field strength gradients.

In accordance with other certain preferred embodiments, electrophoretic devices employed in the systems and methods disclosed here comprise a layered assembly. The separation chamber and the electrode chamber can be separated by a porous membrane. As discussed above, the separation chamber is a conduit that may have a shaped geometry, where sample peaks or fractions are loaded, held and off-loaded or eluted. The electrode chamber may have a shaped geometry and has at least one built-in electrode pair, i.e., at least one anode and one cathode, and preferably has three or more electrodes. Application of a DC voltage to the electrodes results in an electric field, with an intensity inversely proportional to the combined separation chamber and electrode chamber cross-section at a given point. The electric field strength will vary along the axis of flow. To generate a linear electric field gradient, the combined chambers typically will have a hyperbolic shape, but nonlinear fields are possible by selecting the appropriate combined chamber geometry. As discussed above, the magnitude or slope of the field gradient may be manipulated by adjusting the voltage applied to the electrodes. The porous membrane is selectively conductive for the passage of small ionic species and electrical current, thereby communicating the electric field to the separation chamber. The pore size of the membrane is selected such that all molecules designated as samples or analytes will be retained in the separation chamber. A buffer system typically is required for the device to maintain stable pH and provide sufficient conductivity to carry the electrical current throughout the fluidic passages of the electrode chamber and separation chamber. FIG. 4 is an exploded view of an exemplary device comprising a uniform separation chamber and a non-uniform electrode chamber and an electrode pair. FIG. 4 illustrates a representative orientation of device components. The arrow heads indicate the direction of buffer flow. The electric field gradient causes solute to migrate in the opposite direction to buffer flow. Of course, it will be apparent to the person of ordinary skill in the art, given the benefit of this disclosure, that an electrode array, if employed, can be used to generate an electric field gradient directly, even where the electrode chamber and separation chamber are both uniform.

As discussed above, the separation and electrode chambers each may have a hyperbolic shape such that a linear electric field gradient is generated. Nonlinear fields are possible by selecting appropriate electrode and/or separation chamber geometry. The magnitude or slope of the field gradient may be manipulated by adjusting the voltage applied to the electrodes. The porous membrane between the chambers is conductive for the passage of small ionic species and electrical current, thereby producing a field gradient in the separation chamber. The pore size of the membrane is such that molecules of the target analyte in a fluid sample will be retained in the separation or sample chamber. A buffer system typically is used in the electrophoretic devices to maintain stable pH and provide sufficient conductivity to carry the electrical current throughout the fluidic passages of the electrode and separation chambers.

In certain exemplary embodiments of the processing systems disclosed here, one or more electrophoretic devices are used to hyphenate a high performance liquid chromatograph (HPLC) to a nuclear magnetic resonance (NMR) micro-flow probe to create a high throughput two-dimensional analysis system for characterizing a variety of molecules, e.g., proteins, peptides, nucleic acids, lipids, carbohydrates, steroids, metabolites, and many other molecules. In the case of HPLC-NMR, the two platforms typically do not operate on the same time-scale or at the same flow rate. In the case of time-scale, HPLC is continuous and does not easily afford the opportunity to perform stop-flow operations as required by NMR. In terms of flow rate, conventional HPLC operates at flow rates up to milliliters per minute, or greater, compared to micro-flow NMR probes, which typically operate in the microliter per minute range, resulting in a flow rate disparity. With the hold-in-place capability of the electrophoretic devices disclosed here, the flow rate mis-match is accommodated, allowing seamless coupling of the two techniques. In using an electrophoretic device to bridge a capillary electrophoresis (CE) unit to NMR, or rather any capillary-scale unit operation that resides as the front-end to a detector, the technical drawback of low sample loading may be addressed. The electrophoretic devices provided here allow on-line collection of peaks from multiple trials without the use of an intermediate, off-line peak storage device. Thus, sufficient sample mass and/or concentrations can be accumulated for efficient detection using NMR. The coupling of HPLC, CE, and NMR only serve as examples to demonstrate the application of the electrophoretic devices disclosed here, but use with other chemical techniques, such as mass spectroscopy (MS), electron paramagnetic resonance (EPR), circular dichroism (CD), etc. is also reasonable.

In accordance with certain preferred embodiments, electrophoretic devices are provided that are operative to perform electric field gradient focusing (EFGF), employing a counter-balance of chromatographic flow against electromigration to create high resolution, free-solution separation and focusing functionality for a broad range of analytes in buffer systems, including simple buffer systems. Such devices comprise a separation chamber as a focusing chamber and a nom-uniform electrode chamber separated from the separation chamber by a porous or conductive membrane, e.g., a suitably functionalized dialysis membrane, perfluorinated polymers, polysulfones, cellulose esters, porous glass, or other ion exchange or filtration membrane, which in certain preferred embodiments is substantially planar, most preferably planar and flat (i.e., mono-planar rather than curvo-planar) in configuration. Electrodes are positioned in an electrode chamber to establish an electric field gradient in the separation chamber. The membrane is effective to pass electrical current and electrolyte ions (e.g., tris-phosphate buffer ions), but not the analyte, i.e., not the target molecule of interest being focused or concentrated in the separation chamber. However, in certain examples, the membrane is selected such that analytes below a certain molecular weight, e.g., below 5000 Daltons, for example, may be passed by the membrane and are removed from the chamber through the buffer flow. As disclosed and described above, the electrophoretic device may use a porous, conductive layer to separate the electrode chamber from the focusing chamber. The porous layer may be a dialysis membrane, ceramic membrane or other porous material that allows conduction of ions and electrical current. The molecular weight cut-off (MWCO) for the porous layer may range from 100-30,000 MW. Typically, small molecule applications may require a porous layer having a 100-200 MWCO and proteins applications may require a porous layer having a MWCO>1000. Certain preferred embodiments of the electrophoretic devices disclosed here are operative to capture and concentrate a sample, as well as route (i.e., release) the sample from the chamber, and have applicability to processes in biotechnology, pharmaceutical or other scientific research and development areas as well as industrial production and testing applications. Certain preferred embodiments of the electrophoretic devices disclosed here provide a dynamic platform for pre-concentration and routing of target solutes for subsequent analysis, and can serve as a sample preparation tool or an analytical instrument or as a connection tool between instruments, i.e., between first and second sample treatment devices, e.g., even where there exists a dissimilarity in system parameters, such as differences in the operative fluidic requirements of the instruments. As discussed further herein, it will be within the ability of those skilled in this technology area, given the benefit of this disclosure, to employ suitable separation chamber and electrode chamber geometry and configuration, sample flow rate, sample loading, as well as field strength in the separation chamber to achieve good separation resolution in a short processing or “focusing” time.

In certain preferred embodiments the porous, conductive membrane is substantially planar. In such embodiments employing a substantially planar membrane, the electrode chamber can be non-uniform axially, that is to say, the cross-section of the separation chamber varies along the axial length of the flow channel through the chamber, such that in combination with other features, e.g., controlled actuation of an electrode array, separation chamber configuration, etc. an effective gradient is established in the electric field in the separation chamber. The electrode chamber or channel in certain preferred embodiments has a substantially uniform depth (depth here meaning the direction normal to the plane of the membrane) and a non-uniform or non-constant width (width here meaning the direction perpendicular to the overall direction of flow and parallel to the plane of the membrane). In other preferred embodiments, the electrode chamber has a substantially uniform width and a non-uniform depth. In yet other preferred embodiments, the width and the depth are both non-linear, and may include side walls and a bottom wall that are each nonlinear in the same fashion or to differing degrees, multiple facets that are each non-linear to the same or different degrees, or may form a cone-like shape wherein the walls are curved in a direction normal to the axial direction and non-linear in the axial direction. Combinations of these are also possible. As discussed further below, it will be within the ability of those skilled in this technology area, given the benefit of this disclosure, to employ suitable separation channel geometry, sample flow rate, sample loading, as well as field strength in the electrode chamber to achieve good separation resolution in a short processing or “focusing” time.

In other preferred embodiments, the porous, conductive membrane need not be planar. The electrode chamber in these embodiments can be, for example, non-uniform in width and substantially uniform in depth. The side walls in certain preferred embodiments may be linear and nonparallel in shape. Other suitable configurations for the electrode chamber will be readily apparent to those of ordinary skill in the art, given the benefit of the present disclosure.

In accordance with certain preferred embodiments, the separation chamber is typically a uniform cross-section flow channel or chamber, but may in certain preferred embodiments be non-uniform and can comprise any of the configurations described above for the electrode chambers.

In accordance with certain preferred embodiments, an electrophoretic device comprises a separation chamber separated from a non-uniform electrode chamber by a membrane. In at least certain examples, the electrode chamber comprises a plurality of electrodes or an electrode array. The separation chamber may be located alongside or adjacent the electrode chamber or may be partially or completely located within the electrode chamber, as, for example, a separation chamber enclosed partially or completely by the membrane and located within the electrode chamber. For example, the electrode chamber may be substantially conical, with a cylindrical separation chamber located co-axially and entirely within the electrode chamber and separated from the electrode chamber by a tubular membrane, such as, for example, dialysis membrane tubing. The plurality of electrodes or electrode array, typically positioned proximate or within the electrode chamber, is operative to generate an electric field gradient in the electrode chamber which is then further affected by the non-uniformity of the electrode chamber. The electrode chamber and the separation chamber may be any of the configurations described herein and other suitable configuration selected by the person of ordinary skill in the art, given the benefit of this disclosure.

In accordance with other preferred embodiments, electrophoretic devices are provided that comprise a non-uniform cross-section separation chamber as a focusing chamber and an electrode chamber separated from the separation chamber by a porous or conductive membrane as described above, with electrodes operative to establish an electric field in the separation chamber. The non-uniformity of the separation chamber establishes, in combination with other features influencing the field gradient profile, a gradient in the electric field along the direction of flow through the separation chamber. The membrane is effective to pass electrical current and electrolyte ions (e.g.; tris-phosphate buffer ions), but not the analyte, i.e., not the target molecule of interest being focused or concentrated in the separation chamber. Certain preferred embodiments of the electrophoretic devices disclosed here are operative to capture and concentrate a sample, as well as route (i.e., release) the sample from the separation chamber, and have applicability to processes in biotechnology, pharmaceutical or other scientific research and development areas as well as industrial production and testing applications. Certain preferred embodiments of the electrophoretic devices disclosed here provide a dynamic platform for preconcentration and routing of target solutes for subsequent analysis, and can serve as a sample preparation tool. Certain preferred embodiments of the electrophoretic devices disclosed here are substantially planar in configuration, the conductive, porous membrane being substantially flat with the sample flow channel above and the electrode chamber below. It should be understood that in certain embodiments the dimensions and other aspects of the electrophoretic device will be such that gravitational orientation will not be significant to its performance. Thus, directional references throughout this disclosure should be understood to relate primarily to the particular embodiments and drawings being discussed and not necessarily essential to other embodiments.

In accordance with certain other examples, in embodiments employing a configured separation chamber, the separation chamber is elongate and the non-uniform axially, that is, the cross-section of the separation chamber varies along the longitudinal axis of the channel, such that a gradient is established in the flow profile through the chamber and, unless changed by other features of the device, in the electric field established in the separation chamber. The separation chamber or channel in certain preferred embodiments has a substantially uniform height (height here meaning the direction normal to the plane of the membrane) and a non-uniform or non-constant width (width here meaning the direction perpendicular to the overall direction of flow and parallel to the plane of the membrane). In other preferred embodiments, the separation channel has a substantially uniform width and a non-uniform height. In yet other preferred embodiments, the width and the height are both non-linear, and may include side walls and a top wall that are each nonlinear in the same fashion or to differing degrees, multiple facets that are each non-linear to the same or different degrees, or may form a cone-like shape wherein the walls are curved in a direction normal to the axial direction and non-linear in the axial direction. Combinations of these are also possible. As discussed further below, it will be within the ability of those skilled in this technology area, given the benefit of this disclosure, to employ suitable separation channel geometry, sample flow rate, sample loading, as well as field strength in the electrode chamber to achieve good separation resolution in a short processing or “focusing” time.

Where the separation chamber is elongate in the direction of flow, it generally will have a main inlet port and a main outlet port located at the end-most locations along the flow path. As discussed above, however, in certain examples it may be necessary to position the main outlet port out of the defocusing region of the chamber which typically experiences an electric field gradient with decreasing slope. In certain preferred embodiments, the separation chamber further comprises one or more sampling ports located midway along the flow path through the separation chamber, typically between the main inlet port and the main outlet port. Focused analytes can be eluted from the electrophoretic focusing device through one or more sampling ports. Thus, for example, a desired analyte can be focused at its equilibrium position along the flow path and then moved (if necessary) by varying the electric field profile, flow rate etc, to a position at a sampling port. Upon opening the sampling port, the focused analyte can be eluted through the sampling port. Analytes can be eluted from the separation chamber by electric field, pressure, vacuum, or other motive force.

As discussed above, the electrodes in certain preferred embodiments are separated from the separation chamber by a membrane. Suitable membranes allow an electric field to be generated in the separation chamber through the membrane material while desired analytes, for example, macromolecules such as biomacromolecules, are retained in the separation chamber, that is, are not able to directly contact the electrodes. In certain preferred embodiments, the membrane is conductive to heat but not to bulk fluid flow. The membrane advantageously serves to isolate the electrodes from the separation chamber and optionally to avoid disruption of the laminar flow by gas generation or denaturation of charged analyte by contact with the electrodes. Suitable conductive materials include perfluorinated polymers, polysulfones, cellulose esters, porous glass, dialysis membrane, etc. In embodiments wherein the separation and electrode chambers are separated by such membrane, the membrane is typically a permeable or semi-permeable material. As used herein, a permeable material is one that allows electrical communication through the permeable material while (1) desired analytes, for example macromolecules such as biomacromolecules, are retained in the separation chamber; (2) undesired contaminants can be dialyzed out of the separation chamber; and (3) desired molecules, for example buffer ions, etc., can be dialyzed into the separation chamber. In certain preferred embodiments, the permeable material is conductive to heat and buffer ions but not to bulk fluid flow. The permeable material advantageously serves to isolate the electrodes from the separation chamber to avoid disruption of the laminar flow by gas generation or denaturation of charged analyte by contact with the electrodes. Suitable permeable materials include permeable membranes such as dialysis membranes, ion-exchange membranes, filtration membranes, and the like. Other suitable permeable materials will be readily apparent to those of ordinary skill in the art, given the benefit of the present disclosure.

In accordance with certain preferred embodiments, in typical operation of the systems and methods disclosed here, the electrophoretic device receives a flow of a first or sample fluid, typically a liquid, into its separation chamber, and, if the device has an electrode chamber, receives a flow of a second or electrode fluid, also typically a liquid, into such electrode chamber. Generally, the first liquid is an electrophoretic eluant (e.g., buffer solution) containing a target analyte and the second liquid is a coolant, e.g., the same or a different buffer without the target analyte. Suitable liquids include simple liquids such as buffered water, and complex fluids, for example mixtures of water and solvent, etc. The first liquid can be the same as or different from the second liquid. During focusing and separation, and depending on the requirements of the particular separation, the composition of either the first and/or the second liquid can be changed to achieve the desired result. As noted above, liquid flow through the separation chamber preferably opposes the direction of electrophoretic migration of the analyte and can be driven by any one of a variety of forces including electric field, pressure, vacuum, or other motive force. In a preferred embodiment, the direction of liquid flow through the separation chamber is opposite that through the electrode chamber.

In operation of an exemplary electrophoretic device, a first or sample fluid is caused to flow through the separation chamber. Where an electrode chamber is employed, a second or electrode fluid is typically flowed through the electrode chamber. The first and second liquids may be, but need not be, the same. The fluids generally are liquids, and may comprise water or advantageously may comprise buffer. Generally, a higher concentration of buffer stabilizes the protein sample and therefore avoids precipitation. However, in general, high ionic strength means high conductivity of the buffer, which increases the heat generation and power consumption and sets a limit for the highest suitable field strength. Typical field strengths include, for example, 180 to 300 V/cm. Advantageously, the same buffer is used for the first liquid and second liquid, excluding the dissolved gel where a soluble gel is used to ensure the ion balance between the two sides. Advantageously, the device is oriented vertically, that is, so that the flow of fluid through the chambers is substantially vertical, with the buffer in the electrode chamber flowing upward, effectively removing the tiny gas bubbles generated at the electrodes and acting as coolant to remove the Joule heat generated. In certain preferred embodiments, this second liquid is then run through a cooling apparatus, such as a cooling bath, heat exchanger, and the like, to remove the heat from the second liquid and the second liquid is then recycled back into the electrode chamber.

In accordance with certain preferred embodiments, a fluid composition gradient can be used to provide increased separation between different bands of analytes. As used here, fluid composition gradient refers to variation in the composition of the fluid flowing through the separation chamber during the separation of the analytes. For example, in a separation using two solvents, A and B, the separation may begin with 100% solvent A. As the separation progresses, the amount of solvent B can be increased, e.g., linearly, step-wise, logarithmically, etc., such that the solvent composition introduced into the chamber includes both A and B. Typically, the amount of each solvent in the fluid composition gradient is controlled by varying the amount of solvent introduced into the chamber. The solvents typically are introduced into the chamber through one or more pumps or other suitable devices. In certain embodiments, it may be necessary to provide a mixing chamber so that the solvents can be mixed prior to introduction of the solvents into the devices described here. In certain embodiments, the solvent gradients are computer controlled to provide high precision for the separations. One skilled in the art, given the benefit of this disclosure, will be able to select suitable solvent gradients for use in the devices and methods disclosed here.

In certain preferred embodiments, a hydrodynamic force is applied to the first fluid by pumping the first fluid through the separation chamber. The first fluid typically is a liquid, and typical flow rates include, e.g., from 0.1 to 10 μL/min for analytical applications, and, e.g., from 10 to 200 μL/min. for preparative applications. The flow rate is selected to provide the desired separation, in other words so that the hydrodynamic force, when combined with the effect of the molecular sieve in embodiments comprising such, counters the electric field gradient at a position between the weakest and the strongest part of the electric field. In this fashion, the analyte will be retained within the separation chamber. Factors that affect the choice of flow rate include, for example, the viscosity and density of the fluid, strength of the electric field gradient, net charge of the analyte, etc. Suitable flow rates will be readily selected by the person of ordinary skill in the art, given the benefit of this disclosure and suitable flow rates can also be readily determined by routine trial and error.

In accordance with certain preferred embodiments, solvents that are used in the devices and methods disclosed here may be degassed prior to separation of analytes. Without wishing to be bound by any particular scientific theory, it is believed that certain dissolved gases in the solvents can affect the reproducibility of the flow rates of the solvents. Thus, to achieve constant and reproducible flow rates, it may be necessary to remove at least some of the dissolved gases from any solvents prior to introduction of the solvents into the devices described here. The person of ordinary skill in the art, given the benefit of this disclosure, will be able to select suitable techniques for degassing the solvents including, but not limited to, vacuum filtration of the solvents, e.g., filtration through a fritted funnel, bubbling of inert gases, such as, for example, argon and nitrogen, through the solvents, and the like.

In accordance with certain preferred embodiments, lipids may be introduced either in the solvent or in the loaded sample. Without wishing to be bound by any particular scientific theory, lipids typically are either hydrophobic, having only nonpolar groups, or can be amphipathic, having both polar and nonpolar groups. In embodiments where one or more analytes are uncharged, it may be necessary to introduce an amphipathic lipid into the sample. Again without wishing to be bound by any particular scientific theory, the nonpolar group of the lipid can associate with one or more uncharged analytes, e.g., through hydrophobic interactions, hydrogen bonding, dipolar interactions, and the like, while the polar group of the lipid typically remains free to provide an overall charge to the lipid-analyte complex. In certain embodiments, lipids are selected from phosphatidic acid, phospholipids and glycerophospholipids such as, for example, phosphatidylcholine, phosphatidylethanolamine, phosphatidylserine, cardiolipin, phosphatidylglycerol, phosphatidylinositol, and the like. In other embodiments, the lipids may include ether glycerophospholipids, cerebrosides, sphingolipids, and the like. One skilled in the art, given the benefit of this disclosure, will be able to select these and other suitable lipids for use in the devices and methods disclosed here.

In accordance with certain embodiments, the lipids can form micelles that may associate with one or more analytes. Without wishing to be bound by any particular scientific theory, because many lipids, e.g., amphipathic lipids, include a nonpolar group and a polar group, when the lipids are placed into an aqueous environment, the lipids typically spontaneously associate with each such that the polar groups are positioned outward towards aqueous solvent and the nonpolar groups are positioned inward away from aqueous solvent. Typically, it is necessary to provide the lipids in a sufficient amount, e.g., a critical micelle concentration (CMC), such that micelles can spontaneously form. That is, when the lipids are present at concentration below the CMC, the predominant form is individual free lipids. When the lipids are present at a concentration greater than or equal to the CMC, the predominant form is micelles. Suitable CMC concentrations will be readily selected by those skilled in the art, given the benefit of this disclosure, and the CMC concentration typically depends on the type of lipid selected.

In accordance with certain preferred embodiments, the lipids may form vesicles, e.g., unilamellar (large unilamellar vesicles (LUVs), small unilamellar vesicles (SUVs)) or multilamellar vesicles. Such vesicles are typically characterized as including one or more bilayers formed when the nonpolar groups of the lipids associate with each other. Suitable methods for preparing vesicles will be readily selected by those skilled in the art, given the benefit of this disclosure, and include but are not limited to extrusion, sonication/extrusion, and the like.

In accordance with other preferred embodiments, in the presence of lipids, micelles and/or vesicles, the analytes can partition between the bulk solvent and the lipids, micelles and/or vesicles. For example, one or more portions of the analyte molecule can interact with a portion of the lipid to form an analyte-lipid complex. Typically an equilibrium is established between free analyte and analyte complexed with lipid. It may be possible to favor this equilibrium depending on the nature of the analyte and the nature of the lipid selected. For example, it is possible to favor the lipid-analyte complex by adding lipid in amounts far in excess of the analyte concentration to shift the equilibrium to form additional analyte-lipid complex. When the predominant form in solution is analyte-lipid complex, the position at which the analyte is focused typically will differ from the position at which free analyte will focus. In certain embodiments, lipid-analyte complex will focus at a position substantially less than free analyte, i.e., under similar separation conditions free analyte typically can migrate further than analyte-lipid complex. One skilled in the art given the benefit of this disclosure will be able to select suitable lipids and suitable amounts of the lipids to favor, or disfavor, lipid-analyte complexes.

In accordance with certain preferred embodiments, lipids, micelles and/or vesicles can be added to a sample to separate analytes of similar molecular weights and/or similar overall charges. Without wishing to be bound by any particular scientific theory, in many instances analytes having similar molecular weights and/or similar overall charges will be difficult to separate from each other and typically will appear as a single band. To facilitate separation of such analytes, lipids, micelles and/or vesicles can be used. Because there is likely to be some physical differences between the analytes, e.g., differences in hydrophobicity, composition, three-dimensional structure, surface area properties, and the like, the analytes can interact differently with the lipids, micelles and/or vesicles. For example, if one of the analytes includes a large number of hydrophobic groups, such as amino acids leucine, alanine, valine, etc., then these hydrophobic groups can interact more frequently with hydrophobic lipids to reduce entropically disfavored interactions with polar bulk solvent. Accordingly, the use of lipids, micelles and/or vesicles can provide for the ability to baseline separate two or more analytes that behave similarly in the devices provided here.

In accordance with other preferred embodiments, the lipids, micelles and/or vesicles can be used to focus an analyte in a different position than in the absence of any lipids, vesicles or micelles. This result may be desirable for low molecular weight analytes or highly charged analytes, for example, which are difficult to focus at or near a sampling port. For example, without wishing to be bound by any particular scientific theory, it may be difficult to prevent certain analytes from migrating out of the device due to small size, high charge, etc. In the presence of lipids, micelles and/or vesicles, the analyte-lipid complex can increase the effective size of the analyte, which can reduce its rate of migration in the devices disclosed here. After removal of the analyte-lipid complex, e.g., through an exit port or a sampling port, the analyte-lipid complex can be dissociated and the analyte can be isolated using methods routinely used by the person of ordinary skill in the art, e.g., centrifugation, dialysis, etc. It will be within the ability of the person of ordinary skill in the art, given the benefit of this disclosure, to select and use suitable lipids, micelles and vesicles, and suitable amounts of these compounds, to control migration of one or more analytes in the devices disclosed here.

In accordance with yet other preferred embodiments, the lipids, micelles and/or vesicles can be used to separate two or more analytes having very similar migration behavior, e.g. two or more analytes that focus at the same position within the chamber. This result may be desirable for samples comprising two or more analytes that are similarly charged, for example, and difficult to separate from each other. For example, without wishing to be bound by any particular scientific theory, it may be difficult to separate analytes having similar charges even if those analytes have different physical or physicochemical properties, e.g., different hydrophobicities, secondary or tertiary structures, etc. In the presence of lipids, micelles and/or vesicles, the analyte-lipid complex can increase the effective size of the analyte, which, in certain embodiments, can reduce its rate of migration in the devices disclosed here. Because different analytes may interact differently with the lipids, due to the differences in the physical properties of the analytes, for example, it may be possible to favor the lipid-analyte complex for one analyte and favor free analyte for another analyte so that the two analytes may be separated from each other. After removal of the analyte-lipid complex, e.g., through an exit port or a sampling port, the analyte-lipid complex can be dissociated and the analyte can be isolated using methods routinely used by the person of ordinary skill in the art, e.g., centrifugation, dialysis, etc. It will be within the ability of the person of ordinary skill in the art, given the benefit of this disclosure, to select and use suitable lipids, micelles and vesicles, and suitable amounts of these compounds, to control migration of one or more analytes in the devices disclosed here.

In accordance with certain preferred embodiments, FIG. 5 illustrates an exemplary electrophoretic device. Device 100 includes electrode chamber 150 having a varying cross-sectional area defined by electrode chamber walls 144. Positioned within the electrode chamber is a permeable conduit membrane 160, which defines separation chamber 153. The separation chamber 153 is encircled longitudinally by the electrode chamber 150. As illustrated in FIG. 5, permeable membrane 160 is uniform cross-sectionally such that the fluid velocity within the separation chamber is uniform. In certain preferred embodiments the membrane 160, and thereby the separation chamber 153, is tubular, preferably cylindrically tubular. In other preferred embodiments, the separation chamber can be non-tubular, i.e., can be some other geometry, and can be non-uniform cross-sectionally. Membrane 160 is in certain preferred embodiments a dialysis membrane. Sample fluid flows into the separation chamber 153 through inlet port 154, and exits the chamber through outlet port 156. Valves 160 and 162 are provided in-line with inflow and outflow ports 154 and 156, respectively. These valves are operably connected via control signals A and B to a controller, which can be manually controlled or can be computer-controlled as desired. The valves can thus be opened or closed, either fully or partially, to govern the flow rate and volume of fluid introduced into the chamber. An additional port 158 is located intermediate the inlet and outlet ports of the separation chamber and permits the removal or addition of fluid to or from the separation chamber. For example, a focused band of charged analyte could be brought under the additional port and the analyte band could be extracted through the port, for example, by any of the means identified herein. Of course, more than one such additional port could be incorporated. Device 100 further includes electrodes 198, which in certain preferred embodiments are annular, located at proximate ends of the electrode chamber 150, preferably adjacent electrode chamber walls 144 and thus remote from the membrane 160. The converging walls 144 of the electrode chamber 150 cause the current density of electrical current flowing between electrodes 198 to concentrate toward the converging upper end to create a gradient in the electric field within the separation chamber.

As noted above, in certain preferred embodiments, the electrode chamber includes an electrode array. The electric field generated by the electrode array can be DC, AC, or otherwise modulated in time including asymmetric (out of phase) field modulation. The specific nature of the electrode (i.e., size and shape) is not critical. Suitable electrodes include pin-shaped and staple-shaped electrodes, among others. In one preferred embodiment, the electrode array includes a linear array of electrodes (e.g., 50 electrodes arranged linearly) along an axis parallel to the direction of analyte migration. In addition to arrays having electrodes arranged in line with even spacings from one to the next, suitable arrays also include arrays in which the electrodes are not in line and which are not separated by even spacings. Other configurations of electrodes, including two-dimensional electrode arrays, are also within the scope of the devices and methods. Two-dimensional arrays include arrays having rows and columns of electrodes. The electrode chamber in certain preferred embodiments includes more than one electrode array, for example two electrode arrays on opposite sides of the electrode chamber. Suitable electrode array configurations will be readily apparent to those of ordinary skill in the art, given the benefit of the present disclosure, for example electrode array configurations presented in U.S. Pat. No. 6,277,258, hereby incorporated herein in its entirety for all purposes.

A focusing chamber comprising an electrode array is shown schematically in FIG. 6. Referring to FIG. 6, focusing chamber 200 includes separation chamber 212 and electrode chamber 214 separated by permeable member 216. The separation chamber 212 and electrode chamber 214 shown in FIG. 6 are each uniform axially; in practice, either chamber could of course be non-uniform axially. Separation chamber 212 includes elution buffer inlet 218 and outlet 220. In operation, in one embodiment, elution buffer flows downward from inlet 218 through chamber 212 exiting outlet 220, and coolant buffer flows through electrode chamber 214, preferably upwardly. Electrode chamber 214 includes an array of electrodes 222. As shown in FIG. 6, the electrode array can be positioned on the electrode chamber surface 224 opposing separation chamber 212 and permeable member 216. The device can further include one or more ports 230 for eluting analytes from the separation chamber. Alternatively, as shown in FIG. 7, the electrode chamber 314, which again is shown for clarity purposes to be uniform axially, includes a pair of electrode arrays 322. Referring to FIG. 7, in this embodiment, the electrode array includes an electrode array positioned on electrode chamber surfaces 326 and 328 adjacent separation chamber 312 and permeable member 316. Device 310 can further include one or more ports 330 for eluting analytes from the separation chamber.

In certain preferred embodiments, each electrode of the array is individually controlled to provide an electric field gradient that can be dynamically controlled (i.e., maintained and adjusted during the course of analyte focusing and/or separation). Techniques involving such dynamic control of the electric field gradient are referred to herein as “Dynamic Field Gradient Focusing” or “DFGF.” Control can be manual from the device controller, manually from the device's associated computer, or automatically from the computer once the computer has received feedback from a monitor, such as an optical monitor, for example a video signal, or other suitable monitoring device, following analyte focusing. The controller can sense the electrode's voltage and reset its voltage to its initial setting. Such monitoring allows for computer detection of various peaks or fractions, optimization of the separation by locally adjusting the field gradient to tease separated peaks or fractions apart, and then pull off those peaks or fraction that were selected by the operator either before or during a separation. Suitable configurations of the electrodes, controls, computer equipment and the like will be readily apparent to those of ordinary skill in the art, given the benefit of the present disclosure, for example configurations presented in U.S. Pat. No. 6,277,258, which as noted above is incorporated herein in its entirety for all purposes. The inclusion of an electrode array is particularly advantageous in that the strength and shape of the electric field gradient can be altered during the run, for example, to elute focused bands of analyte off one by one, thus permitting each band to be subject to individual treatment following separation in the device. In accordance with certain preferred embodiments of the device and methods, the electronically generated field can take on arbitrary shapes including exponential profiles, steps, and even locally reversed gradients, for example, to elute proteins. The field shape can be monitored and maintained by computer and modified “on-the-fly” on a point-by-point basis, both spatially and temporally. During a run the operator can optimize the local properties of the field to sharpen an individual band, move a band to an off-take port or set up a moving gradient to elute one or more bands from the separation chamber. With online monitoring, for example optical such as UV/Visible monitoring, or potentiometric monitoring, in place, the operator could be replaced by a computer programmed to detect focused peaks and automatically adjust the field shape to optimize the separation and, when necessary, offload products. Suitable monitoring systems and configurations will be readily apparent to those of ordinary skill in the art, given the benefit of the present disclosure.

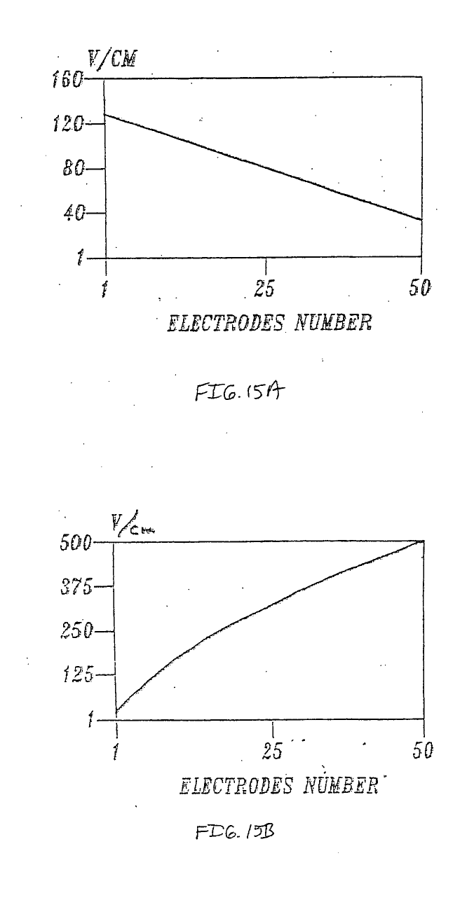

In accordance with certain preferred embodiments, a representative electrophoretic device including a focusing chamber as described above is shown in FIGS. 8-11. FIG. 8A shows an exploded view of the device including front and rear portions. An elevation view of the device is shown in FIG. 9, and forward and rear plan views of the device as illustrated in FIGS. 10A and 10B, respectively. A cross-sectional view of a portion of a representative device illustrating the separation chamber, permeable membrane, and electrode chamber is shown in FIG. 11. The embodiment illustrated in FIGS. 8A-8E includes side-by-side electrode arrays as shown in FIG. 7. Referring to FIGS. 8A-8E, device 400 has basic components including first block 410 and second block 420 separated by intermediate sheets 430 and 440. Permeable member 616 is intermediate block 410 and sheet 440. Blocks 410 and 420 and intermediate sheets 430 and 440 are formed from machinable materials. Preferably, blocks 410 and 420 and intermediate sheet 430 are formed from PLEXIGLAS and sheet 440 is formed from TEFLON. In one embodiment, each component includes a plurality of apertures 512 that are coincident with the apertures of the other components when the components are assembled. Apertures 512 receive bolts 514 (see FIG. 9) for securing the assembled components and assist in sealing the assembly. As shown in FIG. 9, the components are secured through tightening nuts 516 on bolts 514.

To form the focusing chamber, first block 410 and second block 420 include troughs 412 and 422, respectively (see FIGS. 8A, 8B and 8E). Trough 422 includes the electrode arrays, each array comprising a plurality of electrodes 522. Sheets 430 and 440 include apertures 432 and 442, respectively. When the components are assembled, troughs 412 and 422 and apertures 432 and 442 are coincident and form a portion of the focusing chamber 610. Intermediate sheet 440 and block 410 is permeable member 616 which divides chamber 610 into separation chamber 612 and electrode chamber 614.

First block 410 includes conduits 414 and 416 which terminate in opposing ends of trough 412. Conduits 414 and 416 serve as inlet and outlet, respectively, for introducing a first liquid to and for removing the first liquid from the separation chamber. First block 410 further includes channels 418 which terminate in trough 412, which provide for eluting focused analytes from the device through off-take ports (such as off-take ports 230 and 330 in FIGS. 6 and 7, respectively). Channels 419 also terminate in trough 412 and provide for introducing charged analyte and eluant to the separation chamber through inlet 618 and exiting eluant through outlet 620.

Second block 420 (see FIG. 8E) includes conduits 515 and 517, which terminate in opposing ends of trough 422. These conduits serve to introduce and exit liquid flow (e.g., coolant) through the electrode chamber. For embodiments of the device that include an electrode pair in addition to the electrode array, second block 420 further includes channels 518 which terminate in trough 422. Channels 518 receive electrodes 520 and 523 (see FIG. 9), which like the electrode array, are in electrical communication with liquid in the electrode chamber when the device is in operation.

A representative device as described above is shown in FIGS. 9-11. Referring now to FIG. 9, device 400 includes blocks 410 and 420 and sheets 430 and 440, and permeable member 616. Conduits 414, 416, 515, and 517, noted above, are illustrated along with connecting devices 424, 426, 524, and 526, respectively, which serve to connect the focusing chamber with its respective supplies. Inlet connection device 718 and outlet connecting device 720 are illustrated and communicate with channels 419 and separation chamber inlet 618 and outlet 620, respectively. Connector 524 leads to the device's controller and provides current to the electrode array. The representative device further includes first and second plates 470 and 480, respectively, which overlie the outward surfaces of blocks 410 and 420, respectively. Plates 470 and 480 can reinforce the assembly. Plates 470 and 480 are preferably steel plates but other suitable materials will be selected by those skilled in the art, given the benefit of this disclosure.

Referring now to FIGS. 11A and 11B, which are cross-sectional views of a portion of the representative device described above, taken through line 6A-6A in FIG. 9 and through line 6B-6B in FIG. 10. device 400 includes blocks 410 and 420 and sheets 430 and 440. Intermediate block 410 and sheet 440 is permeable material 616 which divides the focusing chamber into separation chamber 612 and electrode chamber 614. Sheet 440 serves as a spacer for adjusting the depth of electrode chamber 614 and, accordingly, the thickness of sheet 440 can be varied as desired. Sheet 440 is a resilient sheet and also serves to seal block 410 to the remaining components of the assembly. Intermediate sheet 440 and sheet 430 is sealant layer 450. Sealant layer 450 includes a sealant that effectively joins sheet 440 to sheet 430 and prevents liquid from escaping the electrode chamber. Intermediate block 420 and sheet 430 is adhesive layer 460. Adhesive layer 460 includes an adhesive that effectively joins sheet 430 to block 420.

Although the above examples illustrate the use of linear electric field gradients, the software can be modified to allow point-by-point adjustment of the field including reversing the field to aid in elution of fractionated bands, isolating and mobilizing a single protein band, or stepping the gradient to improve processing capacity. In addition, because the electronic controller and the technique are largely independent of chamber capacity, there is no reason it cannot be applied at larger or smaller scales.

The dynamic electric field gradient focusing provided by the methods and devices optionally relies in part on field gradient control, which includes hardware and software. Representative gradient control hardware and software are discussed below.

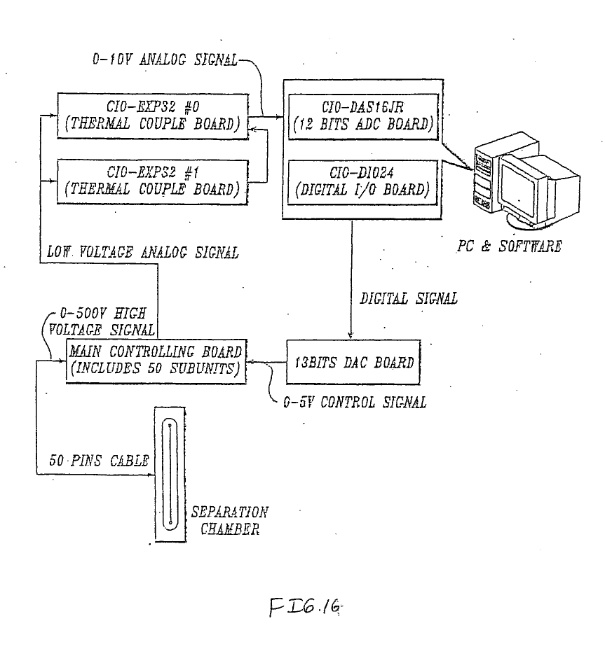

The control circuits are designed to manipulate the field gradient by adjusting the effective electrical resistance between each two adjacent electrodes (see FIG. 12). In one embodiment, each pair of electrodes is connected to one of the 50 controller units. A schematic of such an embodiment is shown in FIG. 13, in which the blocks with dash line frames are controller units and each of the controller units handles the data acquisition and the resistance control of two adjacent electrodes.

Without wishing to be bound by any particular scientific theory, the electrical resistance between two adjacent electrodes Rᵢ is determined by the sum of the resistance of three parallel resistors, Rcᵢ, Rpᵢ, and Rxᵢ. Note that the buffer between electrodes is considered as a resistor Rcᵢ.

$${R}_{i} = \frac{{Rc}_{i} \cdot {Rp}_{i} \cdot {Rx}_{i}}{{Rc}_{i} \cdot {Rp}_{i} + {Rc}_{i} \cdot {Rx}_{i} + {Rp}_{i} \cdot {Rx}_{i}} \qquad ( 1 )$$

The resistors Rpᵢ are used for protective purpose and have 1 MΩ resistance. Because Rₚ>>Rcᵢ, Rₚ>>Rx₁. Equation (1) can be simplified as

$${R}_{i} = \frac{{Rc}_{i} \cdot {Rx}_{i}}{{Rc}_{i} + {Rx}_{i}} \qquad ( 2 )$$

By changing each Rxᵢ, the circuits adjust each Rᵢ indirectly. By Ohms Law, the potential drop between two electrodes is determined by the resistance between them if the total current going through is constant. The potential drop between the two adjacent electrodes is given by

$${V}_{i} = {V}_{total} \cdot \frac{{R}_{i}}{{\sum }_{i}^{50} {R}_{i}} \qquad ( 3 )$$

Since the field strength is proportional to the potential drop with the electrodes equally spaced, we can manipulate the field strength point by point by adjusting each Rxᵢ, independently.

$${E}_{i} = \frac{{V}_{i}}{d} = \frac{{V}_{total}}{d} \cdot \frac{{R}_{i}}{{\sum }_{i}^{50} {R}_{i}} \qquad ( 4 )$$

where d is the distance between the two adjacent electrodes. An electric field gradient in any shape, linear or nonlinear, continuous or stepwise, can be produced with a limitation to the conductivity of the buffer. Note that the resistance between two parallel-connected resistors is always less than any one of them, in other words, Rᵢ<Rcᵢ must be satisfied.

There is more than one group of Rᵢ that satisfies Equation 4, in other words, different groups of Rxᵢ can be used to establish the same field gradient with the total current going through the chamber arbitrarily. There is no unique equilibrium state. To solve the problem, a small modification to unit No. 25 is made by disabling its control function and replacing Rp₂₅ with a 5 kΩ resistor. The total current going through the chamber was fixed, and given by

$$I = \frac{{V}_{25} \cdot {Rp}_{25} \cdot {Rc}_{25}}{( {Rp}_{25} + {Rc}_{25} )} \qquad ( 5 )$$

V₂₅ has a unique value for a specific field gradient, and can be calculated from the total potential drop across the chamber. Rcᵢ is determined by the conductivity of the buffer. Therefore, there is a unique value of Rxᵢ that satisfies Equation 4.

In certain preferred embodiments, dynamic electric field gradients are created by a computer-controlled external circuit, which manipulates the field strength between each pair of adjacent electrodes, as exemplified in FIG. 14. Varying field strength along the separation chamber can thus be achieved. FIGS. 15A and 15B are graphical representations of linear electric field gradients so generated.

In accordance with certain preferred embodiments, representative gradient control circuits are shown schematically in FIG. 16. The blocks represent electronic boards, the lines represent standard ribbon cables. The PC monitor/controller board and the 13 bit DAC board were built in our laboratory. Some modifications have been made for better performance. The data channels between the two CIO-EXP32 boards and the CIO-DAS16Jr boards are programmed rather than being physically connected. CIO-DAS16Jr and CIO-DIO24 are plugged into extension slots of the PC. The two thermocouple boards CIO-EXP32, the 16-channel ADC board CIO-DAS16/Jr and the 24-channel Digital I/O board CIO-DIO24 were purchased from ComputerBoards, Inc. Standard SCSI ribbon cables are used to connect all the boards. There are 50 controller units plugged into the motherboard. Each unit corresponds to one pair of electrodes. The whole system was grounded to protect the circuits from unexpected shock.

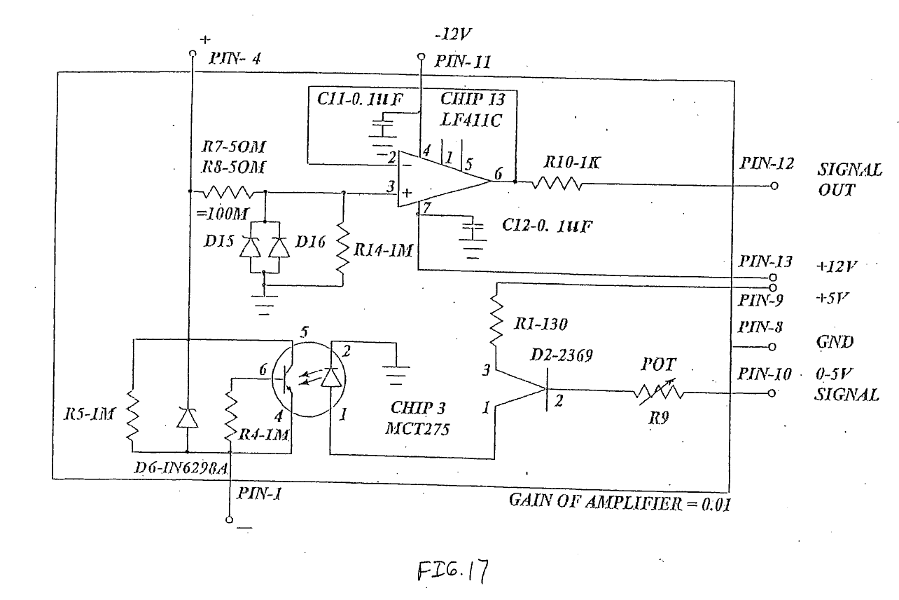

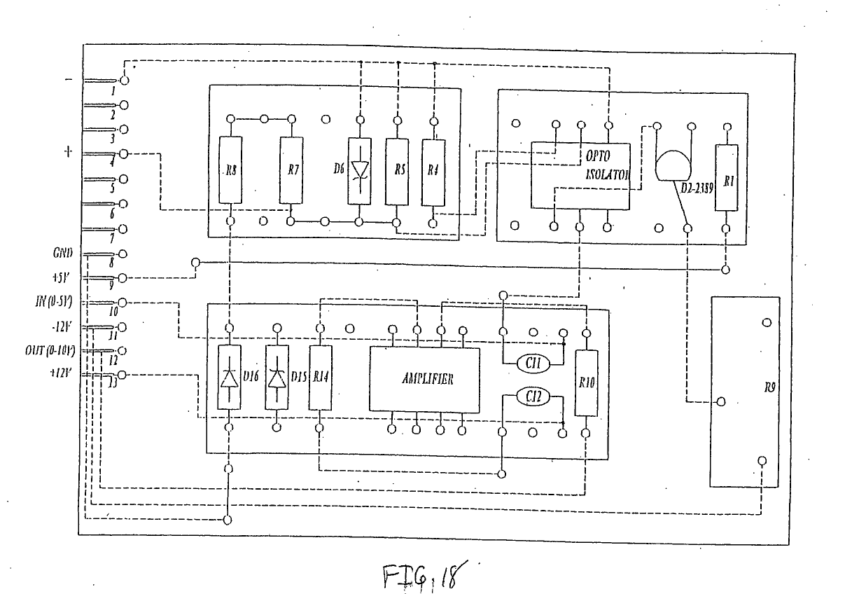

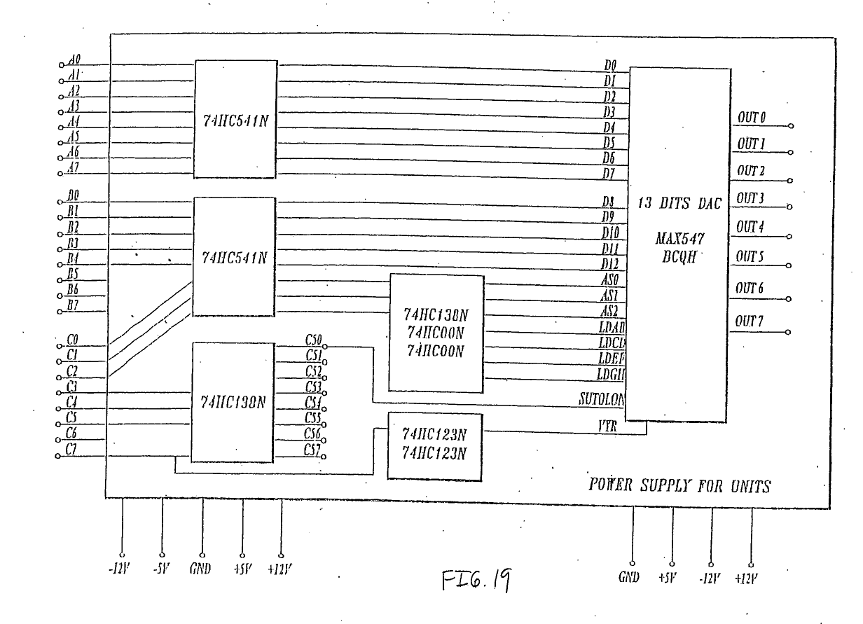

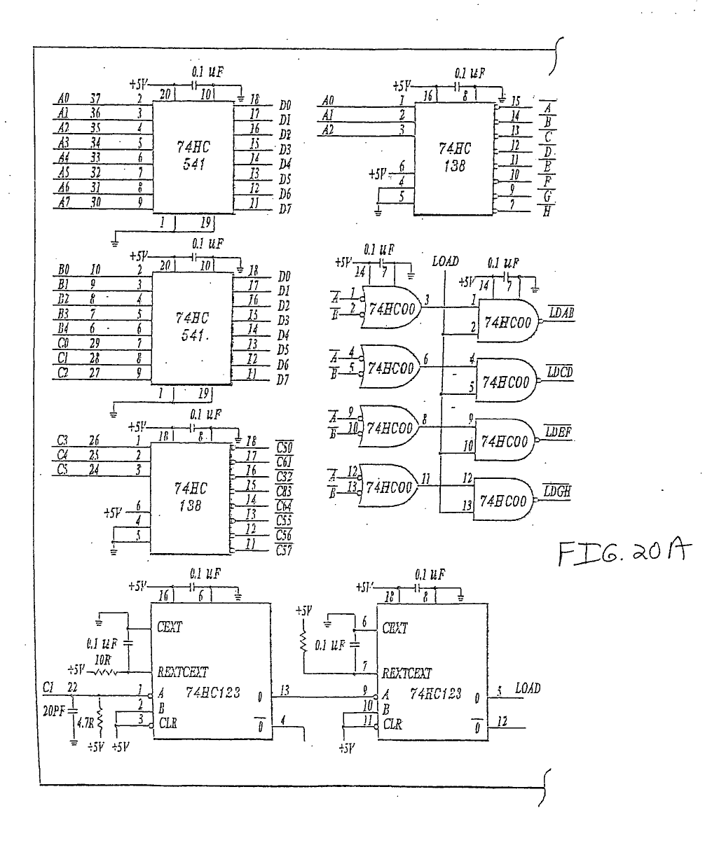

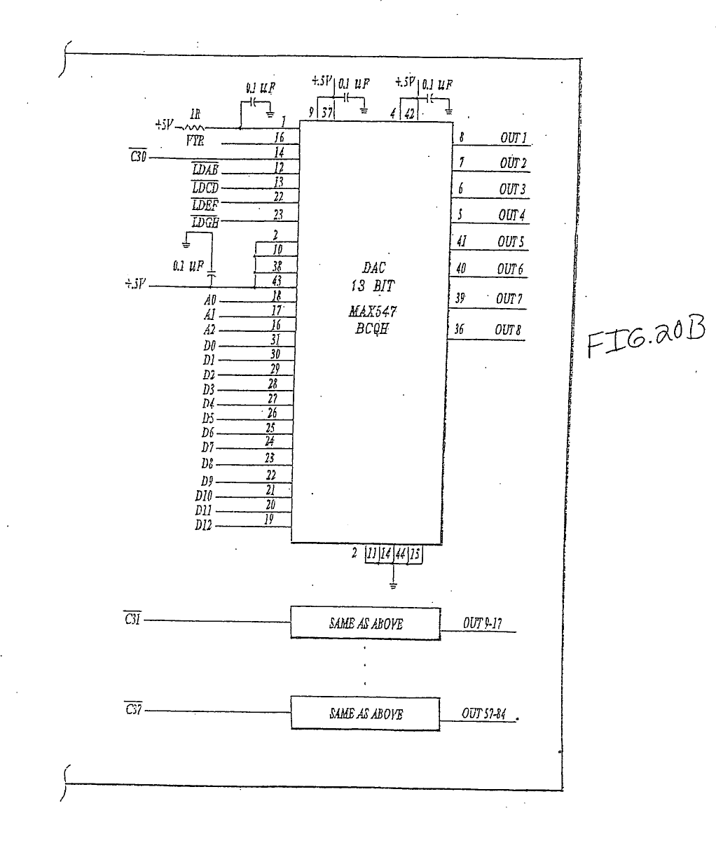

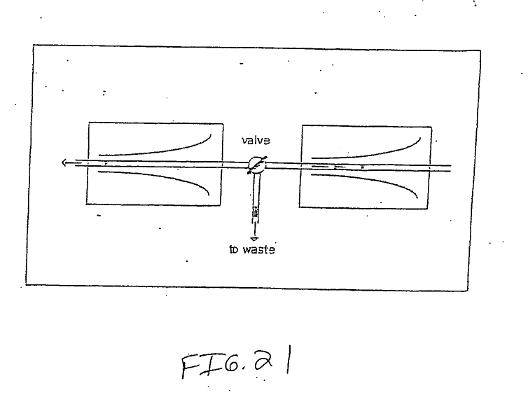

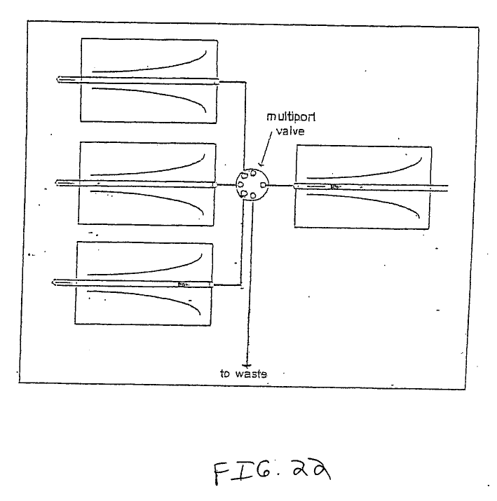

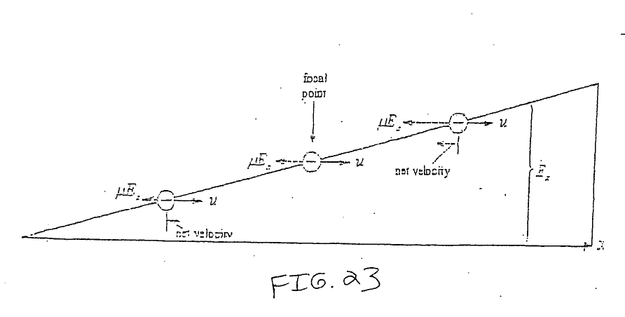

In accordance with certain preferred embodiments, the gradient control is accomplished with PC-controlled circuits, diagrammed in FIG. 17, which are composed of electronic circuit boards. Pin 1 and 4 are connected to electrodes and neighboring units. The electrical potential on the electrode is reduced by 1/100, then enters amplifier LF411C where the load of the signal is increased. The signal is then sent to EXP32 board through pin 12, and the control signal (pin 10, 0-5 V) from the DAC board adjusts the current going through the optical isolator MCT275. A circuit diagram of the controller unit is shown in FIG. 18. A logic diagram for circuit diagram for ADC board is shown in FIG. 19. A circuit diagram for the ADC board with components identified is shown in FIGS. 20A and 20B. The circuits scan all 50 electrodes and scale the signals down by 1/100. Then the signals were sent to ADC board where 0-10V analog signals are digitized. The computer compares these readings with the programmed gradient, then sends its commands in digital signals to DAC board via the Digital I/O boards. In the DAC board, the command signals are converted to 0-5V analog signals, then sent to the 50 units on the PC monitor/controller board. Those units adjust the current going through the units, or we can say change the values of resistance Rxᵢ. Note that the Rxᵢ do not exist physically, and they are the resistance to current going through the chip MCT275, an optically isolated controller. The scan/response cycle for the circuits is set at about 0.5 sec, and could be adjusted by the program.

In accordance with certain preferred embodiments, a 600V DC power supply (Xantrex) supplies power to the electrode chamber. The power to all the boards is supplied by the computer. As noted above, the electrode chamber can include more than one electrode array. For example, two electrode arrays can be associated with a single separation chamber in a configuration in which the separation chamber is positioned in between the two arrays. Similarly, the second (electrode) chamber can include, for example, four arrays positioned about a separation chamber in a quadrupole-type configuration. Other preferred embodiments can include more than one second chamber, each having one or more electrode arrays. It will be within the ability of the person of ordinary skill in the art to design electrode chambers having suitable numbers of arrays for an intended use of the electrophoretic devices disclosed here.

In accordance with certain preferred embodiments, the separation chamber in any of the embodiments disclosed herein can either be an open channel or can be packed with a media, such as a gel or granular packing, to reduce the convective dispersion and help maintain sharp peaks. In certain preferred embodiments, the separation chamber contains a fluid medium. Suitable fluid media include simple fluids such as, for example, buffered water. Also included are complex fluids, for example, a water/acetonitrile/methanol mixture, or polymer solutions such as, for example, linear polyacrylamide, polyvinyl alcohol, methyl cellulose solutions and the like. The fluid media in certain preferred embodiments further comprises a chromatography support medium or packing. Suitable packings can be of any size or type provided that the solute being focused does not irreversibly bind to the packing. Suitable packings include porous and nonporous, pellicular and tentacle, glass, plastic, ceramic, and any nonconductor or semiconductor. Other suitable packings include ion-exchange, affinity, reverse phase size exclusion, gel filtration and hydrophobic interaction supports.

In certain preferred embodiments, a pair of electrodes or optionally an array of electrodes is utilized to generate the electric field, with a gradient arising by means of the configuration of the separation chamber, optionally in conjunction with a configured electrode chamber and/or electrode array, as described above. In such embodiments, the configuration of the separation chamber and/or the electrode chamber is itself subject to dynamic control, either by the user or by computer control. Such embodiments employ, for example, movable or pivotable walls such that the shape and size of the chamber can be altered during the course of a focusing run to provide dynamic control over the strength and/or shape of the electric field gradient. For example, reconfigurable materials, such as piezoelectric materials, can alter their characteristic length when energized. Where the separation chamber configuration is dynamic, the gradient in the hydrodynamic force is advantageously subject to dynamic control, providing still more flexibility to the separation methods available. Suitable configurations employing dynamically-controlled chamber configurations will be readily apparent to one skilled in the art, given the benefit of the present disclosure.

In accordance with certain preferred embodiments, a given set of focusing process parameters, as noted above, includes all parameters, both dynamic and non-dynamic, that affect the location of a focused band of charged analyte in the separation chamber, other than the influence of the molecular sieve. With the influence of the molecular sieve, the focusing location is different than it would be in the absence of the molecular sieve. All such parameters are encompassed by the term “focusing process parameters” unless otherwise noted or otherwise clear from context. Such factors include, for example, dynamic factors, or factors that are capable of being changed, such as the particular characteristics such as the shape and strength of the electric field gradient; the composition, concentration and pH of the first fluid; the flow rate of the first fluid; the composition, concentration and pH of the second fluid; the flow rate of the second fluid; and other such dynamic factors. The parameters that make up the focusing process parameters further include nondynamic factors such as the dimensions of the separation chamber and the electrode chamber; and other such nondynamic factors.

In accordance with certain preferred embodiments, in simultaneous focusing in a separation chamber of multiple charged analytes having the same or similar charge to mass ratios, the composition and amount of molecular sieve is chosen such that the location of the stationary focused band of each such analyte is shifted in the chamber to a different degree. It should be understood, however, that reference here to each of multiple analytes being shifted to a different degree does not exclude the possibility that in any given stationary focused band there may be more than one analyte, that is, there may be analyte mixtures for which the devices and methods disclosed here are operative to establish focuses bands of subsets of the analytes, each subset containing one or more of the analytes. Typically the analytes are separated on the basis of their molecular weights or masses. This is particularly useful for separating analytes that have the same or similar mobilities that would not adequately separate in a traditional DFGF device absent the sieve.

In accordance with certain preferred embodiments, molecular sieves can include any medium or substance, for example suitable organic or inorganic polymer or the like, by which such shifting of the focusing location is achieved. The molecular sieve is selected for its ability to shift the location of the stationary focused band of analyte for simultaneous focusing of multiple charged analytes. Preferably, a molecular sieve is chosen such that the amount to which the stationary focused bands of analyte are shifted for a given set of focusing conditions varies with the size or molecular weight of the analyte. Preferably the degree of shift varies proportionally with the molecular weight of the analyte, for example, such that each stationary focused band of charged analyte is focused at a stable location separate from the other charged analytes. Factors that affect the selection of a particular molecular sieve at a particular concentration include, for example, the size of the molecules to be separated and focused, the pH at which the system is operated, and other such relevant factors that will be apparent to those skilled in the art, given the benefit of this disclosure. In certain preferred embodiments, the molecular sieve comprises a gel, which may be either an organic gel or an inorganic gel or a combination of organic and inorganic gel. The gel may be a fixed gel. A fixed gel optionally may be polymerized within the first chamber, such that it does not substantially flow or move when fluid sample is flowed through the first chamber. Alternatively, the gel may be a soluble gel that is dissolved in the first liquid, such that the gel flows with the first liquid when the first liquid flows through the first chamber. In certain embodiments, the soluble gel is introduced into the chamber and resides there during focusing. As used herein, the term “soluble gel” refers to a gel that is soluble or dissolved in a liquid or fluid, and further refers to gels that form suspensions, emulsions, colloids, and the like. Typically, soluble gels comprise polymers having little or no crosslinking. In certain preferred embodiments, the gel will be comprised of molecules having a molecular weight of between about 2000 and about 100,000. Suitable gels include, for example, linear and cross-linked polyacrylamide, polyvinyl alcohol, methyl cellulose and other derivatized celluloses, and the like. Other suitable molecular sieves include microporous structures composed of either crystalline aluminosilicate, chemically similar to clays and feldspars and belonging to a class of materials known as zeolites, or crystalline aluminophosphates derived from mixtures containing an organic amine or quaternary ammonium salt, or crystalline silicoaluminophosphates which are made by hydrothermal crystallization from a reaction mixture comprising reactive sources of silica, alumina and phosphate, and the like. The person of ordinary skill in the art, given the benefit of this disclosure, will be able to select suitable gels and sieves through routine experimentation, utilizing known methods, for example by the methods described in Ackers et al., “Determination of Stoichiometry and equilibrium constants for reversibly associating systems by molecular sieve chromatography,” Proc. Nat. Acad. Sci. USA 53: 342-349 (1965), the entire disclosure of which is hereby incorporated by reference for all purposes. Other suitable sieves will be readily apparent to those of ordinary skill in the art, given the benefit of the present disclosure.

In accordance with certain preferred embodiments and as discussed above, molecular sieve enables simultaneous focusing of multiple charged analytes having the same or substantially similar charge to mass ratios. These can be focused from the same fluid sample in the separation chamber of any of the devices disclosed above. Each such molecule is concentrated at a location in the channel spatially separated from the locations at which others of the biomacromolecules are focused. Without wishing to be bound by any particular scientific theory, the molecular sieve in preferred embodiments can be said to apply a focus position-shifting force on the analyte along the direction of fluid sample flow, where the magnitude of such force for a particular molecular sieve material is generally proportional to the size or molecular weight of a target analyte being focused (or held) in the separation chamber and where the magnitude of such force is not (or not as) related to the charge-to-mass (or charge per unit of molecular weight) of the analyte. Charged analytes in a fluid sample can in this way be retained and focused in the separation chamber at locations spatially separated from each other sufficiently to permit each to be readily drawn off or removed from the chamber with little or none of the other focused analytes. Typically, the charged analytes are separated by the molecular sieve, in conjunction with the other focusing process parameters and conditions, and focused at positions along the length of an elongate separation chamber in the general order of their apparent molecular weights. It will be within the ability of those skilled in the art, given the benefit of this disclosure, in some cases with routine trial and error or similar selection aids, to select materials suitably operative as molecular sieves for the intended target analyte(s) under a given set of process parameters. Accordingly, in certain preferred embodiments of the methods and devices disclosed here, each of multiple analytes having the same or similar charge to mass ratios or electrophoretic mobilities and different molecular weights, can be simultaneously focused from a fluid sample at different, separate locations along the length of an elongate separation chamber. Each such analyte can be held indefinitely at its respective focusing location against the flow of the fluid sample. In accordance with certain preferred embodiments, spaced focusing positions of such target analytes can be moved in the chamber to different, stable, separate locations, by suitable control of one or more of the operative focusing forces, e.g., by adjusting the electric field gradient strength or configuration, or the hydrodynamic force of the sample fluid flow, such as by changing its flow rate, or by changing the characteristics of the molecular sieve.

Certain preferred embodiments of the devices and methods herein are suited for focusing and separating analytes, such as charged analytes. Analytes that can be focused include, e.g., charged polymers, carbohydrates, and biological analytes, such as proteins, peptides, oligonucleotides, polynucleotides, hormones, biomarkers, and the like, and mixtures of any of these. In particular, charged analytes that have similar charge to mass ratios, such as DNA, RNA, etc., can be separated and focused on the basis of differences in their respective molecular weights. Absent the presence of the molecular sieve of the current devices and methods, such analytes are difficult to fully separate due to the similar charge to mass ratios.

In accordance with certain preferred embodiments, materials with little or no net charge sorbed into charged carriers, for example micelles and liposomes, can also be focused and separated with the devices disclosed here. For example, proteins that exhibit little net charge can be sorbed into a charged carrier such that the protein acquires the charge of the charged carrier. In certain preferred embodiments, a detergent, for example sodium dodecyl sulfate (SDS), is used as the charged carrier. Without wishing to be bound to a theory, it is presently believed that the SDS binds strongly to protein molecules and “unfolds” them into semi-rigid rods whose lengths are proportional to the length of the polypeptide chain, and hence approximately proportional to molecular weight. Because of the magnitude of the charge of the bound detergent molecules, the protein complexed with such a detergent takes on a high net charge. Furthermore, the total charge is approximately proportional to molecular weight, as the detergent's charge vastly exceeds the protein's own intrinsic charge. Thus, the charge per unit length of a protein-SDS complex is essentially independent of molecular weight. This feature gives protein-SDS complexes essentially equal electrophoretic mobility in a non-restrictive medium. Separation and focusing is then brought about by the molecular sieve (acting in conjunction with the other focusing process parameters) on the basis of the molecular weights of the protein-SDS complexes.

In accordance with certain preferred embodiments, in addition to a coupling device, the electrophoretic devices disclosed here can be used as a sample preparation unit for HPLC or other separations techniques. Sample preconcentration and solvent exchange can be carried out in electrophoretic devices without additional liquid handling. The separation chamber can either be an open slit or be packed with a media, such as a gel or granular packing to reduce the convective dispersion and help maintain sharp peaks.

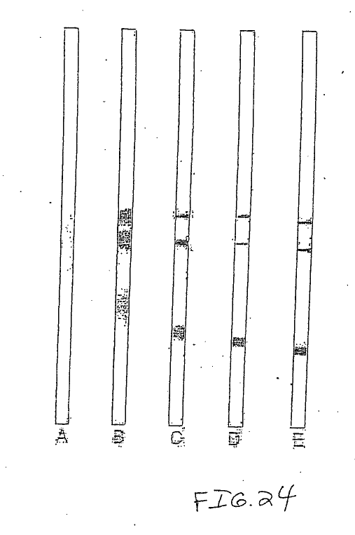

In accordance with certain preferred embodiments, a “notch filter” for sample peaks can be constructed from two serial connected electrophoretic devices and a switching valve. Sample peaks within certain mobility range can be selectively cut from a series of peaks, routed to a second SPUR unit and prepared or used for subsequent analysis. FIG. 21 depicts the configuration for an exemplary “notch filter” embodiment of the systems disclosed here. It can be seen that two devices are connected in a serial fashion. In the era of high through-put screening, the ability to multiplex and perform operations in parallel has taken center-stage. By adding a multi-port switching valve at a point intermediate to multiple electrophoretic devices, a sample multiplexer may be created. The sample multiplexer may provide the ability to operate on multiple peaks from a single source stream without loss of sample or interruption of analysis path. For example, with the emergence of multi-coil NMR probes, a sample multiplexer may allow a single source stream to access all detector coils in a seamless fashion. This application of the electrophoretic devices disclosed here also applies to multiplexing of MS. FIG. 22 illustrates the concept of a sample multiplexer 800 comprising first, second, third and fourth electrophoretic devices 810, 820, 830 and 840, respectively, and switching valve 850. The number of units per multiplexer is generally limited only by the port capacity of the switching valve 850.

As discussed above, the systems, devices and methods disclosed here use an innovative technology known as field gradient focusing (FGF) to provide an in-line, buffered interface between different analytical instruments. By using the electrophoretic devices disclosed here, analytical instruments from different manufacturers may be easily connected to perform a complicated analysis. For example, a sample fraction may be temporarily stored, conditioned, and concentrated before being routed to subsequent processes for detection or manipulation. The electrophoretic device provides a bridge between two hyphenated instruments that otherwise would be incompatible in terms of flow rate, time-scale, buffer composition, or sample concentration; making compatibility less of an issue. The electrophoretic devices disclosed here provide a simple design and costs substantially less than currently available hyphenation strategies and liquid handling workstations.

In accordance with one exemplary embodiment, a substantially planar electrophoretic device comprising a configured electrode chamber, suitable for use in a hyphenated analytical system, generally has the following attributes. The devices are capable of accepting applied voltages up to, or greater than, about 300 V, which corresponds to a maximum electric field of 200 V/cm, but in certain examples, the device can accept voltages up to, or above, about 900 V. The device can accept an electrode buffer flow rate of 0-100 mL/min, and the focusing chamber buffer counterflow flow rate is about 0-30 uL/min. The buffer conductivity of the buffer used in such devices is about 0-1 Siemens/cm. For example, the conductivity of 20 mM Tris-phosphate at pH 7.25 is approximately 1.025×10³ microSiemens/cm. The focusing chamber is about 1 mm wide by about 0.5 mm deep by about 2.54 cm long. The depth of the electrode chamber is about 3.2 mm, and the distance between the main pair of electrodes is about 2.54 cm. The width of the electrode chamber is about 1.6 mm at the most narrow point and about 1.6 cm at the widest point. The focusing chamber has an active region of from about 1 cm to about 12.7 cm for varying scales of the device, e.g., 2.54 cm for the other attributes listed here. The electrode chamber is defined by side walls (i.e., walls substantially perpendicular to the plane of the porous, conductive membrane) with a hyperbolic shape resulting in a linear electric field gradient (see FIGS. 2 and 4). The electrode chamber shape can be tailored to generate a specified electric field (e.g. non-linear) to perform a custom separation. The device preferably includes a single focusing chamber suitable for focusing either positively or negatively charged molecules.

The following are adaptations of the device configuration and the application identified: a single chamber with a switchable power supply to select focusing either positively or negatively charged molecules; two chambers configured in a serial fashion, with a three-way diverter valve positioned at an intermediate point, to allow “filtering” and isolation of target molecule(s). (See, e.g., FIG. 21); two chambers configured in a serial fashion to focus both positive and negative molecules simultaneously; a single chamber interfaced by a multi-position valve, to an array of chambers in parallel for multiplexing of multiple peaks (See, e.g., FIG. 22.); the electrophoretic devices can be constructed of any suitable material that is compatible with either aqueous or organic solvents, or both, depending on the intended application and environment of use and exemplary materials include PEEK, TEFLON, acrylic, etc. Thus, for example, the separation chamber can be etched or otherwise formed as a groove or channel in a substrate of such material. The membrane seated against the substrate completes the separation chamber, leaving the ends open (preferably valved) for flow. The device may be constructed of material that is optically clear over the UV-Vis-IR spectral range to permit imaging or detection of isolated molecules in the chamber. This may include UV transparent acrylic, quartz, TEFLON AF, etc.

In accordance with certain preferred embodiments, detection strategies for such electrophoretic devices may also include monitoring the entering and exiting streams for tracking of materials. These would be considered point detectors. If the device is constructed of optically clear material, as mentioned above, point detectors could be spatially distributed along the length of the chamber, as opposed to imaging the entire chamber. Point detectors may be distributed throughout the system for overall tracking of material (e.g., at the exit of a switching valve to monitor routing of peaks).

An exemplary system in accordance with the present disclosure may employ auxiliary equipment such as any or all of the following devices: a dynamic power controller unit to provide a supply of up to 300 V on 25 independently controlled channels, the user optionally having full control over voltage settings, with built in data acquisition for recording of voltage settings; capillary-scale UV-Vis flow cell to allow UV-Vis interrogation of streams for performing absorbance spectrophotometry across the spectral range 200-1100 nm; UV-Vis light source with fiber-optic coupling capability to provide illumination energy for absorbance spectrometry over the range 200-1100 nm; HTSL-1100 microfluidic sample loader to provide the ability to automatically inject microliter quantities of sample into a precision controlled flow stream with flow rates of 1-20 microliters/min; a GUI software control bench to interface the HTSL for flexible control of sample loader operations; a suitable computer, such as a Pentium IV 2.0 GHz computer, 512 MB Ram, 30 GB HD, CD-RW to provide computational power to execute and manage the HTSL and spectrometer software and data acquisition.

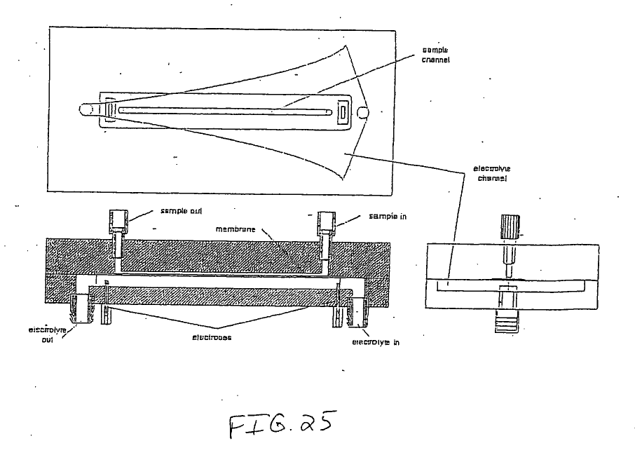

FIG. 23 is a further illustration of electric field gradient focusing. In FIG. 23, a charged solute is pushed from left to right by a chromatographic flow. The electric field will impose an electrophoretic migration velocity proportional to the mobility of the solute. At the point where the elution and migration velocities balance is considered the equilibrium focal point for a solute. As discussed above, EFGF enables focusing of target molecules at pH values distant from their isoelectric points (pI) and in simple buffer systems. Therefore, EFGF has a distinct advantage over isoelectric focusing (IEF), which has the following inherent limitations: many solutes have low solubilities at their isoelectric points, entire classes of solutes cannot be focused by this method either because they degrade at their isoelectric point (pI), e.g., nucleic acids, or they do not have a readily accessible pI, e.g., polystyrene latexes, and the use of ampholytes for generating the pH gradient can increase the cost per separation substantially. Compared to chromatographic techniques, the equilibrium focusing technologies allow a sample to be “held-in-place”, rather than flow-through elution, providing a method to collect peaks from multiple injections or trials without having to manually combine collected fractions. Furthermore, the chamber configurations for EFGF allow the separation conditions (e.g., field gradient, buffer composition, pH) to be altered in situ, providing a means to adjust separation resolution or evaluate behavior of target analytes in a changing environment. There is additional benefit of the device with use of an electric field gradient and optionally a hydrodynamic force gradient as a separation driving force, which promotes flexibility for target molecule elution from the chamber. The slope of the gradient can be decreased in a stepwise fashion to selectively release solutes “trapped” within a “mobility window” (i.e., the field strength of the lower gradient setting is insufficient to retain molecules having electrophoretic mobilities within the “step”). Since the holding force on the sample peaks is an electrophoretic migration, the electrophoretic devices will act on charged molecules or any neutral molecules labeled with charged groups or modified to possess an apparent charge. Given that the majority of DNA, proteins, and other small molecules (e.g., metabolites) are charged in an aqueous environment, the devices here will have application to separation or management of a very broad range of biological samples. In general, the field gradient focusing technologies have been described as providing separation strategies that are orthogonal to IEF and various chromatographic techniques, therefore the devices disclosed here may provide researchers with an attractive alternative to LC and PAGE for separation of complex mixtures, as well as providing a new methodology for instrument hyphenation.

In accordance with certain preferred embodiments, the features, attributes, and benefits that can be provided by an electrophoretic device include, but are not limited to: sample concentration or preconcentration into small microliter volumes; in-line buffer exchange; capability to capture peaks from multiple trials; alternative mode of action for separations; simple buffer systems; broad range of analytes and application for separations; operates as stand-alone or integrated component; and a small device footprint. Systems and devices disclosed here can be packaged as a stand-alone device or as a value added accessory to other separation devices to expand the repertoire of options for resolving complex mixtures. The inclusion of advanced detector markets (e.g., mass spectrometry and nuclear magnetic resonance) enhances the functionality of the electrophoretic devices disclosed here. Such devices have the ability to address mass sensitivity and sample size issues, as well as a providing an alternative front-end sample staging device, positions the device as an attractive alternative to currently available methods of instrument hyphenation. For example, certain systems employing the devices disclosed here include a sample separation device that may exist as a stand-alone unit or as an accessory to other analytical instruments (e.g., LC or CE), and a universal interface for hyphenating analytical separation (e.g., standard scale LC) instruments to advanced detectors (e.g., Mass Spec or NMR) to create integrated, seamless information rich platforms.

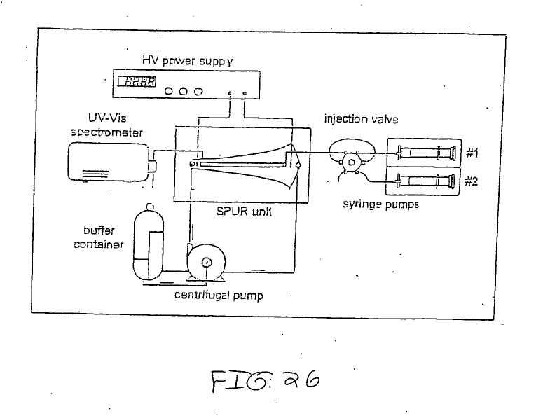

The inherent simplicity of preferred embodiments of the electrophoretic devices, e.g., as illustrated in FIG. 4, is advantageous in many applications. Referring again to FIG. 4, the conductive layer (e.g., a dialysis membrane) separates the focusing channel from the electrode chamber, which is tailored with a hyperbolic curvature to form a linear field gradient. The conductive layer should allow passage of buffer ions and electric current, but should have pore structure that restricts translocation of target molecules from the focusing channel. FIG. 24 presents a series of images extracted from a simulation of a focusing system where three proteins have been injected as a dilute, homogenous mixture. According to model results, a high mobility molecule (small or strongly charged) moves fast to its equilibrium point. Therefore, a focused band can be established in a relatively short amount of time. For a low mobility molecule (big and weakly charged), focusing to equilibrium occurs on a longer time scale. As an example, with field strengths ranging from 20-200 V/cm, at opposite ends of the chamber, a molecule with an electrophoretic mobility of 5×10⁻⁵ cm²/volt-sec can focus into a 2 mm band in about 12 minutes. While, a molecule with a mobility of 5×10⁻⁶ cm²/volt-sec will reach its focal point in approximately 2 hrs. Slower moving analytes create a challenge for equilibrium focusing techniques, but an increase in focusing speed may be achieved at higher flow rates and higher field strengths. Since it is relatively easy to increase the system flow rate, extension of the operational range for the devices primarily focuses on increasing the field strength. The limiting factor to operational conditions may be joule heating and subsequent heat dissipation. It is presently understood that a small-scale electrophoretic device will be capable of 200 V/cm in a 20 mM Tris-phosphate buffer. These field strengths are similar to those used in conventional capillary-scale instruments.

In accordance with certain preferred embodiments, FIG. 24 shows results of a simulation showing the focusing of a protein mixture. In lane A, a faint smear can be seen near the mid-point of the column as two high mobility proteins begin to focus. In lane B, three distinct bands, representing R-phycoerythrin (top band), phycocyanin (middle band), and myoglobin (bottom band), are observed at 2.5 min after applying the field gradient. In lanes C and D, the bands are becoming more concentrated at 5 and 7.5 min into the focusing trial. In lane E, elution of the bands is initiated resulting in a shift downward towards the focusing chamber exit.

In accordance with certain preferred embodiment, a general hyperbolic channel shape for the bottom layer of a typical electrophoretic device comprising a configured electrode chamber would generate field strengths ranging from 20 to 200 V/cm at the widest and most narrow points of the channel, respectively, at an applied voltage of 300 V between a single electrode pair. Although a linear field gradient may be preferred for general focusing application, the field shape is not constrained to linear, but may in certain instances be nonlinear field to address specific needs.

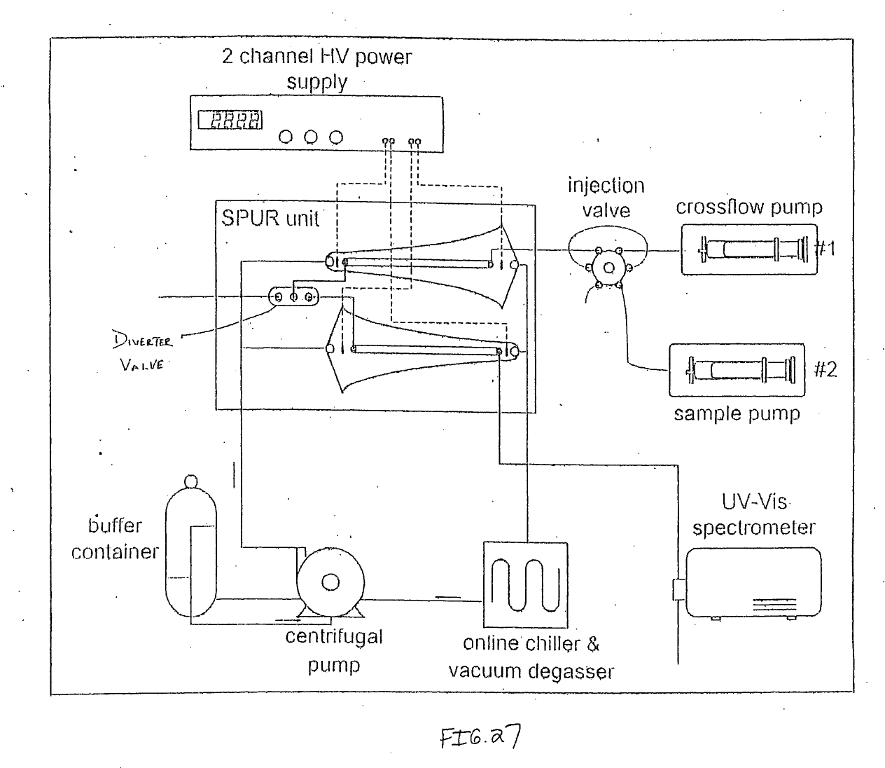

In accordance with certain preferred embodiments, an exemplary electrophoretic device suitable for use in the devices, systems and methods disclosed here is illustrated in FIG. 25. In this example, the cross section of the electrode chamber is significantly larger than the separation chamber, the field gradient is primarily determined by the shape of the electrode chamber. Electrolyte sweeps through the electrode chamber to remove electrolysis products and joule heat. The separation chamber may be packed with a chromatographic media to stabilize convective perturbations. The electrophoretic device, itself, is seen to be an assembly of three functional layers including the sample focusing channel (upper most layer), the “conductive” membrane, and the electrode chamber (lower most layer). The two chamber layers may be fabricated from common plastics (e.g., acrylic or PEEK with TEFLON AF or quartz components) to allow visualization of the separation processes, however chemical compatibility will be a consideration in material selection. The electrodes, housed in the lower layer, are single electrode elements consisting of either gold or platinum metal to prevent hydrolysis-induced breakdown. Trade-offs in the focusing systems have been observed in balancing the operational range and resolution against the ability to dissipate heat. The range of proposed electrophoretic mobilities accessible by the electrophoretic devices includes a wide range of the peptides that may be encountered when peptide mapping, thereby expanding the application base of the device, method and systems disclosed here.

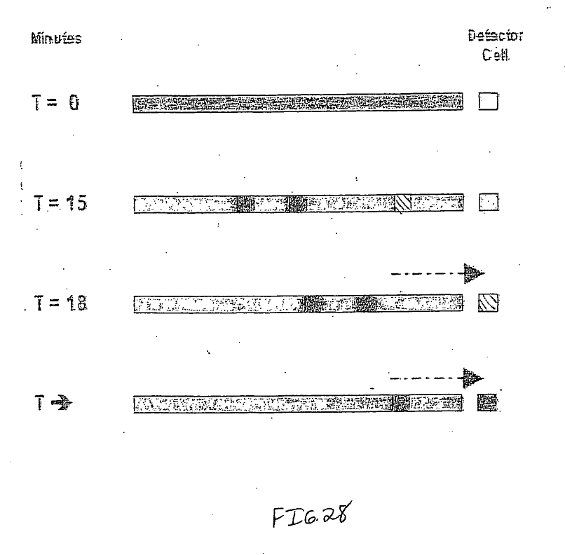

In accordance with certain preferred embodiments, FIGS. 26 and 27 are schematic illustrations showing exemplary testing apparatus, with FIG. 26 representing a single electrophoretic device and FIG. 27 representing an apparatus containing two electrophoretic devices. The devices can be controlled via RS-232, LAN, or contact closure interfaces and advantageously can be used with commercially available liquid handlers to allow unattended analyte preconcentration. Fluidic samples, for example, aqueous-phase samples, are injected into the first analytical or sample chamber with the trapping electric field turned on, and the sample is allowed to separate and focus into one or more bands of focused analyte. The electric field is then lowered to allow a low mobility band of analyte to exit or elute from the chamber. As exemplified in FIG. 26, the eluted band then passes to a suitable detector, here a UV-Vis spectrometer, for detection and quantification, and then exits to pass into any other desired sample treatment or detection apparatus. As exemplified in FIG. 27, eluted bands may be passed from the first electrophoretic chamber into a second electrophoretic chamber. In this fashion, bands can be located within either chamber by separately manipulating the strength of the electric field in each chamber. Such a design is advantageous in that it permits the removal of bands of intermediate mobility while allowing the apparatus to retain bands of higher and lower mobility in the electrophoretic chambers. For example, desired bands of low mobility can be eluted from the first chamber and permitted to flow into the second chamber while retaining the remaining bands on the first chamber. Subsequently, the undesired intermediate bands can be eluted from the first chamber and diverted, for example by means of a diverter valve, out of the device, for example into a separate detection and/or sample treatment apparatus or to a waste port. The remaining bands of high mobility can then be flowed into the second chamber and then to the detection/treatment systems as desired. Typical operating parameters of an apparatus of this type with a 1-inch chamber are shown in Table 1:

| | |
|---|---|
| Sample Amount | 10 micrograms total load |
| Focusing Time | 10 minutes |
| PH Range | 3-9, programmable |
| Temp. Range | 10-25° C. |
| Number of Electrodes | 2 |
| Eluent Flow rate | 1 μL/min. |
| Buffer Flow rate | 1 mL/min. |
| Maximum Voltage | 350 Volts |
| Maximum Current | 45 mA |
| Maximum Field Strength | 200 Volts/cm |

In each of FIGS. 26 and 27, syringe pump #2 represents a device for the introduction of sample to the apparatus. It will be understood that such a device may comprise means for the introduction of free-standing sample, for example a syringe or fixed-loop injector, or may instead comprise the output of an upstream instrument. Further, the UV-Vis spectrophotometer can be replaced by or be followed by any suitable downstream instrument or other sample detection, treatment, or collection device. In this fashion, the apparatus can be used to link up separate instruments in a hyphenated fashion, whereby the sample flows directly from one instrument into the apparatus and then into the next instrument. Additional injections may be used in certain preferred embodiments to accumulate or concentrate low abundance materials while holding previous samples in either the first or, where one is present, the second chamber. Alternatively, continuous flow of sample may be so used, or a combination of continuous flow and additional injections. Further, additional such electrophoretic devices may be used in serial or in parallel networks to provide additional separation flexibility for accumulating multiple analytes for collection or analysis. Additional peripherals may be added for any desired follow-on sample analysis, treatment, collection and the like. Other suitable apparatus designs will be readily apparent to those of skill in the art, given the benefit of this disclosure.

In accordance with certain preferred embodiments, the devices, systems and methods disclosed here have wide application to the capture, concentration and routing of target molecules, e.g., DNA molecules, a large segment of proteins, polypeptides, and small molecule targets. Such devices, systems and methods can serve as sample preparation tools for analytical instruments such as, for example, mass spectroscopy or NMR, or can be used as a connection tool between instruments, advantageously where there exists a dissimilarity in system parameters including, but not limited to, flow rate, time-scale, solute concentration, solute content or solvent composition. The electrophoretic devices disclosed here will expand the options available for management of samples at the “micro” scale, and provide a new, innovative technology. Additionally, the devices are scalable through the use of larger chambers to allow the preparation of more material as needed.

In accordance with certain preferred embodiments, either or both of the separation chamber and electrode chamber comprises cartridge-like inserts that are capable of being easily removed and replaced. The chamber inserts typically reside between an inlet and an outlet for flowing a fluid into and out of the insert chamber. The shape of the chamber is determined by the configuration of the insert. Such a configuration is particularly advantageous in that the configured chamber can be swapped out for chambers of different configurations, making a variety of electric field gradient shapes and strengths available in a single instrument. In other preferred embodiments, the electrode chamber comprises a cartridge-like insert that can be swapped out, for example, to permit changing between a non-configured separation chamber and a configured separation chamber. Typically, the electrode chamber insert will comprise the electrodes. In yet other preferred embodiments, the entire device is contained in an insert that is insertable into an instrument properly set up with appropriate fluidic, electric and other necessary connections. Suitable cartridge configurations will be readily apparent to those of skill in the art, given the benefit of the present disclosure.

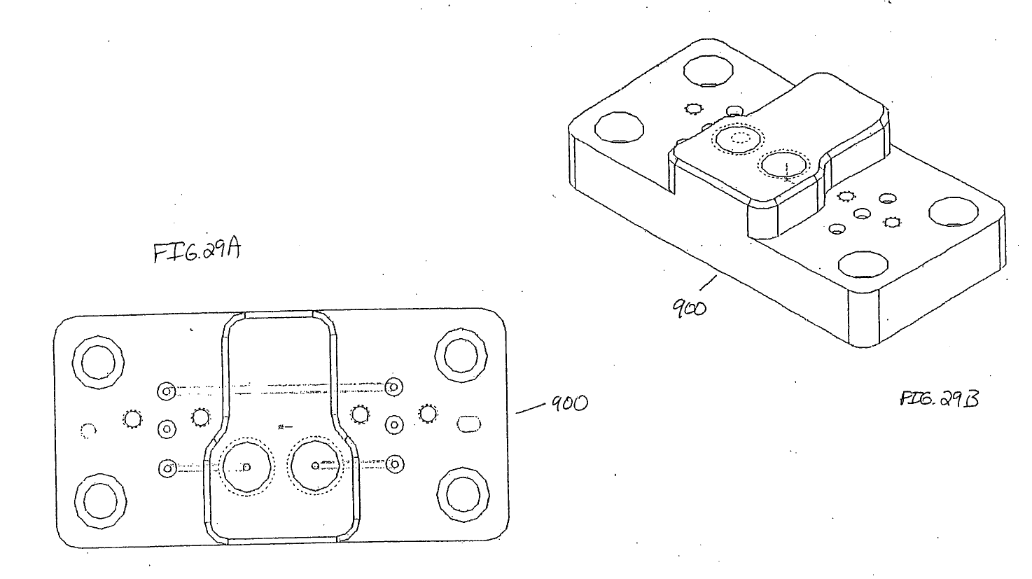

In accordance with certain preferred embodiments, FIG. 28 presents a series of images extracted from a simulation of a focusing system, in which three analytes have been injected as a dilute, homogenous mixture, that illustrate a usage of a device in accordance with the disclosure herein to separate, retain, concentrate, and elute analytes. At the outset, sample is loaded into the device and the electric field is applied. At 15 minutes, the sample has separated and focused into three separate analyte bands, each of which may contain more than one species of analyte. The electric field is then lowered, here at 18 minutes, reducing the electrophoretic force that counters the chromatographic force to an extent sufficient to elute the band of analyte that has the lowest mobility to any suitable downstream detector or other further sample treatment device, in the case of FIG. 27 into an optical flow cell for detection and quantification. Advantageously, the remaining bands of interest can be retained in the electrophoretic device by maintaining the electric field at the lower power level while the first band is analyzed. Each of the remaining peaks can then be eluted in the same fashion into the same downstream detector or other further sample treatment device, or can be diverted into any other appropriate downstream device. Further, if desired, following elution of the band of lowest mobility additional sample can be loaded into the electrophoretic device for concentrating the remaining species; the two retained species will concentrate while the eluted species will not be retained in the device. As such, the device can be used to purify as well as to concentrate the species of interest. Other suitable applications of the device will be readily apparent to those of skill in the art, given the benefit of the present disclosure.

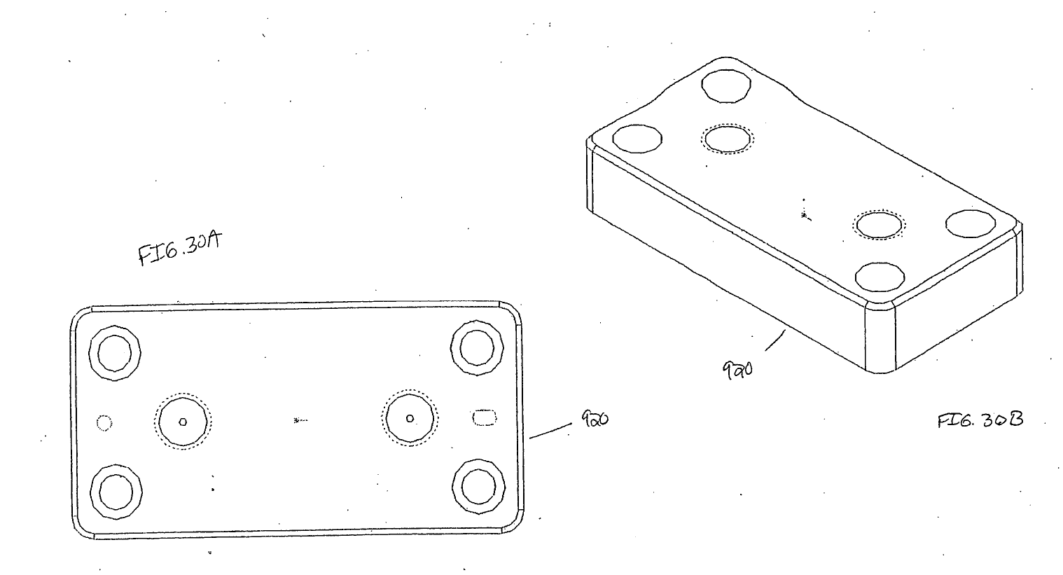

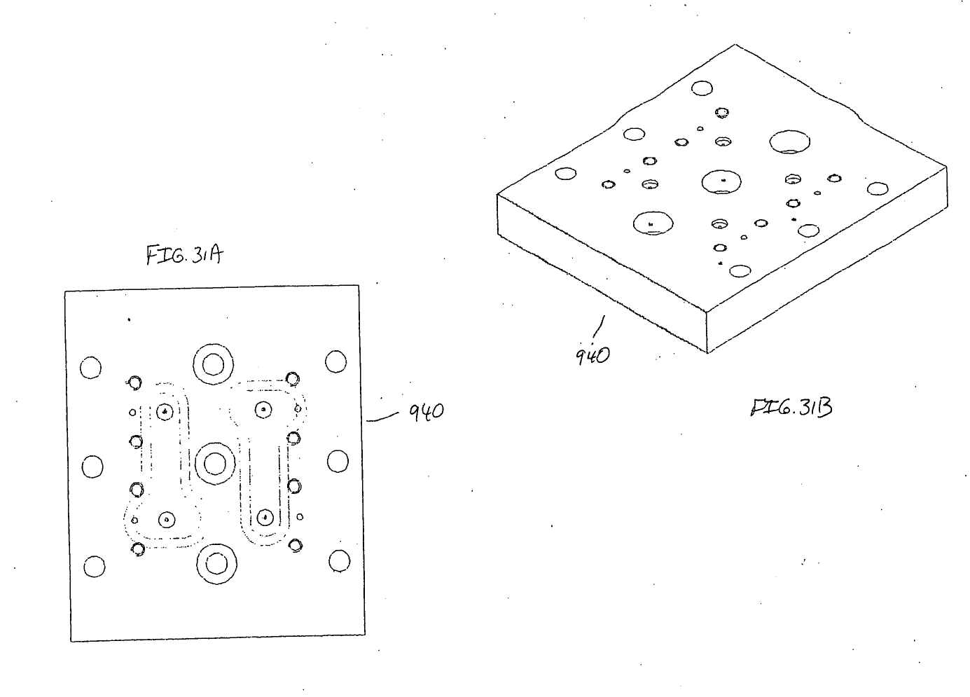

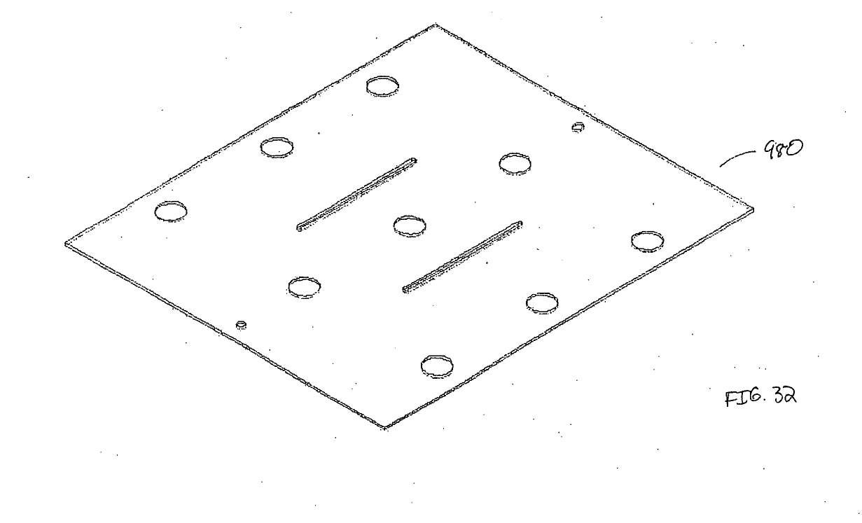

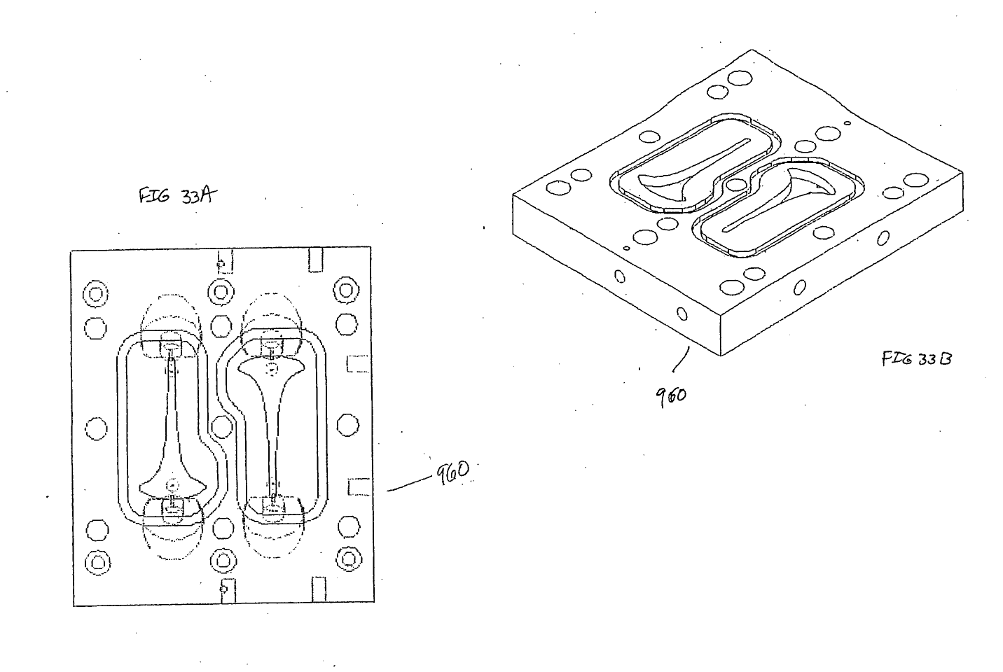

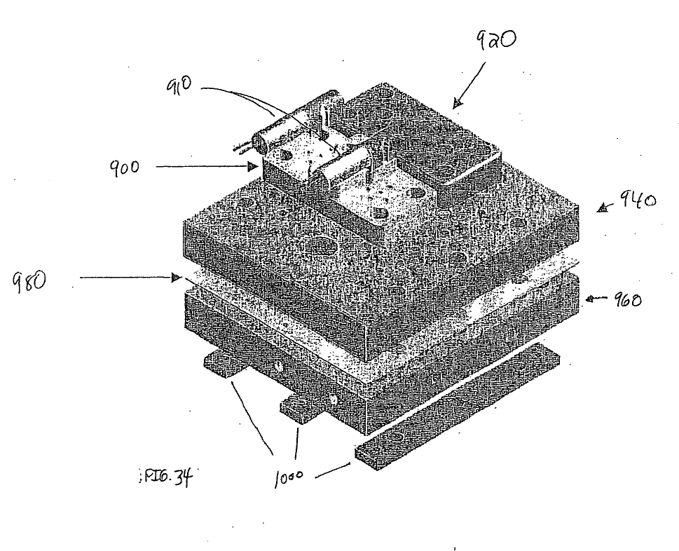

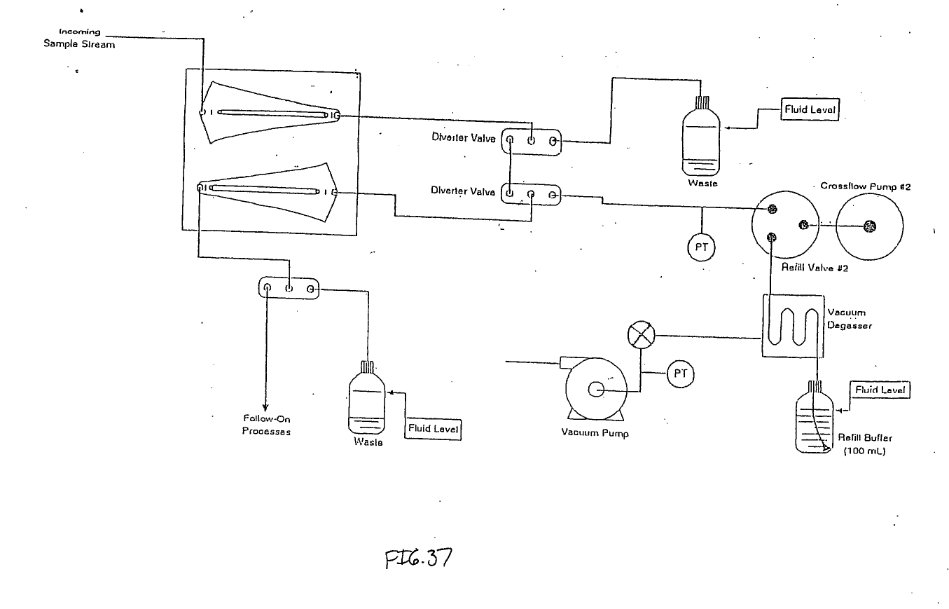

In accordance with certain preferred embodiments, FIGS. 29-34 illustrate an embodiment of an electrophoretic device in accordance with the disclosure herein. The device is comprised of a series of blocks which incorporate the necessary fluid flow paths and electrode paths to make up the device. The overall make-up of the blocks is illustrated in FIG. 34, which also includes a series of nut plate fasteners 1000 for transmitting the closing or sealing force of a series of nuts and bolts, not shown, more evenly across the blocks. FIGS. 29A and 29B illustrate top and isometric views of a diverter manifold 900, which as shown in FIG. 34 incorporates one or more diverter valves 910, such as, for example, 3-way valves which are commercially available. The diverter valve(s) can be manually or electronically controlled to direct a sample fluid flow toward either of two electrophoretic device separation chambers, each of the separation chambers being arranged for focusing an analyte in the sample fluid and then passing the focused analyte to a different treatment device. Optionally, a multiport diverter valve can be employed, such that a sample can be flowed into the second separation channel or can be diverted to more than one possible additional sample treatment and/or detection system. FIGS. 31A and 31B are top and isometric views of a general fluidic interface manifold 920. While the general fluidic interface manifold presented in this figure directs fluid flow uninterrupted through the manifold, the general fluidic interface manifold can include additional fluid handling devices, such as, for example, one or more diverter valves, one or more sample splitters to distribute a single entering fluid into two or more separate fluidic pathways, etc. Similarly, the diverter manifold may incorporate additional fluid handling devices. Optionally, a single manifold is used which incorporates all of the necessary or desired fluid handling devices. In other preferred embodiments, more than two manifolds are utilized, such as, for example, where more than one separation chamber is incorporated into a single device. Suitable manifold arrangements and fluid handling arrangements of the manifolds will be readily apparent to those of skill in the art, given the benefit of the present disclosure.

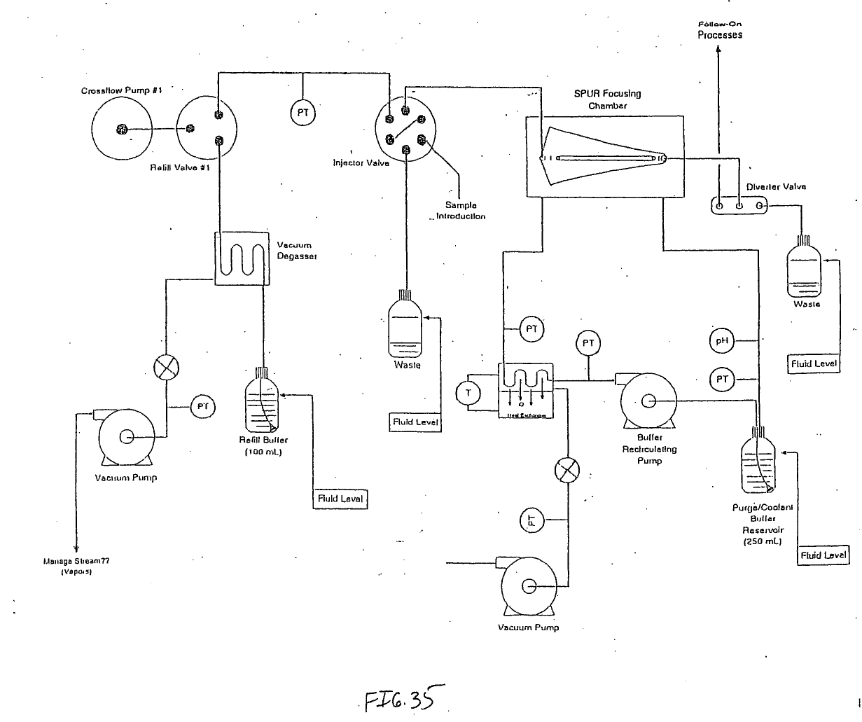

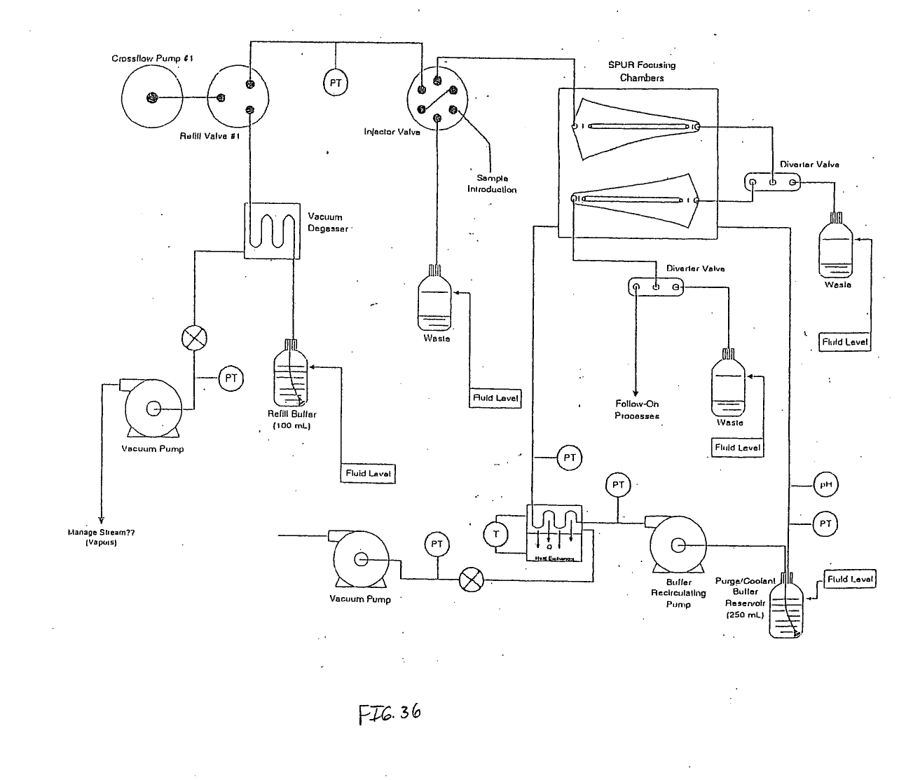

FIGS. 31A and 31B show a top block 940 and FIGS. 33A and 33B show a bottom block 960 suitable for use in certain embodiments of the systems and methods disclosed here. Each of these blocks optionally contains holes for acceptance of fasteners or a closing mechanism, for example, a nut and bolt configuration which clamps the blocks together and seals the fluidic pathways within the blocks. Sandwiched in between the top and bottom blocks in certain preferred embodiments is a separation channel layer, such as, e.g., the separation channel layer 980 illustrated in FIG. 32. The separation channel layer preferably also serves as a sealing gasket for sealing the top and bottom blocks. This separation channel layer may likewise have holes for acceptance of a closing mechanism. The separation channel layer has separation channels cut into and optionally through the layer material, such that the material acts as the side walls and the lower face of the top block serves as the top wall of the separation channels. Alternatively, separation channels may be cut into the lower face of the top plate itself. Other suitable separation channel configurations will be readily apparent to one skilled in the art, given the benefit of the present disclosure. The top block 940 has fluid pathways cut into the substrate to allow the fluid containing the sample to enter the separation channels. Similarly, the bottom block 960 has fluid pathways for the introduction and removal of fluid into and from the electrode chambers, which are incorporated into the bottom block. The electrode chambers may be cut, carved, stamped, etched or otherwise incorporated into the substrate of the bottom block. Alternatively, the bottom block may comprise layers, laminates or composites, in which the electrode chambers are cut out of a first layer such that the first layer acts as the side walls, and the first layer then overlayed a second flat layer, which acts as the bottom wall of the chamber. The latter is advantageous in that a uniform second layer could be mass-produced, and alternative first layers could be custom cut to incorporate different electrode chamber configurations and, therefore, different electric field gradients. The bottom block will further comprise electrode pathways for admitting an electrode into the electrode chamber, typically two electrode pathways per electrode chamber for admitting two electrodes into each electrode chamber. Optionally, an array of electrode pathways will exist for the admission of an array of electrodes into the electrode chamber. A porous, conductive membrane will be interposed between the separation chambers and the electrode chambers to separate the separation channels and the electrode chambers while allowing the electric field gradient of the electrode chambers to be passed through to the separation channels. Such a membrane will typically be a flat material sandwiched between the separation channel layer and the bottom block. Other suitable top and bottom block configurations will be readily apparent to one skilled in the art, given the benefit of this disclosure.

In certain preferred embodiments, an optical sensor flow cell is located between the top block and the manifold block or blocks for detecting and optionally quantifying analyte located in the separated focused bands. The optical sensor flow cell may comprise a block similar to the other blocks in that it may contain holes for acceptance of a closing or sealing mechanism, and may comprise a composite, laminate or other layered configuration. The optical sensor flow cell will typically have a fluid input and output and will have a pair of windows configured such that a beam of light can pass into the flow cell, through the sample, and out of the flow cell. Windows as used herein refers to construction and material selection such that a desired wavelength of light, typically ultraviolet or visible light, can pass through the window in sufficient quantity to allow the light beam to be used as a detector and optionally to allow for quantification by means of the light beam. Advantageously, the window is comprised of a material that permits sufficient light to pass over a range of wavelengths, for example over the entire visible spectrum, preferably over the UV and visible spectrum, to permit a variety of wavelengths of light to pass, to permit detection and analysis over a range of wavelengths. Other suitable optical sensor flow cell configurations include those enabling detection by refraction, fluorescence or phosphorescence and other optical detection means. Such optical detection means are known and will be readily apparent to those of skill in the art, given the benefit of this disclosure. Other preferred embodiments incorporate a detector flow cell, preferably located between the top block and the manifold(s) that incorporate other suitable sensors such as, for example, electrochemical sensors. Other suitable sensors will be readily apparent to those skilled in the art, given the benefit of the present disclosure.

In a typical dual-channel series arrangement, as exemplified in FIGS. 29-34, the fluid containing the sample will flow into the general fluidic interface manifold, then into a fluidic pathway in the top block leading to one end of the first separation channel, typically to the end containing the lowest absolute electric field strength of the gradient. The sample will focus in the separation channel into one or more separate bands, which will simultaneously be held in the channel. At the same time, any species in the sample of insufficient electrophoretic mobility, given the electric field strength being applied, will elute from the channel. After focusing, the electric field strength can be lowered such that the band of lowest electrophoretic mobility elutes from the first separation channel. The band then flows through the top block into the diverter manifold, where it is either directed towards the second separation channel or is diverted to an outlet, for example a waste outlet. Optionally, the band is diverted to an outlet that is attached to a downstream element such as, for example, a further sample treatment or detection instrument or other suitable device, or optionally the band is sent to an outlet for collection. When the band is directed to the second separation channel, it is then held in the second separation channel by the second electric field and possibly separated into further discreet bands. By decreasing the electric field strength in the second separation channel, the band can be eluted from the second channel, from which it passes back up through the general fluidic interface manifold and on to the next downstream element. Optionally, the general fluidic interface manifold comprises one or more diverter valves such that the eluting band can be diverted to one of multiple downstream elements. Such is advantageous, for example, when multiple desired bands exist and are to be subject to differing post-separation treatment and/or analysis.

Such an apparatus can optionally can have diverter valves located at both the inputs and outlets of each separation channel, such that the two separation devices can be run in parallel as well as in series as described above. Such an apparatus could use a diverter valve or sample splitting device to split the sample into two (or more) separate fluidic streams, each of which enters its own separation channel. Such a set-up is advantageous in that it allows for increasing the throughput; additionally, it may be desirable to separate the sample for introduction into two or more distinct treatment and/or detection steps downstream from the apparatus. Optionally, the separation chambers can be arranged to run two different samples simultaneously, that is to say, can be run as two distinct electrophoretic devices at the same time. It will of course be recognized by those skilled in the art, given the benefit of the present disclosure, that the output from any of the above embodiments can be further directed into an apparatus in accordance with any of the above devices and apparatuses, such that, for example, a system could be established using any combination of the above devices along with the appropriate number and location of fluidic pathways or connections and diverter valves or manifolds to achieve any desired degree of separation and subsequent sample handling.

In certain preferred embodiments, the electrode chamber does not contain electrolyte, e.g., buffer. The electrodes are separated from the separation chamber by a barrier that can comprise the porous conductive membrane as described above, or optionally may comprise a conductive, substantially non-porous material, such as, for example, a ceramic material. Other suitable barrier materials will be readily apparent to one skilled in the art, given the benefit of the present disclosure. In such an embodiment, the shape of the electrode chamber would not serve to create a gradient in an otherwise uniform electric field. In certain preferred embodiments, an electrode array or a shaped resister is utilized to create the gradient in the electric field. Suitable electrode arrays are described, for example, in U.S. Pat. No. 6,277,258, hereby incorporated in its entirety for all purposes. In yet other preferred embodiments, the membrane or barrier is shaped, for example, is varied in thickness, to create the gradient in the electric field. Other suitable means for generating a gradient in the electric field will be readily apparent to one skilled in the art, given the benefit of the present disclosure.

In accordance with certain preferred embodiments, FIGS. 35-37 are schematic illustrations showing exemplary SPUR apparatuses, with FIG. 35 representing a single electrophoretic device and FIGS. 36 and 37 representing apparatus containing two electrophoretic devices. The devices can be controlled, for example, via RS-232, LAN, or contact closure interfaces and advantageously can be used with commercially available liquid handlers to allow unattended analyte preconcentration. Fluidic samples, for example, aqueous-phase samples, are injected into the first analytical or sample chamber with the trapping electric field turned on, and the sample is allowed to separate and focus into one or more bands of focused analyte. The electric field is then lowered to allow a low mobility band of analyte to exit or be eluted from the chamber. The eluted band then passes to a follow-on process or processes as exemplified in FIG. 35, or is flowed into the second electrophoretic chamber via a diverter valve as exemplified in FIGS. 36 and 37. As described above, bands can be located within either chamber by separately manipulating the strength of the electric field in each chamber. Such a design is advantageous in that it permits the removal of bands of intermediate mobility while allowing the apparatus to retain bands of higher and lower mobility in the electrophoretic chambers. For example, desired bands of low mobility can be eluted from the first chamber and permitted to flow into the second chamber and then to a follow-on process or processes as desired. Typical operating parameters of an apparatus of this type with a 1-inch chamber are as described in Table 1 above. Advantageously, the dual-chamber apparatus further comprises a second crossflow pump, such as that found in the apparatus of FIG. 37, to provide flow through the second (downstream) electrophoretic device while the diverter valve separating the first (upstream) device from the second device is open to waste. The apparatus illustrated in FIG. 37 further provides for parallel operation of the pair of electrophoretic chambers, such that a sample can be split previous to injection and injected simultaneously onto each of the electrophoretic devices by appropriate manipulation of the pair of diverter valves. A second sample introduction site, for example, located downstream of refill valve #2, would permit the introduction of sample onto the second electrophoretic device, while an additional diverter valve located between the first diverter valve following the first device and the waste would allow diversion of desired bands to follow-on processes in a fashion similar to that found after the electrophoretic chamber of the single-chamber apparatus of FIG. 35. Further, such a configuration would allow the simultaneous treatment of two different samples, which need not be related. Such would effectively double the output of the apparatus by effectively allowing it to function as two distinct apparatuses. Other suitable configurations will be readily apparent to those of skill in the art, given the benefit of this disclosure.

As exemplified in FIGS. 35 and 36, certain preferred embodiments utilize a buffer recirculating pump, a vacuum pump and a heat exchanger to circulate buffer through the electrode chambers of each electrophoretic device. In this way, the buffer serves to transmit the electric field gradient to the separation chambers and to remove heat and gas generated by the electrodes. The actual connections to the electrode chambers are omitted for clarity purposes. Such a configuration would also typically be present in the apparatus illustrated in FIG. 37, and is omitted from FIG. 37 for clarity purposes. Other suitable electrode chamber fluid handling systems will be readily apparent to those skilled in the art, given the benefit of this disclosure.

In each of FIGS. 35-37, sample is introduced via an injector valve. The samples may be directly injected, or in certain preferred embodiments may be brought into the injector valve directly or indirectly from the output of a preceding instrument, such as, for example, and HPLC instrument. In this fashion, the apparatus can be used to link up separate instruments in a hyphenated fashion, whereby the sample flows directly from one instrument into the apparatus and then into the follow-on instrument. Other suitable injection devices, for example, sample loops, etc., will be readily apparent to those skilled in the art given the benefit of the present disclosure.

Additional sample injections may be used in certain preferred embodiments to accumulate or concentrate low abundance materials while holding previous samples in either the first or, where one is present, the second chamber. Alternatively, continuous flow of sample may be so used, or a combination of continuous flow and additional injections. Further, additional such electrophoretic devices may be used in serial or in parallel networks to provide additional separation flexibility for accumulating multiple analytes for collection or analysis. Additional peripherals may be added for a specific test. Other suitable apparatus designs will be readily apparent to those of skill in the art, given the benefit of this disclosure.

Certain examples are described below demonstrating exemplary uses of the devices and methods disclosed here. The illustrative examples below should not be construed as limiting the scope or content of the claims in any manner.

### EXAMPLE 1

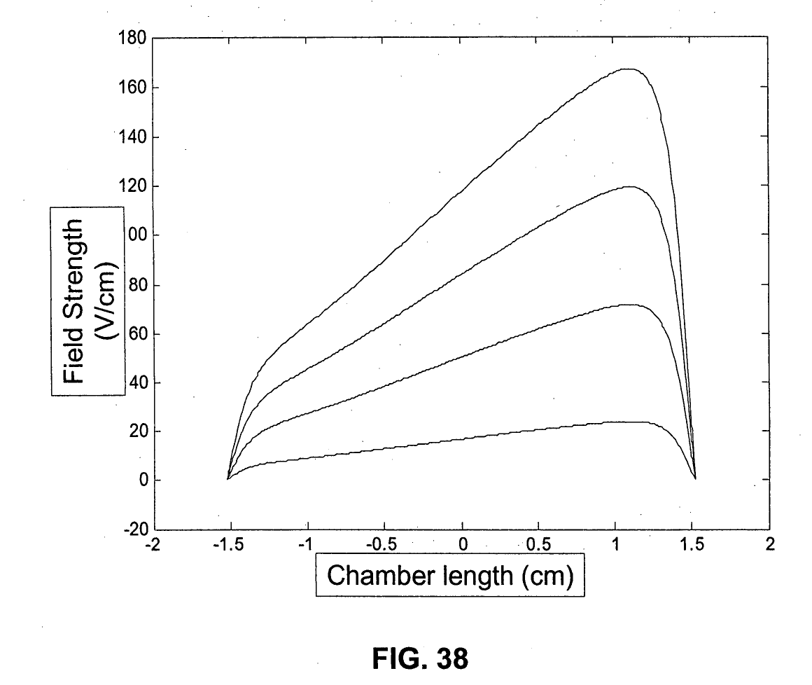

The linear electric field generated using an electrophoretic device employing two electrodes (i.e., one anode and one cathode) is shown in FIG. 38. The linear field is pinned at one end, i.e. at the left of the graph, which typically is the field near the inlet of the electrophoretic device. This “pinning” limits the devices ability to resolve molecular entities that have electrophoretic mobilities that are close in value.

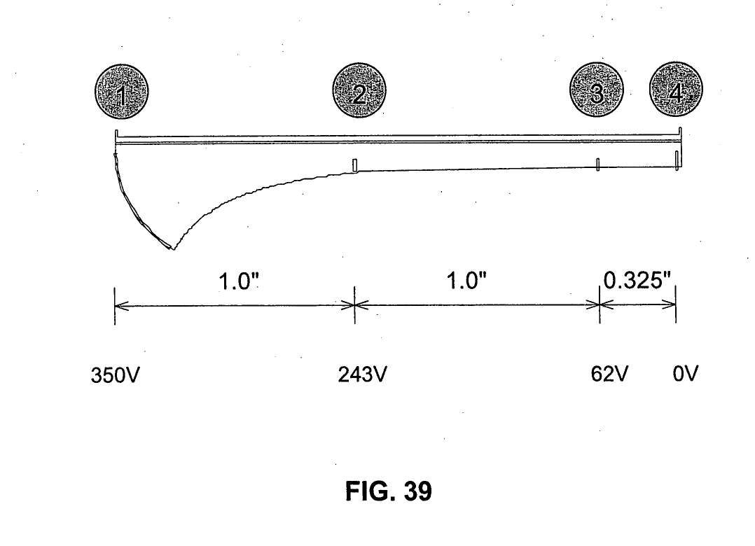

Without wishing to be bound by an particular scientific theory, as the slope of the electric field is decreased in an attempt to “pull” the molecular entities apart, e.g. to spatially separate the two molecular entities, two things may occur. First, because the local field strength is falling, the band width of each molecular entity will broaden. Second, it is believed that at a shallow field gradient and low field strength, the closely spaced molecules will be swept from the separation path prior to being resolved. The ability of resolving closely spaced molecular entities is essential in many separations. To eliminate this “pinning” a shaped electrode chamber can be used to control the shape of the electric field and a multitude of electrodes to control the magnitude of the field. FIG. 39 is an illustration of an electrophoretic device with a non-uniform electrode chamber and the positions of four electrodes along the length of the electrode chamber. Electrodes 1-3 are anodes and electrode 4 is the cathodes.

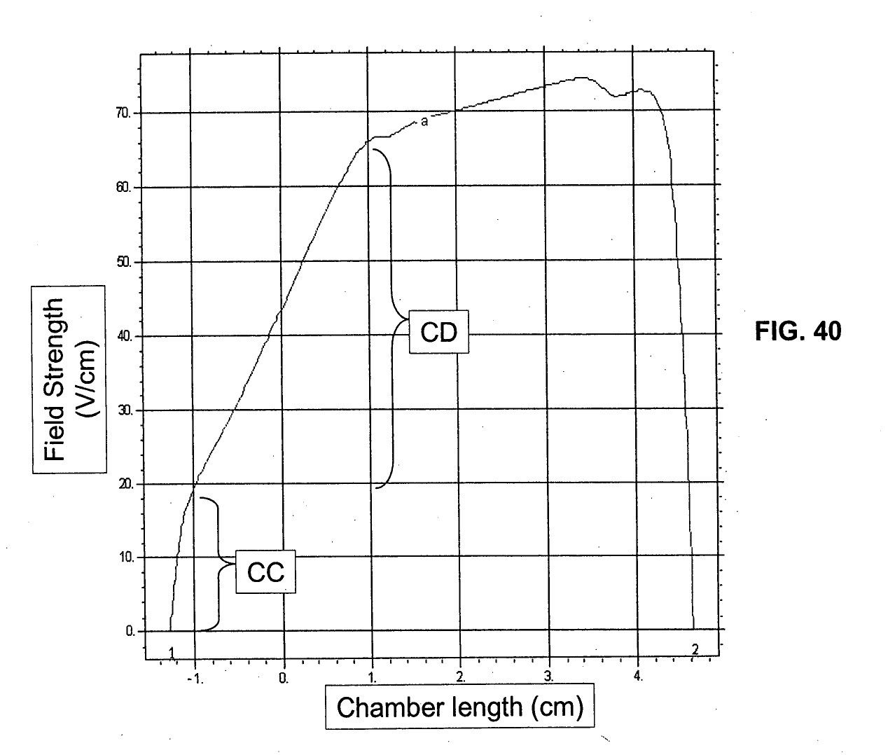

FlexPDE, commercially available from PDE Solutions, Inc., was used to mathematically simulate the electric field in the device having an electrode chamber as shown in FIG. 39. FIG. 40 is a plot of the electric field calculated along the length of the separation chamber using the applied voltages of 350V, 243V, and 62V on electrodes 1, 2, and 3, respectively, of the device shown in FIG. 39. The plot shows an electric field with multiple linear segments, such as segments (CC and CD), where one segment has a steep gradient (segment CC) and the other a shallow gradient (segment CD). Without wishing to be bound by any particular scientific theory, the irregularities in the field shape are due to a mismatch in the applied voltages. For instance, the concave up behavior observed at approximately x=3.75 can be eliminated by increasing the applied voltage from the value of 62 V, used in the simulation, to a higher value.

It should be noted by changing the overall size of the electrode chamber, e.g. increasing the length of the electrode chamber, the maximum magnitude of possible field strengths may be lowered. The electrode chamber length may be increased, for example, to accommodate increased processing capacity of the separation chamber. In order to achieve the same magnitude of field strengths in longer chambers, is may be necessary to use increased amounts of applied voltage, e.g. 800-900 V.

The outlet port of the electrophoretic device is preferably positioned such that is not within the decreasing electric field shown at the far right of FIGS. 38 and 40. Without wishing to be bound by any particular scientific theory, separated analytes can become defocused in the region of the decreasing electric field shown at the right of the graph of FIG. 38.

### EXAMPLE 2

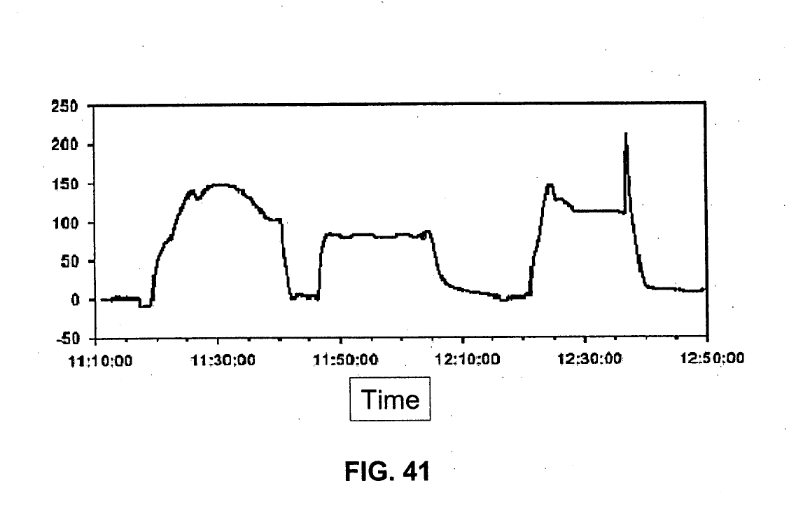

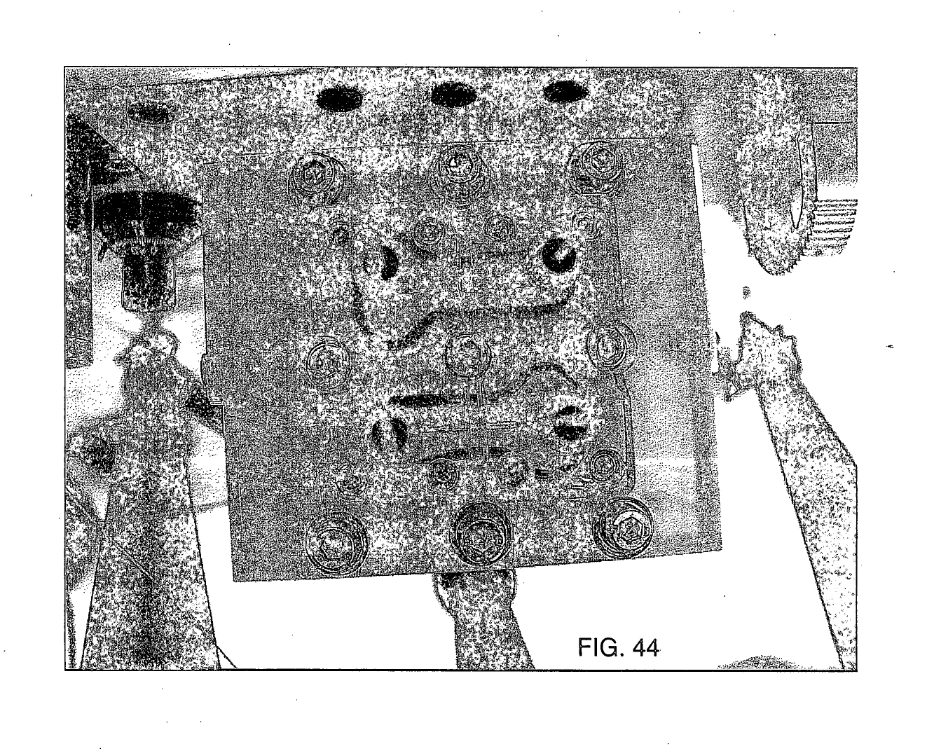

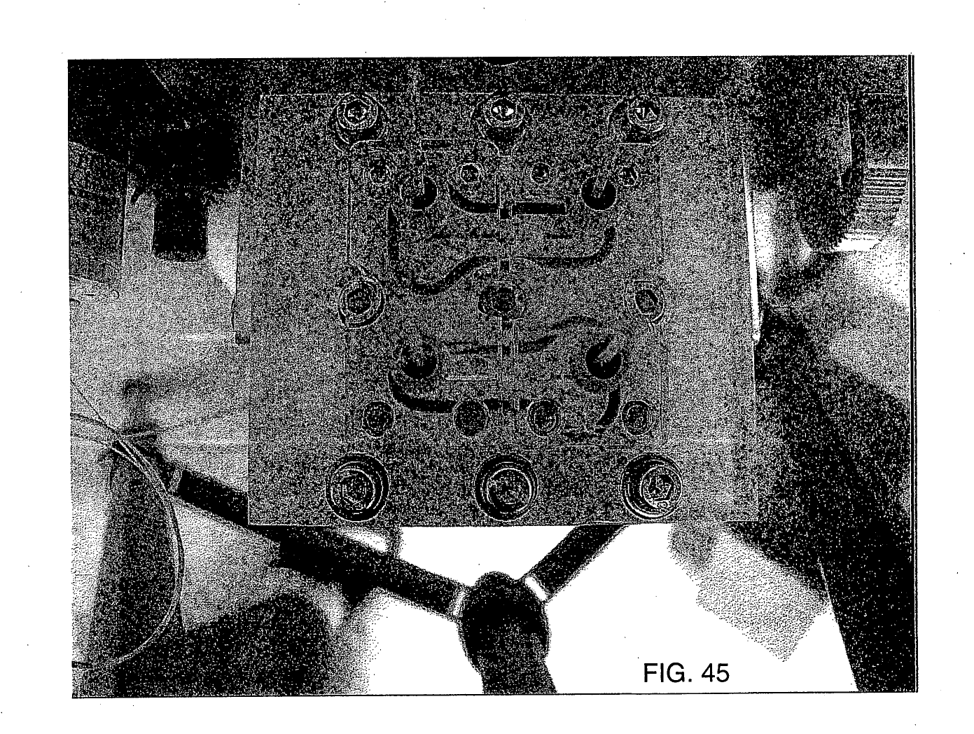

A cocktail of bromophenol blue, new coccine and methyl red dyes was used to test an example device. The cocktail of methyl red, new coccine, and bromophenol blue (0.2 mg/mL each) was prepared by adding 200 μL 1.0 mg/mL methyl red+200 μL 1.0 mg/mL new coccine+200 μL 1.0 mg/mL bromophenol blue to 400 μL 20 mM tris-acetate buffer. 20 mM tris-acetate at pH 8.525 was used as the as elution and purge buffer. A 100 MWCO dialysis membrane (Spectrum Lab 131-021) membrane was used as the membrane. A Greylor mini gear pump (PQ-12DC) was used as a purge pump, narrow to wide. The flow rate used was about 250 uL/hr. A UV/VIS detector was warmed up for about 20 minutes prior to beginning the separation. A suitable amount of the dye cocktail was injected. The power was set to 200 V. About 8 minutes after injecting the cocktail, at least two color zones were observed in the sample channel—a green zone (methyl red is green at this pH) in the front and a purple zone tailing the green zone. About 11 minutes after injecting the cocktail, the purple zone was observed to turn blue (bromophenol blue). After about 40 minutes, the power was turned off. The blue band did not appear to move any further. The power was switched back on at −200 V. The rate of elution was about 400 uL/hr. Another injection of dye cocktail was performed and the power was switched to 200 V. About 10 minutes later, bands were eluted off. The results are shown in FIGS. 41, 44 and 45.

The table below summarizes the above experiment.

| Time | Operation/Results |
|---|---|
| 10:50 am | Detector (AD-200) 260 nm warm up |
| 11:11 am | 215 nm auto zero, elution 250 uL/hr |
| 11:16:49 am | Inject cocktail of methyl red, new coccine, and |
| | bromophenol blue and turn power on 200 V |
| 11:24:23 am | At least two color zones form in the sample channel - |
| | green (methyl red is green at this pH) in the front |
| | and a purple tail |
| 11:27:47 am | The purple zone turns blue (bromophenol blue) |
| 11:31:15 am | Elution 300 uL/hr, the new coccine went between the |
| | dialysis membrane and the Teflon sheet or went into |
| | the membrane itself |
| 11:34:09 am | Elution 350 uL/hr |
| 11:36:13 am | Elution 400 uL/hr |
| 11:39:09 am | Power off |
| 11:43:33 am | The blue zone does not move |
| 11:44:49 am | Power on at 200 V |
| 12:03:13 pm | Power Off |
| 12:17:57 pm | Elution 400 uL/hr |
| 12:18:51 pm | Inject cocktail of methyl red, new coccine and |
| | bromophenol blue and turn power on at 200 V |
| 12:29:30 pm | Elution off |
| 12:35:21 pm | Power off, elution 400 uL/hr |
| 12:46:41 pm | Elution 100 uL/hr |

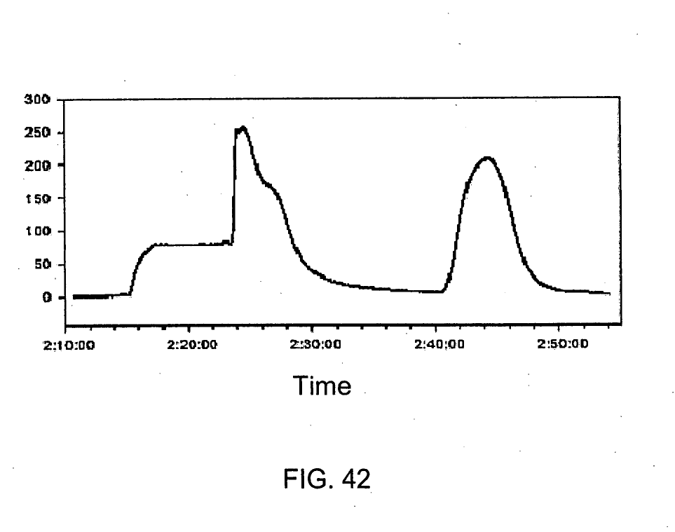

Another injection was made in which 1.0 mg/mL new coccine was injected. The power was switched on for about 4 minutes at 200 V. The power was switched to −200 V to stack the bands. The power was switched off and the bands were eluted. It appears that the coccine went between the dialysis membrane and the Teflon sheet or went into the membrane itself. To achieve effective separation of dye mixtures including coccine, it may be necessary to use a different membrane. FIG. 42 is a graph showing the results of the above experiment and the table below summarizes the results of the above experiment.

| Time | Operation/Result |
|---|---|
| 2:10:00 pm | Elution 250 uL/hr |
| 2:12:45 pm | Inject 1.0 mg/mL new coccine |
| 2:13:19 pm | Power on at 200 V |
| 2:17:35 pm | Elution off, power off |
| 2:18:13 pm | Power on −200 V, stacking |
| 2:22:07 pm | Power off, elution 250 uL/hr |
| 2:36:01 pm | Inject 1.0 mg/mL new coccine as control |

### EXAMPLE 3

A cocktail of methyl red and new coccine dye was made (200 uL 1.0 mg/mL methyl red+small amount of new coccine powder+800 uL 20 mM tris-acetate buffer). The detector was zeroed and the dye mixture was loaded. A flow rate of about 200 uL/hour was used. The power was originally switched on at 100 V in the first chamber and 350 V in the second chamber. Bubbles were observed in the sample channel. It was found that the methyl red was staining the membrane, which resulted in poor separation. To achieve separation of methyl red and coccine, it is necessary to use a different membrane.

### EXAMPLE 4

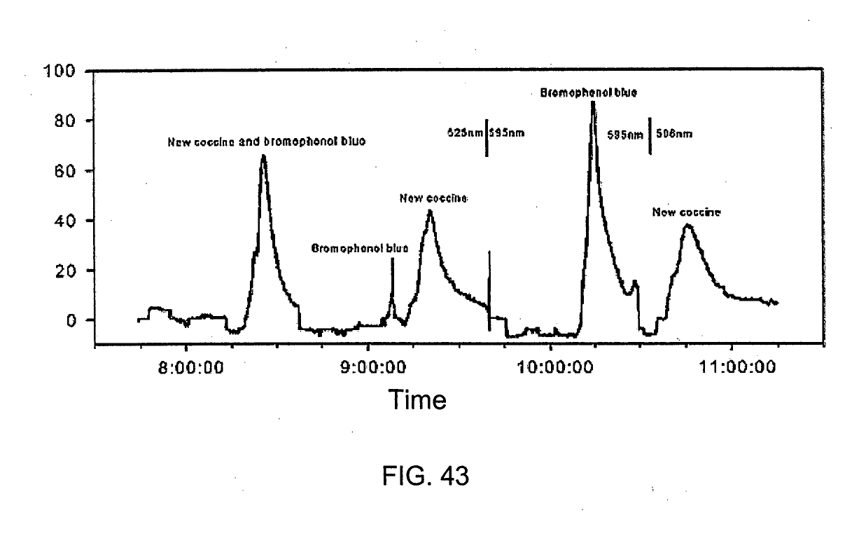

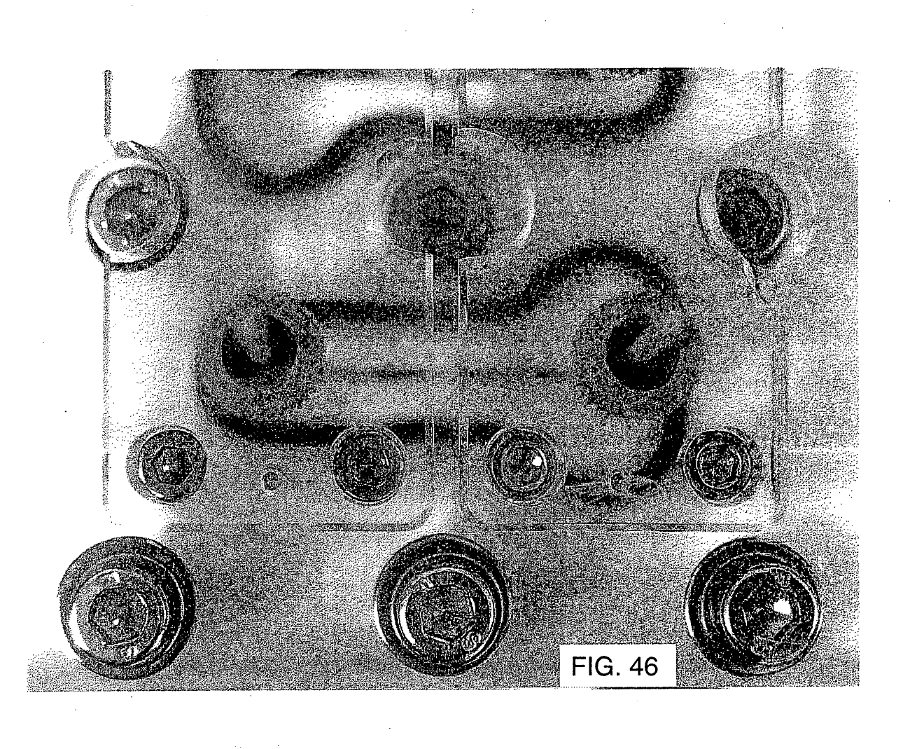

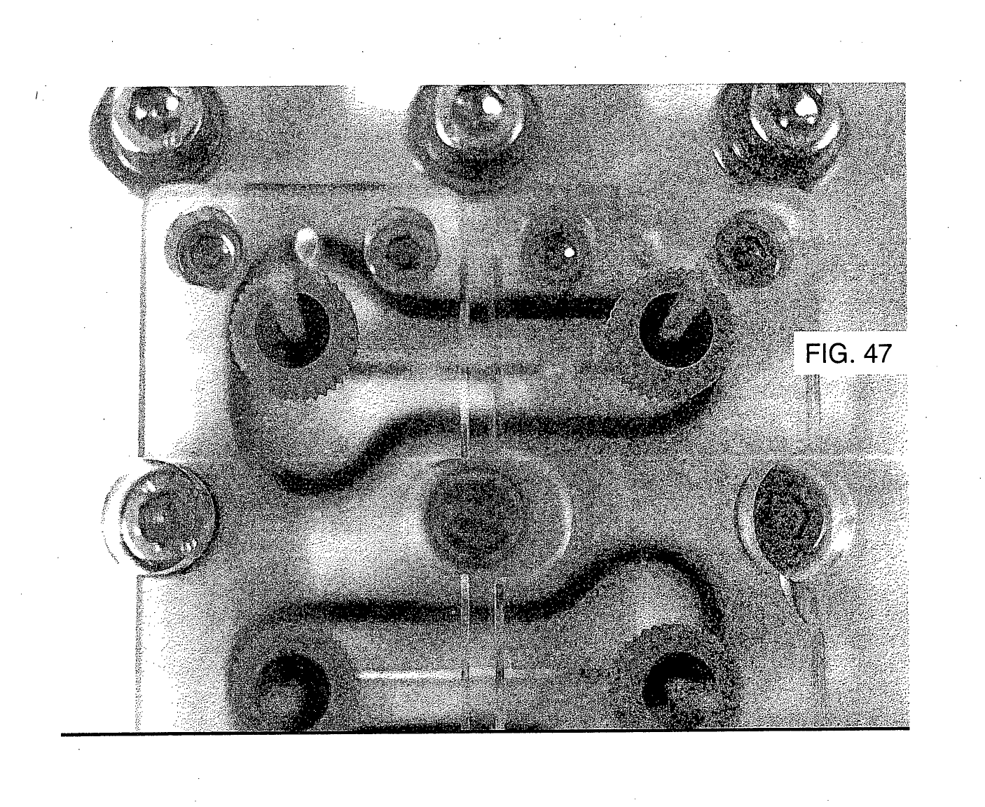

A cocktail of bromophenol blue and new coccine dyes was used to test an example device having a first chamber set from narrow to wide and a second chamber from wide to narrow. The cocktail of new coccine (0.4 mg/mL) and bromophenol blue (0.2 mg/mL) was prepared by adding 400 μL 1.0 mg/mL new coccine+200 μL 1.0 mg/mL bromophenol blue to 400 μL 20 mM tris-acetate buffer. The flow rate used was about 250 uL/hr. A UV/VIS detector was warmed up for about 25 minutes prior to beginning the separation. The results are shown in FIGS. 43, 46 and 47.

The flow rate was set to about 200 uL/hr. A suitable amount of the dye cocktail was injected. About 2 minutes after the cocktail was injected, the power was set to 200V in the first chamber and 350V in the second chamber. About 10 minutes after the injection, the power in the first chamber was reduced to 150V to elute the bromophenol blue band. About 21 minutes after the injection, the power was turned off; about one minute later, the power was turned on to 150V in the first chamber and 350V in the second chamber. The power in the first chamber was adjusted to 300V about one-half of a minute later. About 25 minutes following the injection, the power and flow rates were each set to zero. About 4 minutes following this, the power in the second chamber was set to −350V to stack the bromophenol blue, that is to say, to more tightly focus the bromophenol blue, and the elution was set to 200 uL/hr to elute the bromophenol blue band about two minutes later. About two minutes later, the power was turned off, and about four minutes subsequent to turning off the power, the flow was turned off while the power was set to −350V in the second chamber to stack the new coccine. After allowing the new coccine to stack for about 3 minutes, the power was turned off and the flow was adjusted to 200 uL/hr to elute the new coccine.

The experiment was repeated without the stacking steps as follows. The flow was set to 200 uL/hr, and a cocktail of the bromophenol blue and new coccine was injected. About 1 minute after making the injection, the power in the first chamber was set to 150V and in the second chamber to 350V. About 14 minutes after making the injection, the power in the first chamber was set to 125V, and about 24 minutes after making the injection, the power was turned off. About one minute later, the power in the first chamber was set to 350V (with the power in the second chamber off) to elute the bromophenol blue. After about 12 minutes of elution time, the power in the first chamber was turned off, and after about 8 more minutes, the power in the second chamber was set to 350V. About 7 minutes later, the power in the second chamber was turned off to elute the new coccine. About 34 minutes following the injection, the purge pump was turned off, and the flow rate was set to 100 uL/hr and the elution was continued overnight. The table below is a summary of the above experiment.

| Time | Operation/Result |
|---|---|
| 7:35 pm | Detector (AD-200) 260 nm warm up |
| 7:43 pm | 525 nm, auto zero |
| 7:45 pm | Purge on (1: narrow to wide; 2 wide to narrow) |
| 7:54:47 pm | Auto zero |
| 8:02:37 pm | Refill syringe, 200 uL/hr |
| 8:03:22 pm | Inject a cocktail of new coccine and bromophenol blue |
| 8:09:37 pm | Power on 1: 100 V; 2; 350 V |
| 8:14:42 pm | Power off (power on too late to capture anything) |
| 8:32:52 pm | Inject cocktail of new coccine and bromophenol blue |
| 8:34:47 pm | Power on 1: 200 V; 2: 350 V |
| 8:42:12 pm | Power on 1: 150 V to elute bromophenol blue |
| 8:53:37 pm | Power Off |
| 8:54:32 pm | Power on 1: 150 V; 2: 350 V |
| 8:55:07 pm | Power 1: 300 V |
| 8:57:42 pm | Elution off, power off |
| 9:01:42 pm | Power 1: disconnected; 2: 350 V to stack bromophenol blue |
| 9:03:52 pm | Elution 200 uL/hr to elute bromophenol blue |
| 9:05:47 pm | Power Off |
| 9:09:12 pm | Elution off, power 2: −350 V to stack new coccine |
| 9:12:07 pm | Power off, elution 200 uL/hr to elute new coccine |
| 9:39:27 pm | Refill syringe, elution 200 uL/hr |
| 9:40:17 pm | 595 nm, auto zero |
| 9:42:07 pm | Inject cocktail of new coccine and bromophenol blue |
| 9:42:57 pm | Power on 1: 150 V; 2: 350 V |
| 9:56:22 pm | Power 1: 125 V |
| 10:06:07 pm | Power off |
| 10:07:32 pm | Power 1: 350 V; 2: disconnected, to elute bromophenol |
| | blue |
| 10:19:07 pm | Power off |
| 10:27:12 pm | Power 1: disconnected; 2: 350 V |
| 10:34:42 pm | Power off to elute new coccine |
| 10:35:43 pm | 506 nm, auto zero |
| 11:14:43 pm | Turn off purge pump, elution 100 uL/hr overnight |

### EXAMPLE 5

Naproxen and ibuprofen are separated using the methods described above. Because naproxen and ibuprofen have slightly different mobilities, it is possible to baseline separate the two species using the methods and devices described above.

### EXAMPLE 6

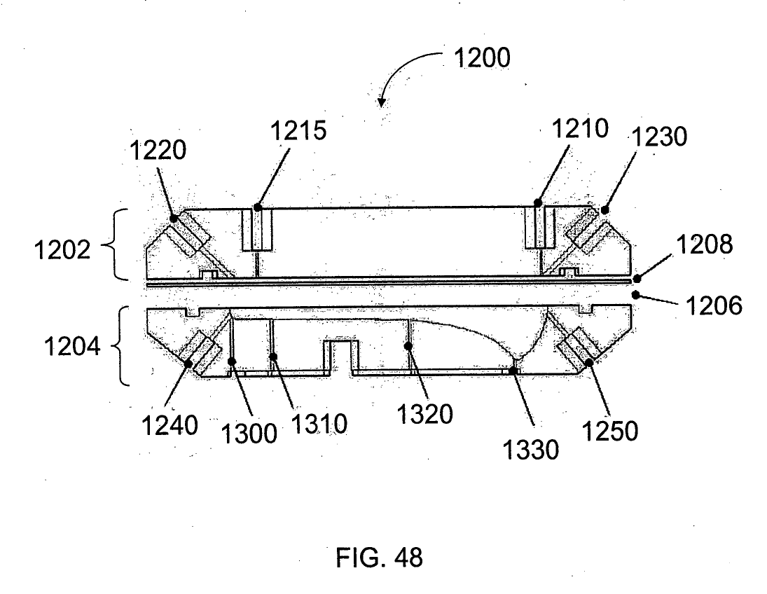

An example of an electrophoretic device including 4 electrodes is shown in FIG. 48. Device 1200 comprises top clamp block 1202, bottom clamp block 1204 comprising a non-uniform electrode chamber, porous membrane layer 1206 and uniform separation chamber 1208. The device also includes sample inlet port 1210, sample outlet port 1215, packing ports 1220 and 1230, coolant buffer ports 1240 and 1250, and electrodes, 1300, 1310, 1320 and 1330. Sample inlet port 1210 is for introducing sample and bulk fluid flow into the separation chamber, and sample outlet port 1215 is for removing separated analytes from the separation chamber. Optional packing ports 1220 and 1230 are configured to introduce packing material, such as a stationary phase, into the separation chamber. Coolant buffer is introduced into one of coolant buffer flow ports 1240 and 1250 and exits through the other coolant buffer flow port. In some examples, the coolant buffer flows in the same direction as bulk fluid flow in the separation chamber, whereas in other examples, the coolant buffer flows in a direction opposite to bulk fluid flow. The coolant buffer acts to remove heat generated during application of voltages to the electrodes. Electrodes 1300, 1310, 1320 and 1330 are configured to be individually energized to provide an electric field gradient for separation of analytes in sample introduced into the device. The device shown in FIG. 48 may be part of a larger system, such as a system including an HPLC, NMR probe, etc. or may be a stand-alone device.

While various preferred embodiments of the methods and devices have been illustrated and described, it will be appreciated that various modifications and additions can be made to such embodiments without departing from the spirit and scope of the methods and devices as defined by the following claims.

1. An electrophoretic device comprising:
a separation chamber having a fluid inlet port and a fluid outlet port, with a flow path from the fluid inlet port to the fluid outlet port defining a fluid flow direction through the separation chamber;
an electrode chamber separated from the separation chamber by a porous, conductive membrane; and
electrodes positioned in the electrode chamber and operative when energized to generate an electric field gradient in the separation chamber,
wherein the electrode chamber has a non-uniform configuration along at least a portion of the flow path of the separation chamber.

2. The electrophoretic device of claim 1 wherein the membrane is substantially planar.

3. The electrophoretic device of claim 1, wherein the electrode chamber has a substantially uniform height and a non-uniform width.

4. The electrophoretic device of claim 1, wherein the electrode chamber has a substantially uniform width and a non-uniform height.

5. The electrophoretic device of claim 1, wherein the electrode chamber has a non-uniform width and a non-uniform height.

6. The electrophoretic device of claim 1, wherein the electrode chamber is defined by side walls that have a hyperbolic shape.

7. The electrophoretic device of claim 1, wherein the electrode chamber is defined by a top wall that has a hyperbolic shape.

8. The electrophoretic device of claim 1, wherein the electrode chamber is defined by side walls and a top wall each having a hyperbolic shape.

9. The electrophoretic device of claim 1, further comprising molecular sieve in the separation chamber operative to shift the location at which a stationary focused band of charged analyte forms under a given set of focusing process parameters.

10. The electrophoretic device of claim 1, wherein the electrode chamber is defined by one or more non-linear walls.

11. The electrophoretic device of claim 10, wherein the one or more non-linear walls of the electrode chamber are curved along the direction of flow.

12. The electrophoretic device of claim 10, wherein the electrode chamber has a substantially half-circular cross-section throughout its length.

13. The electrophoretic device of claim 1, wherein the separation chamber further comprises molecular sieve.

14. The electrophoretic device of claim 13, wherein the molecular sieve comprises a gel selected from the group consisting of organic gels, inorganic gels, fixed gels and soluble gels.

15. The electrophoretic device of claim 14, wherein the gel comprises molecules having a molecular weight of between about 2000 and about 100,000.

16. The electrophoretic device of claim 13, wherein the molecular sieve comprises zeolites.

17. The electrophoretic device of claim 1, wherein the electrodes comprise more than two electrodes.

18. The electrophoretic device of claim 1, wherein the electrode chamber is configured to provide an electric field gradient comprising multiple linear segments having different slopes.

19. The electrophoretic device of claim 18, wherein the electrode chamber comprises four electrodes.

20. The electrophoretic device of claim 1, wherein the separation chamber has a substantially uniform height and a non-uniform width or a substantially uniform width and a non-uniform height or a non-uniform width and a non-uniform height.

21. A processing system comprising:
a first sample treatment device having a fluid outlet port;
a second sample treatment device having a fluid inlet port and optionally having at least one operative fluidic requirement different from a corresponding operative fluidic requirement of the first sample treatment device; and
an electrophoretic device comprising
a separation chamber having a fluid inlet port in fluid communication with the fluid outlet port of the first sample treatment device and a fluid outlet port in fluid communication with the fluid inlet port of the second sample treatment device, with a flow path from the fluid inlet port of the separation chamber to the fluid outlet port of the separation chamber defining a fluid flow direction through the separation chamber, and
electrodes operative to generate an electric field gradient in the separation chamber.

22. The processing system of claim 21 in which the electrode chamber of the electrophoretic device is configured to provide an electric field gradient comprising multiple linear segments having different slopes.

23. The processing system of claim 22 in which the electrode chamber comprises 4 electrodes.

24. The processing system of claim 21, comprising multiple electrophoretic devices in fluid communication with each other between the first sample treatment device and the second sample treatment device.

25. The processing system of claim 24, wherein the electrophoretic devices are combined in parallel, serially and/or both.

26. The processing system of claim 21, wherein the electrophoretic device further comprises an electrode chamber separated from the separation chamber by a permeable membrane, the electrodes being positioned in the electrode chamber.

27. The processing system of claim 26 wherein the permeable membrane is substantially planar.

28. The processing system of claim 26 wherein the electrode chamber has a non-uniform configuration operative to establish a gradient in an electric field in the separation chamber, generated by the electrodes.

29. The processing system of claim 26, wherein the electrode chamber has a substantially uniform height and a non-uniform width or a substantially uniform width and a non-uniform height or a non-uniform width and a non-uniform height.

30. The processing system of claim 26, wherein the electrode chamber is defined by side walls that have a hyperbolic shape or a top wall that has a hyperbolic shape.

31. The processing system of claim 28, wherein the electrode chamber is defined by side walls and a top wall, at least one of the walls having a hyperbolic shape along the direction of flow.

32. The processing system of claim 21, wherein the electrode chamber is defined by one or more non-linear walls.

33. The processing system of claim 32, wherein the one or more non-linear walls of the electrode chamber are curved along the direction of flow.

34. The processing system of claim 32, wherein the electrode chamber has a substantially half-circular cross-section along the direction of flow.

35. The processing system of claim 21, further comprising molecular sieve in the separation chamber operative to shift the location at which a stationary focused band of charged analyte forms in the separation chamber under a given set of focusing process parameters.

36. The processing system of claim 35, wherein the molecular sieve comprises a gel selected from the group consisting of organic gels, inorganic gels, fixed gels and soluble gels.

37. The processing system of claim 35, wherein the gel comprises molecules having a molecular weight of between about 2000 and about 100,000.

38. The processing system of claim 35, wherein the molecular sieve comprises zeolites.

39. The processing system of claim 21, wherein the electrodes comprise a pair of electrodes.

40. The processing system of claim 39, wherein each electrode of the pair of electrodes is located proximate a corresponding end of the separation chamber.

41. The processing system of claim 21, wherein the electrodes comprise an electrode array.

42. The processing system of claim 21, wherein the separation chamber is non-uniform.

43. The processing system of claim 42, wherein the electrode chamber has a uniform cross-section flow channel.

44. The processing system of claim 42, wherein the separation chamber has a substantially uniform height and a non-uniform width.

45. The processing system of claim 42, wherein the separation chamber has a substantially uniform width and a non-uniform height.

46. The processing system of claim 42, wherein the separation chamber has a non-uniform width and a non-uniform height.

47. The processing system of claim 44, wherein the separation chamber is defined by side walls that have a hyperbolic shape.

48. The processing system of claim 45, wherein the separation chamber is defined by a top wall that has a hyperbolic shape.

49. The processing system of claim 46, wherein the separation chamber is defined by side walls and a top wall that each has a hyperbolic shape.

50. The processing system of claim 42, wherein the separation chamber is defined by one or more non-linear walls.

51. The processing system of claim 50, wherein the one or more non-linear walls are curved along the direction of flow.

52. The processing system of claim 50, wherein the separation chamber has a substantially half-circular cross-section throughout its length.

53. The processing system of claim 50, wherein the separation chamber comprises at least one wall of substantially hyperbolic shape in the axial direction.

54. The processing system of claim 42, wherein the porous, conductive membrane is substantially planar.

55. The processing system of claim 21, wherein the separation chamber comprises an inlet, an outlet, and an separation chamber insert that defines the separation chamber, wherein the separation chamber insert is insertable into a receptacle in the device such that the separation chamber is adjacent the membrane.

56. The processing system of claim 21, wherein the electrode chamber comprises an inlet, an outlet, and an electrode chamber insert that defines the electrode chamber, wherein the electrode chamber insert is insertable into a receptacle in the device such that the electrode chamber is adjacent the membrane.

57. A method for focusing a charged analyte comprising:
providing a device for focusing a charged analyte comprising
a separation chamber having a fluid inlet port and a fluid outlet port, with a flow path from the fluid inlet port to the fluid outlet port defining a fluid flow direction through the separation chamber,
an electrode chamber separated from the separation chamber by a porous, conductive membrane, and
electrodes positioned in the electrode chamber and operative when energized to generate an electric field gradient in the separation chamber,
wherein the electrode chamber has a non-uniform configuration along at least a portion of the flow path of the separation chamber;
introducing a fluid sample comprising analyte into the separation chamber via the inlet port; and
energizing the electrodes to establish an electric field gradient in the separation chamber to focus at least a portion of the analyte at a location along the flow path.

58. The method of claim 57, wherein the electric field gradient is changed during the course of focusing the analyte.

59. The method of claim 57, wherein the charged analyte comprises an uncharged material sorbed to or otherwise associated with a charged carrier.

60. The method of claim 57, wherein the separation chamber contains molecular sieve operative to shift the location at which a stationary focused band of a charged analyte forms under a given set of focusing process parameters.

61. The method of claim 60, wherein the molecular sieve comprises a gel.

62. The method of claim 57, wherein the charged analyte comprises a biological molecule.

63. The method of claim 62, wherein the charged analyte comprises DNA.

64. The method of claim 62, wherein the charged analyte comprises RNA.

65. The method of claim 62, wherein the charged analyte comprises protein.

66. The method of claim 57, wherein the charged analyte comprises a molecule sorbed to a detergent.

67. The method of claim 66, wherein the detergent comprises SDS.

68. The method of claim 57, wherein additional fluid comprising charged analyte is introduced into the separation chamber and focused.

69. The method of claim 57, wherein the electric field gradient is dynamically controlled.

70. A method for focusing a charged analyte comprising:
providing a device for focusing a charged analyte comprising:
a separation chamber and a non-uniform electrode chamber separated from the separation chamber by a substantially planar, porous, conductive membrane, with electrodes positioned proximate the electrode chamber and operative to generate an electric field in the electrode channel;
introducing a first liquid comprising a plurality of charged analytes into the separation chamber; and
applying an electric field gradient to the plurality of charged analytes in the first liquid to focus the plurality of charged analytes in the electric field gradient into stationary focused bands of charged analytes, each charged analyte forming a stationary focused band.

71. A method of processing a charged analyte comprising:
providing a processing system comprising:
a first sample treatment device having a fluid outlet port,
a second sample treatment device having a fluid inlet port and optionally having at least one operative fluidic requirement different from a corresponding operative fluidic requirement of the first sample treatment device, and
an electrophoretic device comprising
a separation chamber having a fluid inlet port in fluid communication with the fluid outlet port of the first sample treatment device and a fluid outlet port in fluid communication with the fluid inlet port of the second sample treatment device, with a flow path from the fluid inlet port of the separation chamber to the fluid outlet port of the separation chamber defining a fluid flow direction through the separation chamber, and
electrodes operative to generate an electric field gradient in the separation chamber;
passing a flow of fluid from the outlet port of the first sample treatment device to the fluid inlet port of the separation chamber;
focusing at least a portion of the analyte at a location in the separation chamber, comprising establishing an electric field gradient in the separation chamber by energizing the electrodes; and to
passing a flow of fluid comprising at least a portion of the analyte from the separation chamber to the inlet port of the second sample treatment device.

72. The method of claim 71, wherein the first sample treatment device and the second sample treatment device have differing analyte concentration requirements.

73. The method of claim 71, wherein the first sample treatment device and the second sample treatment device have differing fluidic flow rate requirements.

74. The method of claim 71, wherein the separation chamber or the electrode chamber or both is non-uniform.

75. The method of claim 71, wherein the electrophoretic device further comprises an electrode chamber separated from the separation chamber by a permeable membrane, the electrodes being positioned in the electrode chamber.

76. The method of claim 71, wherein the electric field gradient is changed during the course of focusing the charged analyte.

77. The method of claim 71, wherein the charged analyte comprises an uncharged material sorbed into a charged carrier.

78. The method of claim 71, wherein the separation chamber contains molecular sieve operative to shift the location at which a stationary focused band of a charged analyte forms under a given set of focusing process parameters.

79. The method of claim 80, wherein the molecular sieve comprises a gel.

80. The method of claim 71, wherein the charged analyte comprises a biological molecule, DNA, RNA or a protein.

81. The method of claim 71, wherein the charged analyte comprises a molecule sorbed to a detergent.

82. The method of claim 81, wherein the detergent comprises SDS.

83. The method of claim 71, wherein additional fluid comprising charged analyte is introduced into the processing system.

84. The method of claim 71, wherein the electric field gradient is dynamically controlled.

85. The method of claim 71, wherein the processing system comprises multiple electrophoretic devices.

86. The method of claim 85, wherein the electrophoretic devices are combined in serial, in parallel, and/or both.
